(19) United States
(12) Patent Application Publication
(10) Pub. No.: US 2026/0228778 A1
(43) Pub. Date: Aug. 6, 2026

(54) PERSONALIZED ADVERTISING CONTENT DISPLAY BASED ON TIMING PARAMETER

(71) Applicant: Walmart Apollo, LLC, Bentonville, AR (US)

(72) Inventors: Advika Gupta, Los Altos Hills, CA (US); Michael Alvin Schubert, JR., Sulphur Springs, AR (US)

(73) Assignee: Walmart Apollo, LLC, Bentonville, AR (US)

(21) Appl. No.: 19/465,458

(22) Filed: Jan. 30, 2026

Related U.S. Application Data
(60) Provisional application No. 63/752,364, filed on Jan. 31, 2025.

(51) Int. Cl. G06Q 30/0251

(52) U.S. Cl. CPC G06Q 30/0271; G06Q 30/0252; G06Q 30/0261

(57) ABSTRACT

Example implementations relate to providing advertising content. A transaction event associated with a user is detected. A timing parameter is determined based on transaction data associated with the transaction event and user profile information of a user. The timing parameter is indicative of an estimated time for the user to approach a fixed digital display device after the transaction event. Advertising content for the user is determined based on the user profile information. The advertising content is displayed on the fixed digital display based on the timing parameter.

### CROSS REFERENCE TO RELATED APPLICATION

This application claims the benefit of priority to U.S. Provisional Patent Application No. 63/752,364, filed Jan. 31, 2025, which is hereby incorporated by reference in its entirety.

### BACKGROUND

During transactions in retail facilities, items being purchased by customers are scanned via a scanning device at a point-of-sale (POS), such as a staffed checkout or a self-checkout (SCO). As each item is scanned, an item identifier (ID), such as a universal product code (UPC), is added to a list of scanned items which are ultimately included in a purchase receipt when the transaction is complete. Advertising may help to promote certain items or services to consumers.

### BRIEF DESCRIPTION OF THE DRAWINGS

FIG. 1A is an example block diagram illustrating a system for frontend identification of unscanned items in real-time during a current transaction.

FIG. 1B is an example block diagram illustrating a system for identifying unpaid items using object detection and object recognition models in real-time in cart exit area.

FIG. 2A is an example block diagram illustrating a retail environment including a POS device and a set of cameras for capturing data used during frontend identification of unscanned items.

FIG. 2B is an example block diagram illustrating a retail environment including a POS device and a set of cameras for capturing data used during identification of unpaid items.

FIG. 3A is an example block diagram illustrating an item scan manager for frontend identification of unscanned items.

FIG. 3B is an example block diagram illustrating an unpaid item manager for real-time identification of unpaid items.

FIG. 4 is an example flow chart illustrating a method to identify unscanned items in real-time during a current transaction.

FIG. 5 is an example flow chart illustrating a method to generate a list of scanned items and a list of identified items with predicted item identifiers (IDs) for use in generating an unscanned items notification for a user.

FIG. 6 is an example flow chart illustrating a method to notify a user of unscanned items in real-time during a current transaction.

FIG. 7 is an example flow chart illustrating a method to identify unpaid items in real-time using computer vision detection and recognition results.

FIG. 8 is an example flow chart illustrating a method to select images of a cart for use in identifying unpaid items.

FIG. 9 is an example flow chart illustrating a method to generate a notification in response to a verification request.

FIG. 10 is an example diagram illustrating exit CV hardware and camera settings.

FIG. 11 is an example illustration of selecting representative cart images in the trajectory.

FIG. 12 is an example image showing a top view and a side view of a selected cart and a conveyor including a plurality of items at a staffed checkout.

FIG. 13 is an example image showing a top view and a side view of a selected cart at a self-checkout (SCO).

FIG. 14 is an example image showing a top view of a selected cart, a conveyor device and a receipt associated with a transaction.

FIG. 15 is an example image of a user interface (UI) associated with a POS device for displaying an unscanned items notification to a user.

FIG. 16 is an example table illustrating performance of the frontend CV system over a receipt check system.

FIG. 17 is an example system architecture for frontend identification of unscanned items.

FIG. 18 is an example screenshot of a receipt check screen displayed via a UI device.

FIG. 19 is an example screenshot of a scan items notification including a cart image with instructions to scan a sample of the items in the cart associated with the image.

FIG. 20 is an example screenshot of a scan items notification including a cart image with a side view of a cart.

FIG. 21 is an example screenshot of a scan items notification including a cart image with highlighted items for scanning by a user prior to customer exit.

FIG. 22 is an example screenshot of an unscanned items notification displayed via a UI device.

FIG. 23 is an example illustration of a gallery monitoring page displaying a set of paid items and a set of unpaid items.

FIG. 24 is an example illustration of a gallery review page including a list of paid items and a list of unpaid items.

FIG. 25 is an example block diagram illustrating a system for an interactive exit lane via an archway truss device.

FIG. 26 is an example block diagram illustrating a barrier member for blocking a field of view (FOV) of a set of cameras from objects outside an exit lane of the archway truss.

FIG. 27 is an example diagram illustrating a single lane archway truss having a pair of barriers.

FIG. 28 is an example diagram illustrating a front view of a multi-lane archway truss having a plurality of barrier members.

FIG. 29 is an example diagram illustrating a perspective view of a multi-lane archway truss having a plurality of barrier members.

FIG. 30 is an example diagram illustrating a multi-lane archway truss having a digital display device.

FIG. 31 is an example diagram illustrating an exploded view of a multi-lane archway truss having a plurality of barrier members.

FIG. 32 is an example diagram illustrating a top view of the multi-lane archway truss having a plurality of barrier members.

FIG. 33 is an example diagram illustrating an exterior side of a vertical support member having a barrier member.

FIG. 34 is an example diagram illustrating a camera mounted to a horizontal top member.

FIG. 35 is an example diagram illustrating a wing panel having a sloping top edge.

FIG. 36 is an example diagram illustrating a side view of a wing panel having a sloping top rail.

FIG. 37 is an example diagram illustrating a side view of a wing panel frame without an exterior covering.

FIG. 38 is an example diagram illustrating an interior side of a vertical support member having a recessed camera housing.

FIG. 39 is an example diagram illustrating an exterior covering for a vertical support member including an aperture for a camera housing.

FIG. 40 is an example diagram illustrating a camera mounted to a horizontal top member via a mounting bracket.

FIG. 41 is an example block diagram illustrating a system for an interactive multi-lane archway truss displaying customizable content to users while generating sensor data associated with objects moving towards an exit.

FIG. 42 is an example flow chart illustrating operation of a computing device to generate content for display to a user and receive image data from a plurality of camera devices associated with the archway truss.

FIG. 43 is an example diagram illustrating aspects of a store environment and process flow for determining and displaying personalized ads to a user initiating a POS transaction and thereafter exiting the store.

FIG. 44 is an example diagram illustrating aspects of a store environment and process flow for determining and displaying personalized ads to a customer or user initiating a mobile self-checkout transaction and thereafter exiting the store.

FIG. 45 is an example diagram illustrating a flow of information for personalized advertisement presentation.

FIG. 46 is an example diagram illustrating a user profile database according to an example.

FIG. 47 is a block diagram illustrating a system for providing advertising content according to an example.

FIG. 48 is a flow diagram depicting an example method for providing advertising content.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION

Shrink is an issue troubling retailers worldwide, resulting in over $61B in lost profit every year. At some stores, missed item scans at exit alone can result in millions of dollars in losses attributed to shrink annually. In some cases, to attempt to reduce shrink, an exit greeter can be employed to scan one or more random items in each customer's cart as the customers exit the store. Items in a customer's cart may be randomly selected and scanned at a store exit to verify whether those randomly selected items were scanned and included in the final purchase receipt.

However, this approach has several drawbacks that impede its effectiveness. For example, the process of stopping customers for random scans increases “friction”—e.g., by introducing additional wait times and creating an additional step for customers to perform before leaving the store. This added inconvenience can lead to dissatisfaction among customers. The exit process can create a bottleneck at store exit that can cause unpredictable exit wait times and inconvenience leading to a potentially negative customer experience. The random checks of every customer's shopping cart can cause embarrassment and discomfort for customers, as it can imply a sense of distrust towards every customer and it can be difficult for customers to pay for items that were missed since it cannot be done at exit. Such practices can negatively impact overall shopping experience and customer loyalty. It also limits the amount of shrink captured because only a small sample size of items, typically three random items from each cart, are scanned and verified. The majority of the items in the customer's cart remain unchecked, resulting in sub-optimal verification of cart contents that is limited in scope. This method may miss unpaid items that are not among the randomly selected items, leaving potential losses unaddressed.

Examples herein describe frontend identification of unscanned items. In some examples, when a user indicates they are ready to complete a purchase transaction, the system maps each scanned item to items identified using computer vision (CV) object detection and recognition models. If any item identified by the CV models fails to map to a scanned item, a notification is generated and presented to the user via a user interface device. This enables the user to scan missed items quickly and easily while the user is still at the point-of-sale (POS) device with minimal friction while reducing shrink resulting from unscanned items remaining at customer exit from the store.

It should be understood that the terms “user”, “customer” and “member” may be used interchangeably herein. Similarly, the terms “store” and “retail facility” may be used interchangeably herein.

In other examples, the system presents an image of each unscanned item to a user at a POS device in real-time during a current transaction via a UI. This enables the user to quickly identify and scan each unscanned item. This improves user efficiency via the UI interaction with increased user interaction performance.

In examples, the computing device operates in an unconventional manner by presenting a list of unscanned items to a user at a POS device in real-time during a current transaction before the transaction is completed, thereby enabling the user to quickly scan and pay for missed items during a single (current) transaction. This reduces system resources consumed by scanning random items and requires customers to start a new, second transaction operation to scan and pay for missed items after the first (original) transaction was already completed. Enabling missed items to be scanned during the same (original) transaction enables reduced processor usage, network bandwidth usage and memory usage consumed in completing an additional purchase transaction. Moreover, the computing device is used in an unconventional way and allows reduced number of unpaid items, improves customer experience, and improves overall efficiency of human users by eliminating the need to scan random items in a customer cart at exit.

Examples described herein can reduce human time and effort consumed scanning receipts and matching randomly scanned items to the receipts at exit, reducing queue lines of customers waiting to exit the store, as well as eliminating time spent starting another purchase transaction to scan and purchase missed items. The frontend identification of unscanned items further improves customer experience by saving customer time at exit and reducing friction for customers exiting the store.

In some examples, computer vision technology is used to capture images of customer carts and identify items within the cart. The system compares recognized items to the items scanned at the POS and/or recorded on the receipt. The system identifies potential shrink and notifies a user or cashier upstream right before the transaction is completed, sending the missed item alert to the tablet or other user interface (UI) at the checkout terminal. This enables the user to complete the scanning and payment of the identified missed items before the transaction is completed. With the frontend CV system, customers from staffed and unstaffed checkout lanes are not stopped at exit door for another check, reducing the extra step and saving a lot of friction for customers.

The present disclosure also provides various examples of systems and methods that enable exit computer vision unpaid item identification for a reduced friction exit experience. In some examples, an unpaid item manager selects an image of a selected cart from a plurality of images of the selected cart using object tracking, a depth model and tracking trajectory of the cart using a set of anchor points associated with a field of view of an image capture device. In this manner, the system is able to select images having a full view of the selected cart with the optimum images which enable generation of the highest quality detection and recognition model results. This reduces false positives and error rates while improving accuracy of item recognition results.

In some examples, when a user completes a purchase transaction, the system maps each scanned item identified in an e-receipt to predicted item IDs for items identified using computer vision (CV) object detection and recognition models. If any item identified by the CV models fails to map to a scanned item included in the list of paid items in the e-receipt, a notification is generated and presented to a user via a user interface device. This enables the user to identify and/or scan missed items quickly and easily with minimal friction prior to exiting the store while reducing shrink resulting from unscanned items remaining at customer exit from the store.

Other aspects provide fuzzy basket matching for identifying an electronic receipt (e-receipt) associated with the identified items in a selected cart. This enables more accurate matching of paid item information obtained from the e-receipt with item recognition data associated with a selected cart while reducing error rates associated with false positives.

Some examples provide a mapping component that generates a list of unpaid items by mapping the predicted item identifiers (IDs) for items identified using item detection and recognition models with paid item IDs obtained from a selected e-receipt. This enables fast and efficient identification of unpaid items with zero-friction for customers attempting to checkout and exit a retail facility.

Other examples generate a notification including a list of unpaid items and paid items associated with a receipt ID for a basket of items purchased by a customer in real-time as a customer is exiting a retail facility. This enables frictionless exit while providing quick and reliable access to accurate unpaid item lists and paid item lists for each customer basket.

In some examples, the computing device operates in an unconventional manner by automatically identifying unpaid items for customer baskets using e-receipt data and item recognition results. The results are provided to a user seamlessly in response to a verification request generated upon scanning a receipt associated with the customer basket. In this manner, the computing device is used in an unconventional way and allows accurate and reliable identification of unpaid items without physically scanning items in the customer's basket for prevention of shrink while improving customer exit experience and reducing time spent verifying item payments. The system further reduces system memory usage consumed in storing item scan data and matching scanned items to receipt data during manual verifications of customer baskets at exit.

In other examples, the computing device operates in an unconventional manner by presenting a list of unpaid items to a user requesting basket payment verification in real-time after completion of a transaction but before the customer exits the store, thereby enabling the user to quickly identify missed items. This reduces system resources consumed by scanning random items during a manual verification process and reduces the number of missed unpaid items, further improving overall efficiency of human users by eliminating the need to scan random items in a customer cart at exit. The system further reduces human time and effort consumed scanning receipts and matching randomly scanned items to the receipts at exit, reducing queue lines of customers waiting to exit the store.

In some examples, computer vision technology is used to capture images of customer carts and identify items within the cart. The system compares recognized items to the items scanned at the POS and/or recorded on the receipt. The system identifies potential shrink and notifies a user or cashier upstream right before the customer exits after the transaction is completed, sending the missed item alert to the tablet of a user and/or another user interface (UI) at the checkout terminal. This enables the user to identify missed items quickly and efficiently at exit.

The system further outputs the verification results to a user via a user interface (UI). The results include a list of unpaid items and/or images of the unpaid items, enabling a user to quickly locate and scan the unpaid items if desired. This improves user efficiency via UI interaction with increased user interaction performance, thereby improving the functioning of the underlying computing device.

The present disclosure provides various examples of an archway truss device for supporting a plurality of sensor devices generating sensor data associated with object passing through the archway. In some examples, the archway truss device includes a plurality of barrier members for blocking the field of view of one or more cameras mounted on the archway truss device. The barrier members prevent the cameras from capturing images of objects outside the one or more lanes of the archway truss. This enables more accurate identification of objects of interest in carts passing through the archway truss while reducing errors in item detection and recognition due to detection of objects which are not of interest.

In other examples, the archway truss device enables multiple lanes of egress from a checkout area to an exit area through the archway truss. This enables faster and more efficient exit of users from a retail facility while still enabling accurate object detection and recognition of basket contents using CV analysis of images captured by cameras on the archway truss.

Other examples enable an interactive archway truss device which captures sensor data associated with objects passing through one or more lanes of travel through the archway and provision of customizable content to a user via one or more digital display devices mounted to the archway truss. In this manner, the system both provides data to the archway truss device in the form of dynamic digital video content as well as receive data associated with the objects passing through the archway for more efficient communication with users without impeding or otherwise hampering users exiting the retail facility.

Still other examples provide a multi-lane archway truss device having a digital display device mounted thereon for presentation of digital images or video content to users dynamically as the users move toward an exit. The digital display device receives the content for display, including the digital images and/or video content, via a network from a computing device or cloud server. The computing device operates in an unconventional manner by dynamically generating the content and/or identifying content for presentation to the users from a plurality of available content in a data storage device. The digital display device can act as a user interface (UI) providing information to users without requiring the users to stop moving toward the exit. In this manner, the archway truss device and computing device are used in tandem in an unconventional way, and allows improved user efficiency via the UI interaction and increased user interaction performance without impeding egress of users from the facility, thereby improving the functioning of both the archway truss device and the underlying computing device.

In certain cases, an image capture device can capture images of objects in the background of an image which are not in a cart or basket. The presence of certain items in the background of an image can lead to the shrink where items in another lane are recognized and mistakenly attributed to a customer cart when those items are not actually present in the cart. The barrier members reduce or prevent these occurrences to improve accurate detection of cart contents with reduced errors.

Advertisements (ads) may also be displayed in stores to promote products or services customers. Advertisers may desire to personalize their message to consumers to make the goods or products more relevant to those consumers and increase the chances of conversion. However, the ability to personalize for individual consumers may be limited in physical stores, which may have generic, non-personalized messaging capabilities presenting to all customers in that location.

In the retail industry today, personalized or targeted advertisements may be delivered to individual customers on personal devices, but may not be similarly delivered on shared screens, particularly in a physical store or other public spaces. Retailers may be unable to target display ads within a physical retail store to individuals. For example, there may be limitations to knowing when specific customers are standing in front of an in-store display device. Further, displayed ads may remain generic to all shoppers for the region in which the store is located.

Accordingly, there is a continued opportunity to provide additional solutions to enhance the completion of retail transactions, such as solutions that can increase the incidence of accurate transactions and providing dynamic advertising displays.

Example techniques are provided for determining and providing personalized advertisements for customers in a retail facility. Am example process flow may be as follows: 1) customer initiates a checkout process, such as by scanning their membership card to begin checkout at a point of sale (POS), e.g., a self-checkout register or a staffed checkout register, initiating completion of a mobile self-checkout transaction (also referred to as a scan and go (SNG) transaction), or the like; 2) customer data and an average time it takes the customer to exit is determined based on user profile data associated with that customer (e.g., stored customer profile information is accessed via a customer ID associated with membership); 3) customer completes checkout; 4) customer begins to exit the store. In the background, a personalized ad is created for the member based in part on the stored customer profile information. After the average time to exit is completed, and the customer is expected to be approaching the exit (e.g., exit archways), a personalized ad is displayed for that customer on an in-store display device, which may be fixed in place such as on an archway truss. This advantageously allows the customer to see an ad that is relevant to that specific customer, while allowing advertisers to personalize ads to individual customers using each customer's demographic, behavioral, and purchase data. In some examples, the personalized advertisement(s) are displayed on one or more fixed display devices proximate a store exit, for viewing by the customers as they approach and exit the store.

As it can be difficult to determine where customers may be located in a store to provide personalized advertisements to those customers, in some examples, a transaction event associated with a customer is used to determine a time at which the customer is expected to exit the store, and a set of one or more fixed displays near the store exit may be used to display advertising content personalized for that specific customer.

Similarly, multiple transaction events associated with multiple customers around the same timeframe may be used to determine a time at which one or more customers are expected to exit the store. Based on similar affinities among some or all of the customers exiting the store in a similar timeframe, one or more personalized advertisements may be generated and displayed for the group of customers having similar affinities.

### Example Systems for Identifying Unscanned Items

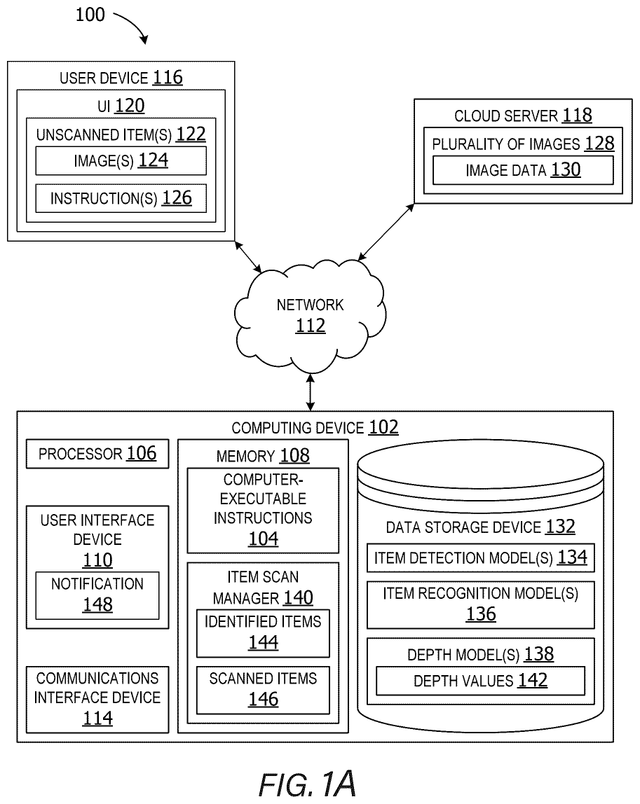

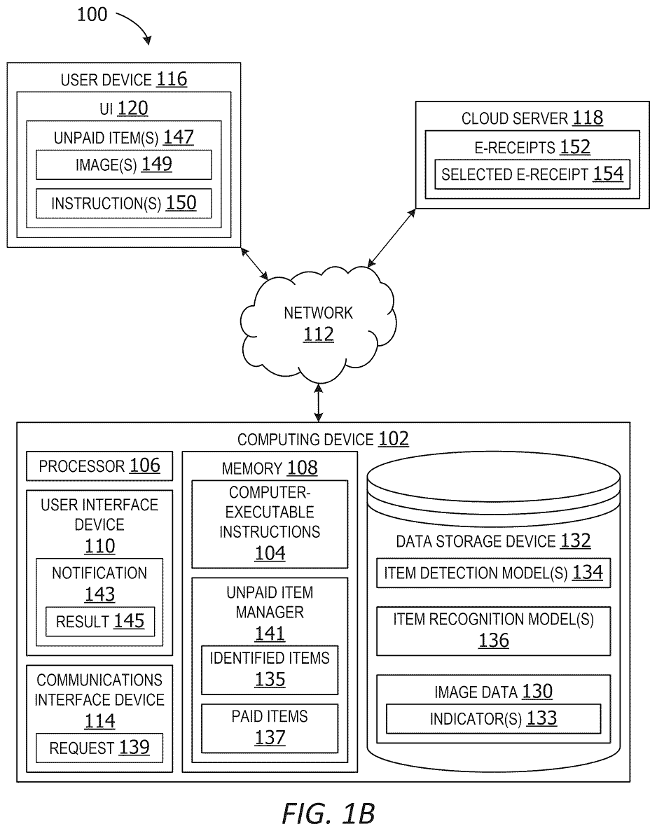

Turning now to the Figures, there is shown in FIG. 1A, an example block diagram of a system 100 constructed according to principles of the present disclosure for frontend identification of unscanned and/or unpaid items in real-time during a current transaction. In the example of FIG. 1A, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

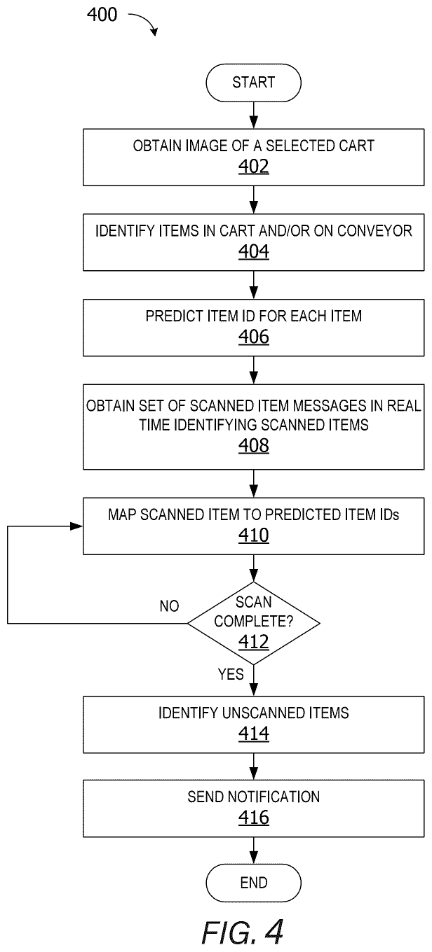

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIGS. 4-6).

The computing device 102 further has one or more computer-readable media such as the memory 108. The memory 108 includes any quantity of media associated with or accessible by the computing device 102. The memory 108 in these examples is internal to the computing device 102 (as shown in FIG. 1A). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) 120 for displaying unscanned item notification data to a user, such as, but not limited to, an identification of a set of one or more scanned item(s) 122, one or more image(s) 124 of the unscanned items and/or one or more instruction(s) 126 to scan each of the unscanned item(s) 122. The UI 120 is a device for presenting data to a user, such as, but not limited to, the user interface device 110. In some examples, the UI 120 is a UI associated with a point-of-sale (POS) device.

In these examples, the image(s) 124 do not include images of users or other individuals within the retail facility. Any images having human users or other objects which are not of interest inadvertently included within the images are removed from the image(s) by cropping the images such that only objects of interest remain in the cropped images. Images of users or objects which are not of interest are deleted or otherwise discarded. The cropped images containing only the objects of interest, such as shopping carts, items in the shopping carts, and/or items on the POS device conveyor, are then analyzed to identify and label the objects of interest within the cropped images, such as, but not limited to, the image(s) 124.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers. In still other examples, the cloud server 118 includes a cloud storage for storing data, such as, but not limited to, a plurality of images 128 of a plurality of carts holding one or more items in a retail environment. The plurality of images 128, in this example, are digital images including image data 130, such as image metadata and/or detected item indicators.

The system 100 can optionally include a data storage device 132 for storing data, such as, but not limited to, one or more item detection model(s) 134, one or more item recognition model(s) 136, and/or one or more depth model(s) 138 for calculating depth values 142 associated with one or more objects in an image, such as shopping carts in proximity to a POS device. The one or more item detection model(s) 134 include pre-trained, computer vision (CV), deep learning item detection models.

The object detection model(s) 134 are trained to analyze one or more image(s) of a checkout area within a retail environment and identify shopping carts, items in shopping carts, and/or items on a conveyor belt associated with a POS device shown in the image(s). The detected items are enclosed within bounding boxes in the image(s). The images are cropped to isolate the selected shopping cart identified in the image. The image(s) of the shopping cart is cropped to isolate the one or more item(s) in the shopping cart. The image(s) of the conveyor is cropped to isolate any items detected on the conveyor which are part of the current transaction.

The item recognition model(s) 136 includes one or more trained, CV deep learning models trained to recognize the items detected by the item detection model(s) 134. The item recognition model(s) 136 predicts or infers an item ID for each recognized item. The item ID, in some examples, is a universal product code (UPC) associated with the identified item. For example, if the item detection model(s) 134 isolate an item in an image that is recognized as a brand “A” 24-pack of soft drinks, the item recognition model(s) 136 infers an item ID for the brand “A” 24-pack of soft drinks and associates that item ID with the image of the brand “A” 24-pack soft drinks. The item recognition model(s) are trained using labeled image data including images of thousands of items in a catalog of items stocked and/or offered for sale in the retail store.

The depth model(s) 138 includes one or more models trained to generate depth values 142 associated with one or more objects (items) in an image. In this example, the depth model(s) 138 determines a depth value for each shopping cart in an image. The depth values are used to identify a shopping cart which is closest in proximity to the POS device and therefore, predicted to be the shopping cart associated with the current transaction. Carts which are located too far away from the POS device (threshold depth/distance) are discarded or disregarded.

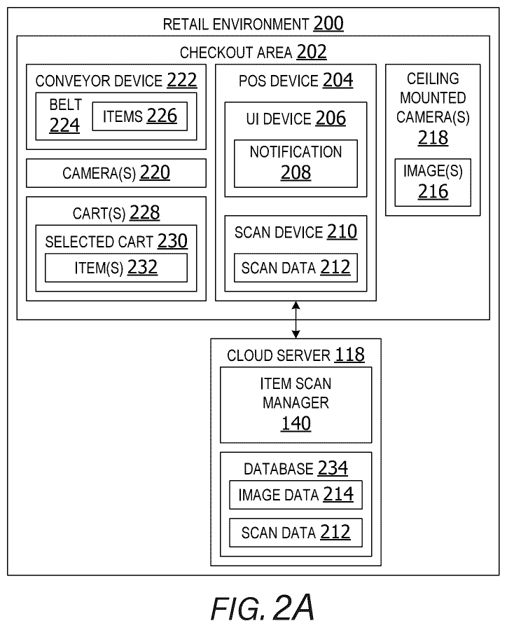

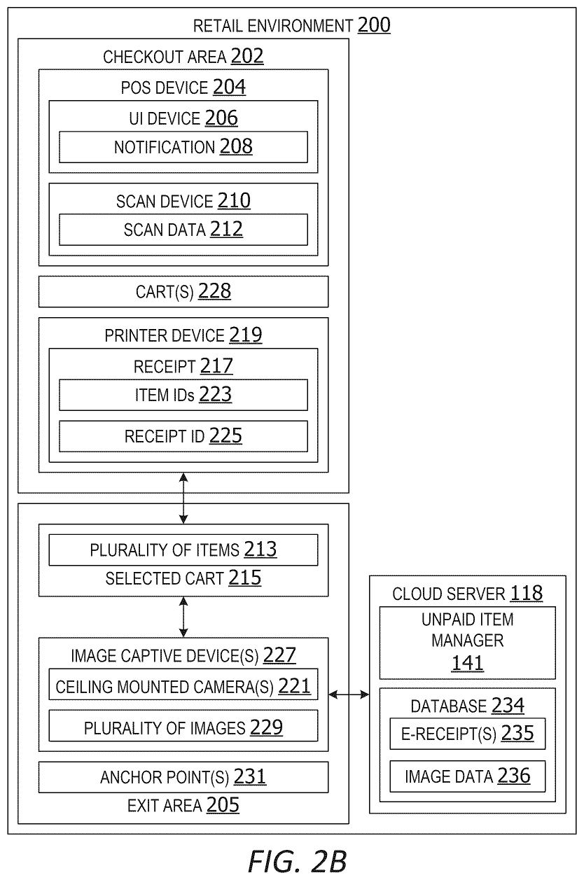

The data storage device 132 can include one or more different types of data storage devices, such as, for example, one or more rotating disks drives, one or more solid state drives (SSDs), and/or any other type of data storage device. The data storage device 132, in some non-limiting examples, includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 132 includes a database, such as, but not limited to, the database 234 in FIG. 2A.

The data storage device 132, in this example, is included within the computing device 102, attached to the computing device, plugged into the computing device, or otherwise associated with the computing device 102. In other examples, the data storage device 132 includes a remote data storage accessed by the computing device via the network 112, such as a remote data storage device, a data storage in a remote data center, or a cloud storage.

The memory 108 in some examples stores one or more computer-executable components, such as, but not limited to, an item scan manager 140, that, when executed by the processor 106 of the computing device 102, obtains an image of a selected cart and a plurality of items associated with the selected cart. The item scan manager 140 identifies the plurality of items associated with the selected cart. The item scan manager 140 predicts an item ID associated with each item in the plurality of items. A set of identified items 144 includes a plurality of item IDs associated with the plurality of items is generated. The item scan manager 140 obtains item scan data in real time from the POS device. The item scan data includes item IDs associated with each item scanned at the POS device during a current transaction. A set of scanned items 146 includes an item ID for each scanned item associated with the item scan data received from the POS device. The item scan manager 140 maps each scanned item ID to an identified item ID in the set of identified items 144. The item scan manager 140 receives a scan complete signal from the POS device indicating a user is ready to pay for the set of scanned items. The scan complete signal may also be referred to as a ready-to-pay signal. The item scan manager 140 identifies a set of unscanned item(s) 122 based on mapping of the set of identified items to the set of scanned items. An unscanned item is an item having an item ID in the set of identified items that fails to map to a corresponding item ID in the set of scanned items. The item scan manager 140 generates a notification 148 including the item IDs of the unscanned items and/or images of the unscanned items. The item scan manager 140 sends the notification 148 to a user interface device for viewing by a user, such as, but not limited to, the user interface device 110 and/or the UI 120 of the user device 116.

The notification instructs the user to scan the unscanned items. In some examples, an image of each unscanned item is displayed one at a time with an instruction to scan the item. When the item is scanned, if there is another unscanned item, the image of the next unscanned item is presented to the user with another instruction to scan the next unscanned item. In other examples, the notification 148 includes an image of the shopping cart with bounding boxes highlighting each unscanned item in the image. This enables the user to view all the unscanned items at once and see the location of the items in the cart. In still other examples, a cropped image of each unscanned item is displayed on the UI for viewing by the user.

The item scan manager 140 in this example is implemented on the computing device 102. However, the examples are not limited to implementation of the item scan manager on a local computing device, such as a server. In other examples, the item scan manager is implemented on a cloud server, such as, but not limited to, the cloud server 118, as shown in FIG. 2A below.

FIG. 2A is an example block diagram illustrating a retail environment 200 including a POS device 204 and a set of cameras 220 for capturing data used during frontend identification of unscanned items. The retail environment 200 is an environment including a retail facility, such as, but not limited to, a retail store, a warehouse and/or a distribution center storing and/or displaying items available for purchase or lease by customers. The retail environment includes an indoor area, outdoor area, and/or a partially enclosed area for storing and/or displaying items for retail sale. In this embodiment, the retail environment 200 includes a checkout area 202.

The checkout area 202 is an area associated with a POS device 204 for completing a transaction to purchase one or more items. The checkout area 202 includes staffed checkout lanes and/or unstaffed, self-checkout (SCO) lanes. In this example, the POS device 204 includes a UI device 206 for displaying data to a user, such as, but not limited to, a UI 120 and/or the user interface device 110. Data displayed may include notification 208 in some examples.

The POS device 204 includes a scan device 210 for scanning item identifiers codes associated with items, such as, but not limited to, a universal product code (UPC), a radio frequency identifier (RFID) tag, matrix barcode, or any other type of identifier. The scan device generates scan data 212 associated with the scans of each item. As each item is scanned by the scan device 210, the POS device transmits the scan data for the scanned item to the item scan manager 140 via a network, such as, but not limited to, the network 112 in FIG. 1A.

For example, if a user scans two items, a first message containing first scan data associated with scanning the first item is transmitted to the item scan manager 140. The item scan manager 140 identifies an item ID for the first scanned item based on the scan data in the first message. When the second item is scanned at the POS device, a second message containing different scan data associated with the second item UPC is transmitted to the item scan manager. The item scan manager 140 uses the second scan data to determine the item ID of the second item.

In this example, when the first item is scanned and the scan data is transmitted to the item scan manager, this constitutes a start signal triggering the item scan manager to begin analyzing image data 214 associated with the current ongoing transaction and identify items in the image(s) 216 generated by a set of cameras, including one or more ceiling mounted camera(s) 218 and/or one or more camera(s) 220 mounted on the POS device 204. The image(s) 216 include one or more top views (birds eye view) of the conveyor device 222. The conveyor device 22 includes a belt 224 having one or more items 226 resting on a surface of the belt. The image(s) also include one or more shopping cart(s) 228 near the POS device 204.

In this example, data such as the image data 214 and/or scan data 212 is stored on a database 234. The database 234 is any type of database, such as, but not limited to, a relational database.

The item scan manager 140 analyzes the image(s) 216 using a depth model to identify a selected cart 230 nearest to the POS device, such as but not limited to, the depth model(s) 138 in FIG. 1A. The item scan manager uses object tracking to track the selected cart 230 through a sequence of images generated by the camera(s) 220 and/or the ceiling mounted camera(s) 218.

The item scan manager 140 detects and identifies one or more item(s) 232 in the selected cart 230 via one or more detection and recognition models, such as, but not limited to, the item detection model(s) 134 and/or the item recognition model(s) 136 in FIG. 1A. In some examples, the POS device optionally includes a printer (not shown) for printing a receipt including a listing of all the scanned items when the transaction is completed.

In other examples, the POS device includes a processor and a memory for generating messages transmitted to the item scan manager 140, such as, but not limited to, the messages including the scan data (scanned item messages), a start signal sent when a first item is scanned at the beginning of a transaction, and/or a scanning complete (end) message when a user selects a ready-to-pay option via the POS device when the user is finished scanning items.

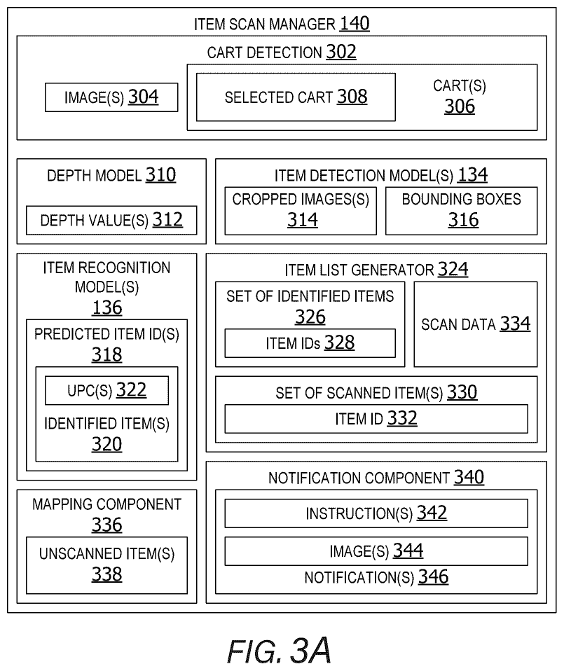

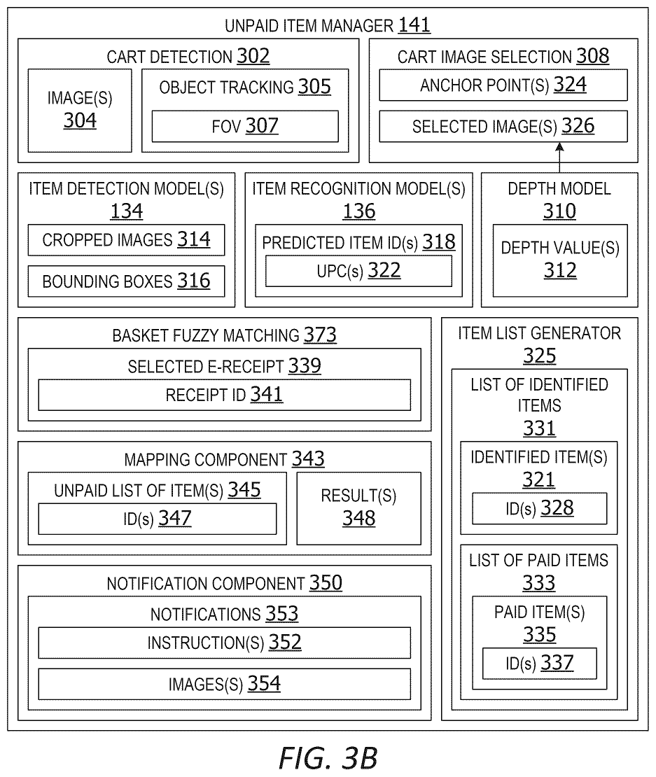

Referring to FIG. 3A, an example block diagram illustrating an item scan manager for frontend identification of unscanned items is shown. In some examples, a cart detection 302 obtains one or more image(s) 304 of one or more cart(s) 306. In this example, the cart detection 302 obtains between five and twenty images captured by a camera at a staffed checkout lane. However, the examples are not limited to using five to twenty images. The cart detection may utilize a single image, as well as two or more images of one or more carts. The cart detection 302 is a software component that employs a cart detection algorithm to isolate and extract the selected cart 308 and/or a conveyor belt area within the checkout area. Additionally, a depth model 310 estimates depth value(s) 312 for each cart in the image(s) view, enabling the system to accurately identify the selected cart corresponding to the ongoing transaction. The depth model 310 is a trained deep learning model, such as, but not limited to, the depth model(s) 138 in FIG. 1A.

The item detection model(s) 134 applies an item detection algorithm to crop images of items present in the selected cart 308 and/or on the conveyor belt. This process enables precise localization of items within the captured images. The cropped image(s) 314 are isolated or highlighted by bounding boxes 316 enclosing the detected items in some examples.

The item recognition model(s) 136 apply two item recognition algorithms are utilized to infer the Universal Product Code (UPC) from the cropped item images. These algorithms facilitate accurate identification and recognition of items in the transaction. The item recognition model(s) generate predicted item IDs 318 for the identified item(s) 320. The identified items include items detected in the images that the item recognition model(s) recognize and infer an item ID. The item IDs, in this example, include one or more item UPC(s) 322.

An item list generator 324 generates a set of identified items 326 including the inferred or predicted item ID 328 for each item recognized by the item recognition model(s) 136. The set of identified items 326 may be referred to as a list of identified items. The item list generator generates a set of scanned item(s) 330 including the item ID 332 for each item scanned. The scanned items are identified using scan data 334 received from a POS device, such as, but not limited to, the POS device 204.

By leveraging the computer vision item detection model(s) 134 and the item recognition model(s) 136, in this example, the item scan manager 140 of the frontend CV system generates the set of identified items 326 by inferring from the image(s) 304. The set of identified items (inferred item list) is then compared with the set of scanned items, resulting in the prediction of two lists, a scanned item list including items which have been paid for or are about to be paid for and the unscanned (unpaid) item list (potential shrinkage items).

A mapping component 336 performs unscanned item detection to generate a set of one or more unscanned item(s) 338. In the event that the frontend CV system detects unscanned and/or unpaid items during a transaction, upon receiving the ‘ready to pay’ signal, a notification component 340 of the item scan manager 140 sends one or more notification(s) 346 to the tablet or UI device mounted next to the checkout monitor.

In other words, the item scan manager can send a single notification identifying all the unscanned items or the item scan manager can send a series of notifications in which each notification identifies a single unscanned item. After each unscanned item is scanned, the new scan data for the scanned item is received triggering the item scan manager to send the next notification identifying the next unscanned item that requires scanning. In this manner, the notifications enable the system to walk the user through the process of identifying each unscanned item one at a time and scanning it (adding it to the basket of scanned items).

The notification(s) 346 includes instruction(s) 342 to scan the unscanned item(s) 338 and/or image(s) 344 of the unscanned item(s) 338. In some examples, these notifications display red bounding boxes, one at a time, on the checkout image, effectively highlighting the unpaid items for further attention and resolution.

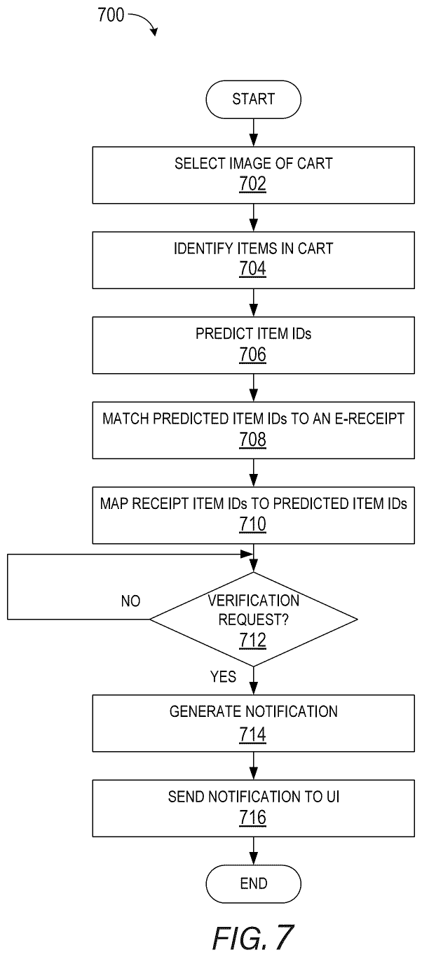

Referring to FIG. 1B, an example block diagram illustrates an example of a system 100 constructed according to principles of the present disclosure for identifying unpaid items using object detection and object recognition models in real-time in cart exit area. In examples, the processor 106 is programmed to execute instructions such as those illustrated in the figures (e.g., FIGS. 7-9). The system 100 can optionally include a data storage device 132 for storing data, such as, but not limited to one or more item detection model(s) 134, one or more item recognition model(s) 136, and/or image data 130. The image data optionally includes one or more indicator(s) 133 associated with one or more identified items 135. The indicator(s) 133 in some examples include color-coded bounding boxes placed around the images of objects, such as a shopping cart and/or items in the shopping cart.

The item detection model(s) 134 may include deep learning CV object detection models that are trained to analyze one or more image(s) of a checkout area within a retail environment and identify shopping carts, items in shopping carts shown in the image(s). The detected items are enclosed within bounding boxes in the image(s). The images are cropped to isolate the selected shopping cart identified in the image. The image(s) of the shopping cart are cropped to isolate the one or more item(s) in the shopping cart.

The item recognition model(s) 136 may include one or more trained, CV deep learning item detection models trained to recognize the items detected by the item detection model(s) 134. The item recognition model(s) 136 predicts or infers an item ID for each recognized item. The item ID, in some examples, is a universal product code (UPC) associated with the identified item. For example, if the item detection model(s) isolate an item in an image that is recognized as a brand “A” 24-pack of soft drinks, the item recognition model(s) 136 infers an item ID for the brand “A” 24-pack of soft drinks and associates that item ID with the image of the brand “A” 24-pack soft drinks. The item recognition model(s) are trained using labeled image data including images of thousands of items in a catalog of items stocked and/or offered for sale in the retail store.

In examples, the data storage device 132 includes a database, such as, but not limited to, the database 234 in FIG. 2B. The data storage device 132, in this example, is included within the computing device 102, attached to the computing device, plugged into the computing device, or otherwise associated with the computing device 102. In other examples, the data storage device 132 includes a remote data storage accessed by the computing device via the network 112, such as a remote data storage device, a data storage in a remote data center, or a cloud storage.

The memory 108 in some examples stores one or more computer-executable components, such as, but not limited to, an unpaid item manager 141, that, when executed by the processor 106 of the computing device 102, selects one or more image(s) of a selected cart from a plurality of images of the selected cart using a set of anchor points associated with a field of view of an image capture device. The unpaid item manager 141 identifies a plurality of items associated with the selected cart using the selected image(s). The unpaid item manager 141 predicts an item identifier (ID) associated with each item in the plurality of items associated with the selected cart. The unpaid item manager 141 generates a list of identified items 135 and/or a list of paid items 137. The paid items 137 are identified using an e-receipt selected from a plurality of e-receipts.

In some examples, the unpaid item manager 141 selects an e-receipt associated with the selected cart from a plurality of active e-receipts 152 using a fuzzy matching of the list of paid items 137 included in the selected e-receipt 154 and the list of identified items 135 generated using the selected image in real time. The paid items 137 include a paid item ID associated with each item scanned at a POS device during a transaction associated with the selected e-receipt. The unpaid item manager 141 maps each paid item ID in the list of paid items 137 to an identified item ID in the list (set) of identified items 135.

An unmapped item in the identified items 135 is a predicted unpaid item. When the unpaid item manager 141 receives a verification request 139 signal associated with the selected receipt from a scan device indicating a user is ready to exit and a verification of the basket contents payment is required. The unpaid item manager 141 generates a notification 143 including a verification result 145. The verification result 145 includes a list of unpaid items 147. Each predicted unpaid item is associated with an item ID in the list of identified items 135 that fails to map to a corresponding item ID in the list of paid items 137. The unpaid item manager 141 sends the notification 143 to a user interface device, such as, but not limited to, the user interface device 110 and/or the UI 120.

The notification includes the list of unpaid item(s) 147 and/or the list of paid items 137. The notification optionally also includes one or more image(s) 149 of the selected cart with an overlay of indicator(s) 133 highlighting the unpaid items. The notification 143 optionally also includes one or more instruction(s) 150, such as an instruction to scan one or more of the unpaid item(s) 147.

In this example, the unpaid item manager 141 is implemented on the computing device 102. However, in other examples, the unpaid item manager is implemented on a remote computing device or a cloud server, such as, but not limited to, the cloud server 118, as shown in FIG. 2B below.

In the example shown in FIG. 1B, the plurality of e-receipts is stored on the cloud server 118. However, in other examples, the e-receipts are optionally stored on a data storage device, such as, but not limited to, the data storage device 132. The system of FIG. 1B is similar to the system of FIG. 1A in other respects.

FIG. 2B is an example block diagram illustrating a retail environment 200 including a POS device and a set of cameras for capturing data used during identification of unpaid items. The retail environment 200 is an environment including a retail facility, such as, but not limited to, a retail store, a warehouse and/or a distribution center storing and/or displaying items available for purchase or lease by customers. The retail environment includes an indoor area, outdoor area, and/or a partially enclosed area for storing and/or displaying items for retail sale. In this example, the retail environment 200 includes a checkout area 202 and an exit area 205.

The checkout area 202 is an area associated with a POS device 204 for completing a transaction to purchase one or more items associated with one or more cart(s) 228. The checkout area 202 includes staffed checkout lanes and/or unstaffed, self-checkout (SCO) lanes. An SCO is an unstaffed checkout lane. In this example, the POS device 204 includes a scan device 210 for scanning item identifiers codes associated with items, such as, but not limited to, a universal product code (UPC), a radio frequency identifier (RFID) tag, matrix barcode, or any other type of identifier. The scan device 210 generates scan data 212 associated with a plurality of items 213 associated with a selected cart 215.

The POS device 204 generates a receipt 217 associated with the plurality of items scanned by the scan device 210. The receipt 217 includes a physical receipt printed by a printer device 219 and/or an electronic receipt. The receipt 217 includes a list of scanned items and the item IDs 223 associated with the scanned items. In some examples, the receipt 217 includes a unique receipt ID 225. The receipt ID in some examples is a barcode or other identifier, such as, but not limited to, a UPC, a matrix barcode, or any other type of unique ID. The receipt ID is scanned by a scan device to obtain the receipt ID. The receipt ID is used to retrieve receipt data, including a list of purchased (paid) items on the receipt.

As each receipt is generated, the POS device transmits an e-receipt copy of the receipt to the unpaid item manager 141 via a network, such as, but not limited to, the network 112 in FIG. 1B. In this example, the e-receipts 235 received from the POS device 204 are stored in a database 234. The database 234 optionally stores other data, such as, but not limited to, image data 236. The image data includes data associated with one or more digital images in the plurality of images 229, such as image metadata. The image metadata optionally includes a timestamp identifying a time when the image was generated, location data associated with the image capture device, an image capture device ID, and/or any other data associated with the plurality of images 229.

In this example, the exit area includes one or more image capture device(s) 227 generating a plurality of images 229 of the plurality of cart(s) 228 and cart contents, such as, but not limited to, the plurality of items 213 associated with the contents of the selected cart 215. The image capture device(s) generates images of the cart(s) as the cart(s) move away from the POS device and toward an exit. As the cart(s) move, they pass one or more anchor point(s) 231. In this example, there are three anchor point(s) 231 used to identify selected images of the selected carts. In other words, the system selects images of the selected cart when the cart is positioned near (in proximity to) an anchor point. The anchor point identifies a location in which a cart is fully within the field of view (FOV) 307 of at least one image capture device, such as a camera mounted to a ceiling of the retail facility.

The unpaid item manager 141 analyzes the image(s) using a depth model to identify a selected cart nearest to the anchor point(s), such as but not limited to, the depth model 310 in FIG. 3B. The unpaid item manager uses object tracking to track the selected cart through a sequence of images generated by the image capture device(s), such as, but not limited to, the ceiling mounted camera(s) 221.

The unpaid item manager 141 detects and identifies one or more items in the selected cart 215 via one or more detection and recognition models, such as, but not limited to, the item detection model(s) 134 and/or the item recognition model(s) 136 in FIG. 1B.

In other examples, the POS device includes a processor and a memory for generating messages transmitted to the unpaid item manager 141, such as, but not limited to, the messages including the e-receipts and/or a verification request message.

FIG. 3B is an example block diagram illustrating an unpaid item manager 141 for real-time identification of unpaid items. In some examples, the cart detection 302 obtains one or more image(s) 304 of one or more carts, such as, but not limited to, the cart(s) 228 in FIG. 2B. In this example, the cart detection 302 obtains between five and twenty images captured by a camera at an unstaffed (SCO) checkout lane, such as, but not limited to, the image capture device(s) 227 in FIG. 2B. However, the examples are not limited to using five to twenty images. The cart detection 302 may utilize a single image, as well as two or more images of one or more carts. The cart detection 302 is a software component that employs a cart detection algorithm to isolate and extract a selected cart from one or more images of the cart. An object tracking 305 algorithm is applied to track the same cart through a series of images in a sequence. The cart detection identifies images in which a full and clear view of the selected cart is visible within the FOV 307 of the camera generating the images. Additionally, a depth model 310 estimates depth value(s) 312 for each cart in the image(s) FOV 307, enabling the system to accurately identify the selected cart corresponding to the ongoing transaction. The depth model 310 is a trained deep learning model.

The item detection model(s) 134 applies an item detection algorithm to crop images of items present in the selected cart. This process enables precise localization of items within the captured images. The cropped image(s) 314 are isolated or highlighted by bounding boxes 316 enclosing the detected items within an overlay of the image data, in some examples.

The item recognition model(s) 136 apply two item recognition algorithms that are utilized to infer the Universal Product Code (UPC) from the cropped item images. These algorithms facilitate accurate identification and recognition of items in the transaction. The item recognition model(s) generate predicted item IDs 318 for the identified item(s) 326. The identified items include items detected in the images that the item recognition model(s) recognize and infer an item ID. The item IDs, in this example, include one or more item UPC(s) 322.

The depth model 310 includes one or more models trained to generate depth values 312 associated with one or more objects (items) in an image. In this example, the depth model determines a depth value for each shopping cart in an image. The depth values are used to identify a shopping cart which is closest in proximity to the POS device and/or an anchor point in an image. Carts which are located too far away from the anchor points (threshold depth/distance) are discarded or disregarded.

One or more images of the selected cart are selected from a plurality of images of the selected cart by a cart image selection 308. The cart image selection 308 identifies images in which the selected cart is located within a predetermined proximity or range from one or more anchor point(s) 324. The selected image(s) 326 include images in which the cart is fully visible in the FOV of the image capture device without any obstructions visible.

An item list generator 325 generates a set of identified items 321 including the inferred or predicted item ID(s) 328 for each item recognized by the item recognition model(s) 136. A list of identified items 331 is generated by the item list generator 325. The list of identified items 331 includes the predicted item IDs 328 for the set of identified items 321. The item list generator also generates a list of paid items 333 including the item IDs 337 for a set of paid items 335 obtained from a selected e-receipt 339. The selected e-receipt 339 is an electronic receipt selected from a plurality of e-receipts using a basket fuzzy matching 373 algorithm. Each e-receipt is optionally associated with a unique receipt ID 341 used to request verification when the customer receipt is scanned.

By leveraging the computer vision item detection model(s) and the item recognition model(s), in this example, the unpaid item manager 141 generates a list of unpaid items 345 by inferring item ID(s) 347 from the image(s). A mapping component 343 maps the list of identified item IDs to the list of paid item IDs from the selected e-receipt 339 to generate the list of unpaid item(s) 345. The list of unpaid item(s) includes the item ID(s) for identified items in the set of identified items which fail to map to at least one paid item ID in the set of paid items. The list of unpaid item(s) 345 is included in verification result(s) 348 which are stored in a database with the receipt ID for the e-receipt associated with the selected cart.

When the unpaid item manager 141 receives a verification request from a user device, a notification component 350 generates one or more notifications 353 including the list of unpaid item(s) 344. The notification(s) optionally also include one or more instruction(s) 352, such as a scan item instruction, a “green to go” instruction, and/or any other type of instruction. The notification(s) 353 optionally also include one or more image(s) 354 of the unpaid items. The notification component 350 sends the notification(s) to a UI device for display to a user.

In some examples, the notification component sends a single notification identifying all the unpaid items or the notification component can send a series of notifications in which each notification identifies a single unpaid item. After each unpaid item is scanned, the new scan data for the scanned item is received triggering the unpaid item manager to send the next notification identifying the next unpaid item that requires scanning. In this manner, the notifications enable the system to walk the user through the process of identifying each unpaid item one at a time and scanning it (adding it to the basket of scanned items).

In some examples, these notifications display red bounding boxes, one at a time, on the cart image, effectively highlighting the unpaid items for further attention and resolution. In other examples, the notifications include cropped images of each unpaid item. In still other examples, the notifications include anchor images of the unpaid item. An anchor image is a stock image or image of an item from a catalog of items.

### Example Methods for Identifying Unscanned Items

Examples of a method following principles of the present disclosure can be practiced using any example of a system constructed according to principles discussed herein. In examples of a method following principles of the present disclosure, a system constructed according to principles of the present disclosure is used to perform a series of steps to perform functions and operations described herein.

FIG. 4 is an example flow chart illustrating operation of the computing device of FIG. 1A, to identify unscanned items in real-time during a current transaction. The process 400 shown in FIG. 4 is performed by an item scan manager component, executing on a computing device, such as the computing device 102 or the user device 116 in FIG. 1A.

The process begins by obtaining an image of a selected cart at 402. The selected cart is a cart associated with a current transaction, such as, but not limited to, a selected cart 230 in FIG. 2A and/or the selected cart 308 in FIG. 3A. The item recognition model identifies items in the selected cart and/or on the conveyor associated with the POS device in the image at 404. The item recognition model predicts an item ID for each item at 406. The item scan manager receives a set of scanned item messages in real time identifying scanned items at 408. The scanned item messages are received from the POS device and/or the scanner device associated with the POS device, such as, but not limited to, the POS device 204 in FIG. 2A. The item scan manager maps the scanned items to the predicted item IDs at 410. The item scan manager determines if the scanning is complete at 412. The item scan manager determines the scanning is complete when a ready-to-pay (scan complete) signal is received from the POS device. When scanning is complete, the item scan manager identifies unscanned items at 414 and sends a notification for a presentation to a user at 416. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

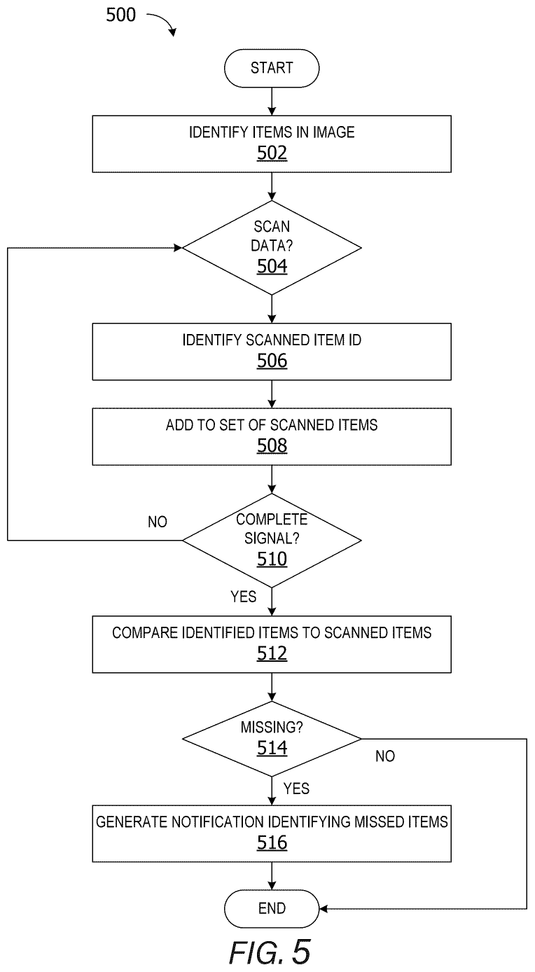

FIG. 5 is an example flow chart illustrating operation of the computing device of FIG. 1A to generate a list of scanned items and a list of identified items with predicted item identifiers (IDs) for use in generating an unscanned items notification for a user. The process 500 shown in FIG. 5 is performed by an item scan manager component, executing on a computing device, such as the computing device 102 or the user device 116 in FIG. 1A.

The process begins by identifying items in an image at 502. The items are identified by item detection models and/or item recognition models, such as, but not limited to, the item detection model(s) 134 and/or the item recognition model(s) 136. The item scan manager determines whether scan data associated with a scanned item is received from the POS device at 504. If yes, the item scan manager identifies the scanned item ID at 506. The scanned item ID is added to a set of scanned items at 508. A determination is made whether a scan complete (ready-to-pay) signal is received from the POS device at 510. If not, the process iteratively receives scan data as each item is scanned at the POS device. The scanned data is used to identify scanned item IDs and add those scanned item IDs to the set of scanned items until scanning is complete at 510.

The item scan manager compares the identified items to the scanned items at 512. A determination is made whether any identified items are missing from the set of scanned items at 514. If yes, a notification identifying the missed items is generated at 516. The notification is transmitted to a user scanning the items. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

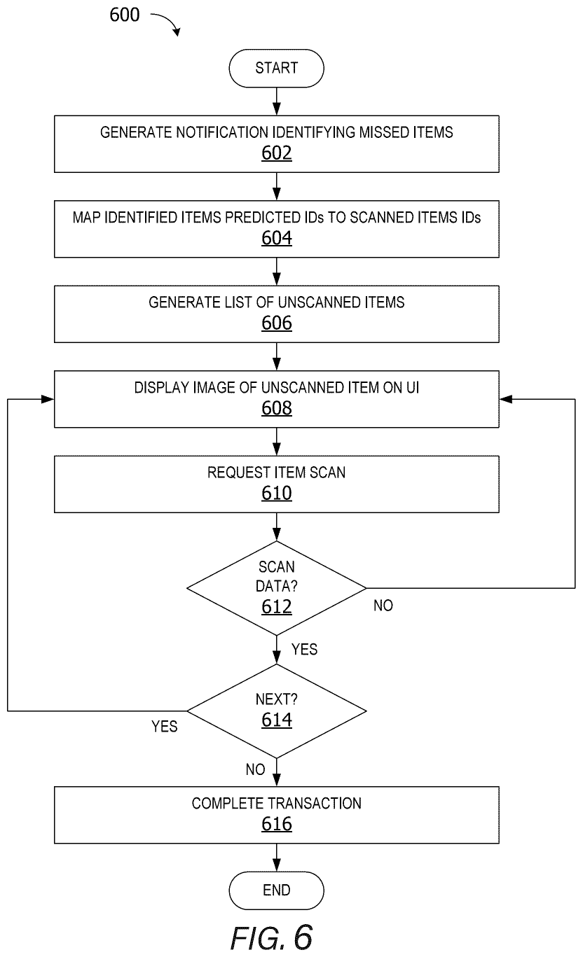

FIG. 6 is an example flow chart illustrating operation of the computing device to notify a user of unscanned items in real-time during a current transaction. The process 600 shown in FIG. 6 is performed by an item scan manager component, executing on a computing device, such as the computing device 102 or the user device 116 in FIG. 1A.

The process begins by receiving a scan complete signal at 602. In some examples, the scan complete signal is sent when a user selects a “ready to pay” option at the POS device. The item scan manager maps identified items predicted IDs to scanned item IDs at 604. The item scan manager generates a list of unscanned items based on the mapping at 606. The image of unscanned items is displayed via a UI at 608. A request to scan the unscanned item is displayed to the user at 610. The request is presented via the UI. A determination is made whether the scan data is received at 612. If yes, a determination is made whether a next unscanned item needs to be scanned at 614. If yes, the process iteratively executes operations 608 through 614 until all unscanned items are scanned or the unscanned items are removed from the customer's basket. If there are no remaining unscanned items, the transaction is completed at 616. The transaction is completed when the user pays for the scanned items and a receipt is issued to the user. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an example flow chart illustrating operation of the computing device of FIG. 1B to identify unpaid items in real-time using computer vision detection and recognition results. The process 700 shown in FIG. 7 is performed by an unpaid item manager component, executing on a computing device, such as the computing device 102 or the user device 116 in FIG. 1B.

The process begins by selecting an image of a cart at 702. The cart is a selected cart, such as the selected cart 214 in FIG. 2B. An item detection model and an item recognition model identify items in the cart at 704. The item detection models include one or more item detection models, such as, but not limited to, the item detection model(s) 134 in FIG. 1B. The item recognition model predicts item IDs for the detected items at 706. The item recognition model includes one or more CV models, such as, but not limited to, the item recognition model(s) 136 in FIG. 1B. The unpaid item manager matches predicted item IDs to an e-receipt at 708. The unpaid item manager maps the receipt item IDs to the predicted item IDs at 710. A determination is made whether a verification request is received at 712. If yes, a notification is generated at 714. The unpaid item manager sends the notification to the UI at 716. The process terminates thereafter.

While the operations illustrated in FIG. 7 are performed by a computing device, such as shown in FIG. 1B, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

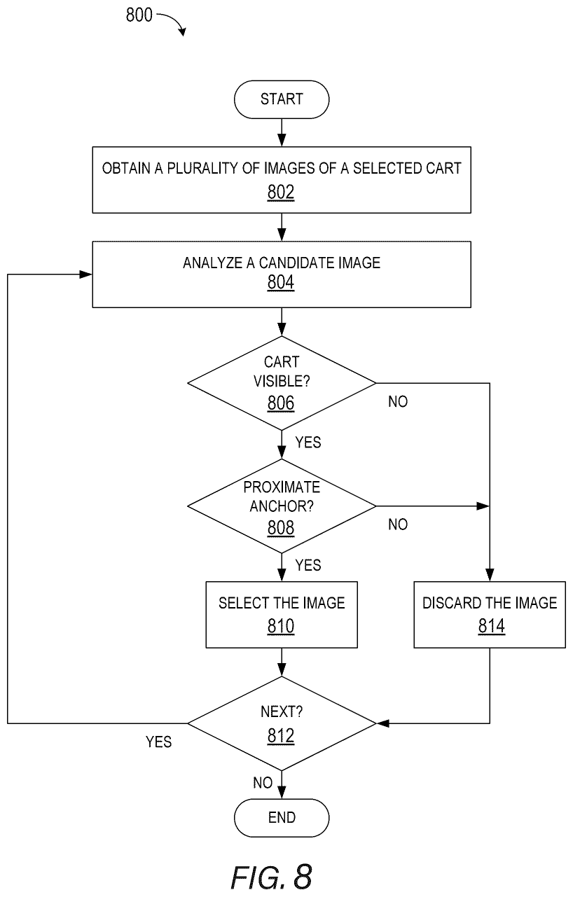

Referring now to FIG. 8, an example flow chart illustrating operation of the computing device to select images of a cart for use in identifying unpaid items is shown. The process 800 shown in FIG. 8 is performed by an unpaid item manager component, executing on a computing device, such as the computing device 102 or the user device 116 in FIG. 1B.

The process begins by obtaining a plurality of images of a selected cart at 802. The plurality of images includes images generated by an image capture device, such as, but not limited to, the image capture device(s) 227 in FIG. 2B. The unpaid item manager analyzes a candidate image at 804. A determination is made whether the cart is fully visible within the FOV of the camera at 806. If not, the image is discarded at 814. If the cart is visible, a determination is made whether the cart is proximate to an anchor point in the candidate image at 808. If not, the image is discarded at 814. If the cart is near the anchor, the image is selected at 810. A determination is made whether a next candidate image is available at 812. If yes, the process iteratively executes operations 804 through 812 until all the images are analyzed. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

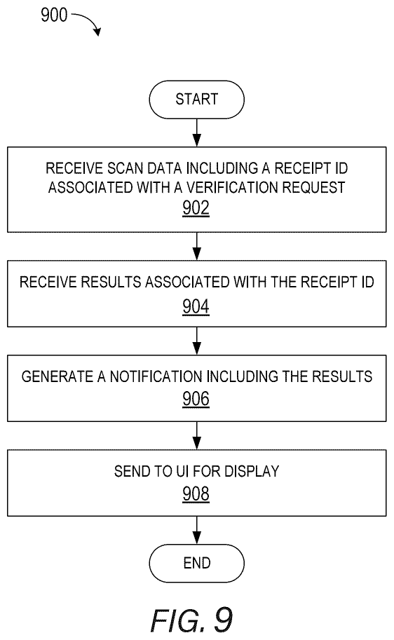

FIG. 9 is an example flow chart illustrating operation of the computing device to generate a notification in response to a verification request. The process 900 shown in FIG. 9 is performed by an unpaid item manager component, executing on a computing device, such as the computing device 102 or the user device 116 in FIG. 1B.

The process begins by receiving scan data including a receipt ID associated with a verification request at 902. The scan data is generated by a scan device, such as, but not limited to, the scan device 210 in FIG. 2B. The unpaid item manager retrieves results associated with the receipt ID at 904. The unpaid item manager generates a notification including the results at 906. The unpaid item manager sends the notification to a UI for display to a user at 908. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

### Example Retail Environments

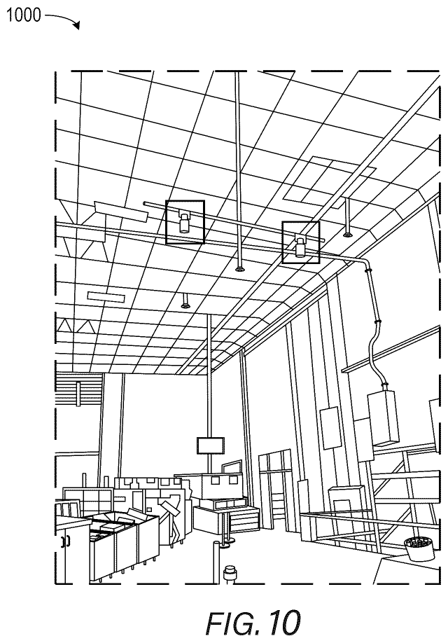

FIG. 10 is an example diagram 1000 illustrating exit CV hardware and camera settings. In this example, cameras monitor the exit for scan and go (SNG) and/or self-checkout (SCO) transactions. In this example, two ceiling mounted cameras are shown enclosed within bounding boxes. The cameras are mounted above an exit area in a retail environment. However, the examples are not limited to two ceiling mounted cameras. In other examples, the system includes three or more cameras mounted to the ceiling. In still other examples, the system includes additional other cameras mounted to other fixtures, such as, but not limited to, support pillars, walls, checkout devices, or any other fixture within a retail environment. The cameras and their respective views ensure comprehensive coverage of the exit area.

FIG. 11 is an example diagram 1100 of selecting representative cart images in the trajectory. The diagram 1100 includes cart indicators associated with a trajectory of shopping carts in a series of images relative to a set of three anchor points. In this example, the indicators include colored and/or shaded dots representing carts and anchor positions. The images in which the shopping cart is closest in proximity to the anchor points are the images that are selected.

In other examples, the images generated by the cameras are used for basket matching. During the basket matching process, the exit CV system generates a CV item list and skillfully matches it with active candidate receipts, effectively linking cart images generated by the cameras to the respective SNG receipts generated during cart checkout.

For example, if the exit CV system uses images of a customer cart to identify a list of items in the cart including a package of Brand “X” cookies, a package of Brand “Y” chips, a bottle of Brand “Z” soda, and a pineapple, the system attempts to match the list of identified items with a list of scanned items in a customer e-receipt. In this example, a first receipt includes a package of Brand “X” cookies, a package of Brand “Y” chips, a bottle of Brand “Z” soda, and a package of nuts. A second receipt includes paper towels, a package of Brand “X” cookies, a package of Brand “A” chips, and a bottle of water. A third receipt contains hotdog buns, beef ribs, tomatoes, and strawberries. In this example, the system matches the list of identified items captured in the image(s) with the first list of items associated with the first receipt because the items are the closest match.

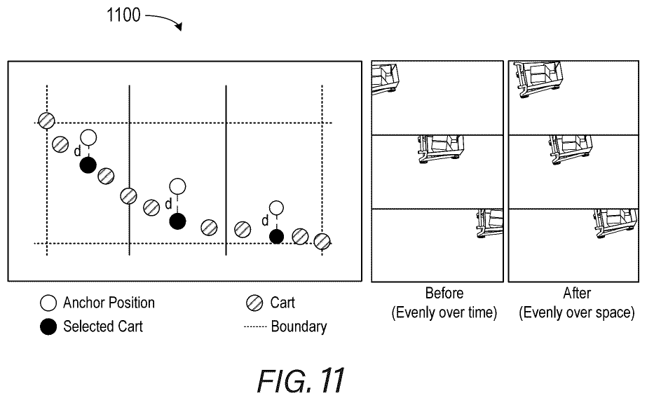

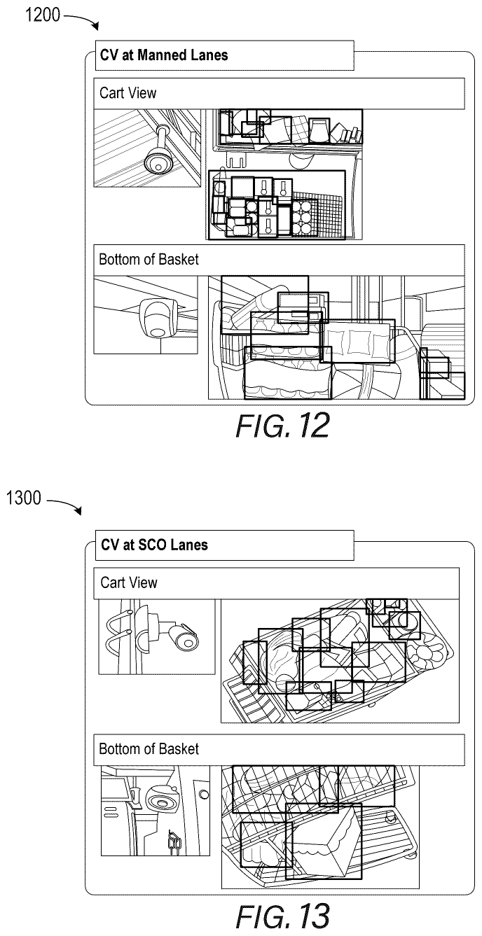

FIG. 12 is an example image 1200 showing a top view and a side view of a selected cart and a conveyor including a plurality of items at a staffed checkout. The selected cart in this example is enclosed in a bounding box. The items on the conveyor and inside the selected cart are also placed inside item detection bounding boxes. In this example, a camera is mounted to a ceiling above the checkout area and another camera is mounted to an underside of a portion of the POS device.

FIG. 13 is an example image 1300 showing a top view and a side view of a selected cart at a self-checkout (SCO). The image 1300 includes bounding boxes enclosing individual items inside the selected shopping cart. In this example, a camera is mounted to a ceiling above the checkout area and another camera is mounted to a side of the POS device.

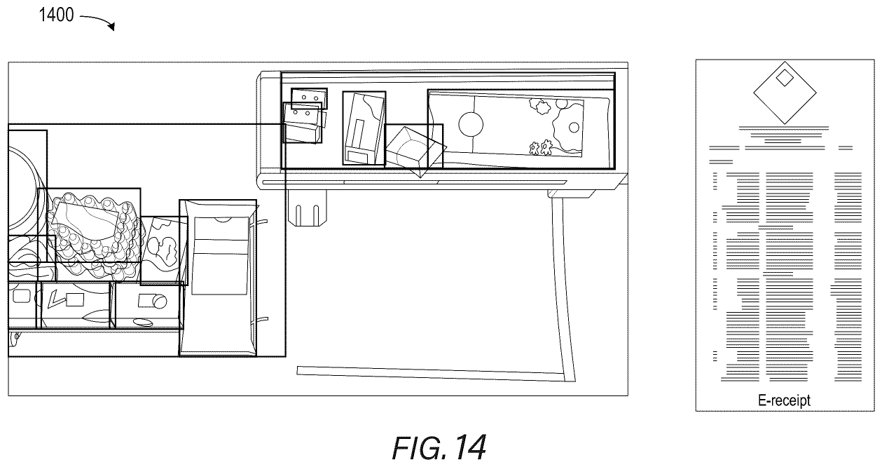

FIG. 14 is an example image 1400 showing a top view of a selected cart, a conveyor device and a receipt associated with a transaction. Bounding boxes are placed around the selected cart and around items on the cart and on the conveyor, belt associated with the POS device. In this example, the data fed into the frontend computer vision (CV) system consists of approximately 5-20 images capturing the transaction and the corresponding receipt.

In other examples, the system performs cart detection, item detection, and cart level depth estimation using one or more ML models, such as, but not limited to, a computer vision model. The system further performs recognition, classification, and verification of the items detected in the image data via the CV analysis of the image(s) of the cart(s). In an example, the computer vision model is a You Only Live Once Version Five (YOLOv.5) CV model.

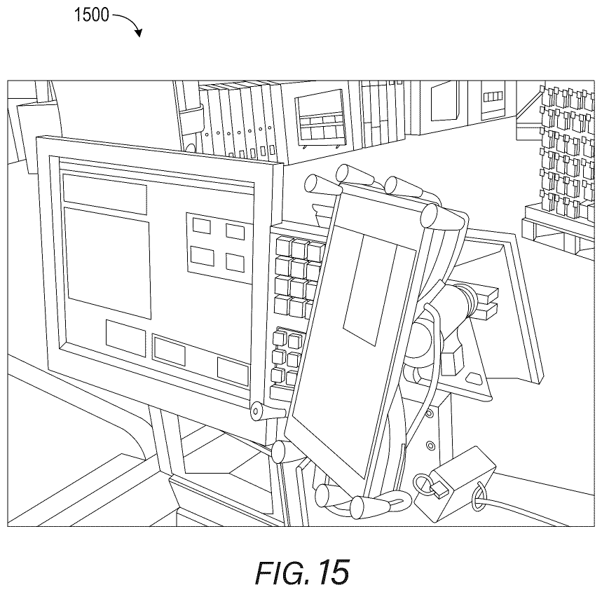

FIG. 15 is an example image 1500 of a user interface (UI) associated with a POS device for displaying an unscanned items notification to a user. The notification(s), in this example, are presented to the user via the UI attached to the POS device. However, in other examples, the notification(s) are presented to the user via a UI on a separate user device that is not connected or otherwise associated with the POS device, such as, but not limited to, the user device 116 in FIG. 1A.

In some examples, when the frontend computer vision (CV) system detects unpaid items during a transaction, upon receiving the ‘ready to pay’ signal, it will send notifications to the tablet mounted next to the checkout monitor. These notifications, in this example, display red bounding boxes, one at a time, on the checkout image, highlighting the unpaid items.

In this example, the POS device including a scanner for scanning items during a current transaction. As each item is scanned, scan data is transmitted to the item scan manager, such as, but not limited to, the item scan manager 140 on the computing device 102 in FIG. 1A.

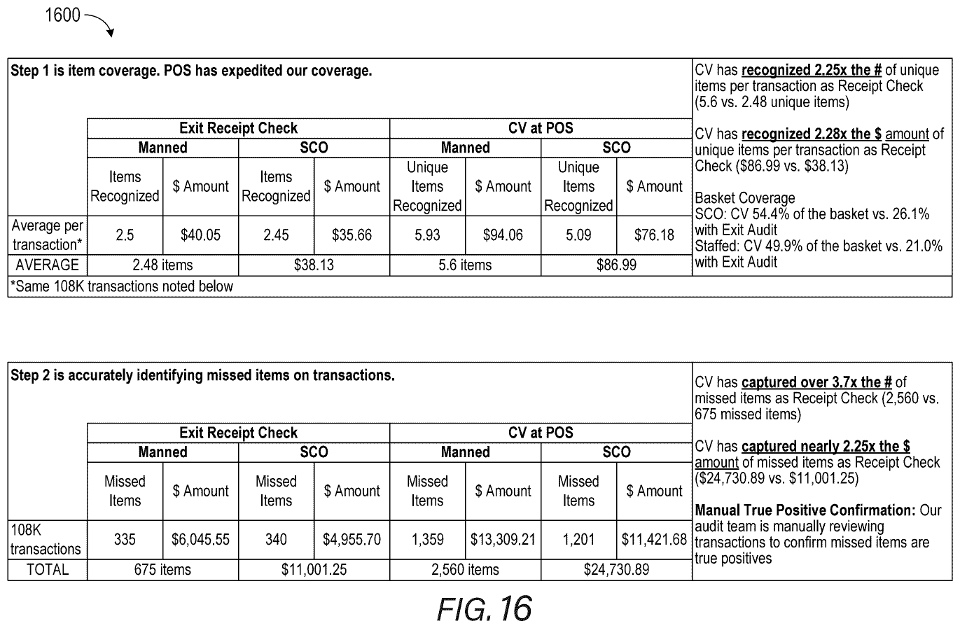

FIG. 16 is an example table 1600 illustrating performance of the frontend CV system over a receipt check system. When comparing the performance of the frontend CV system and the receipt check, the results clearly demonstrate the superiority of the frontend CV system over the receipt check, yielding significantly better outcomes.

In this example, extensive analysis of 108,000 transactions reveals that the frontend CV system consistently delivers significantly superior results when compared to the receipt check method. The CV system has increased item coverage, where it has recognized 2.25 times the number of unique items per transaction as the manual receipt check method (5.6 vs. 2.48 unique items). The CV has recognized 2.28 times the dollar amount of unique items per transaction as the manual receipt check ($86.99 vs. $38.13). The CV system accurately detects unpaid items. The CV system has captured over 3.7 times the number of missed items as the manual receipt check method (2,560 vs. 675 missed items). The CV has captured 2.25 times the dollar amount of missed items as the manual receipt check method ($24,730.89 vs. $11,001.25).

### Example Computer Architecture

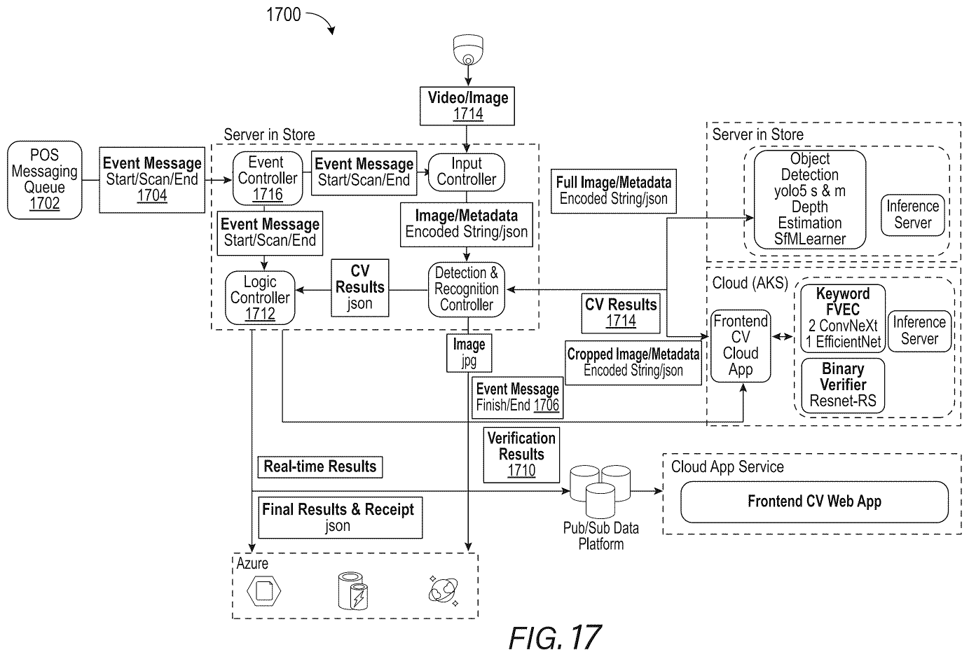

FIG. 17 is an example system architecture 1700 for frontend identification of unscanned items. In this example, the POS sends a signal to start at 1702. The signal is a start/scan/end event message 1704. As each item is scanned, the analysis occurs in real-time. The final CV results 1708 and verification results 1710 are generated when a finish/end signal 1706 is received, such as when a ready to pay option is selected. The results are aggregated. The results are provided, in this example, in a JSON format.

In some examples, an alert is sent if any items remain unscanned. The logic controller 1712 listens for messages from the checkout machine. When it receives a start message, the system obtains (reads) input messages containing image data from cameras, such as the video/image 1714. The images are used for item detection and recognition inferences.

As each item is scanned, a new message is sent from the event controller 1716 to the logic controller 1712 in a continual stream of event messaging as the items are scanned in real-time. A final message that the customer is ready to pay triggers generation of the notification if any items remain unscanned. The notification is published to a UI for viewing by an associate or by the customer. If this is manned/staffed lane, the message goes to the cashier. If this is self-checkout, the message goes to the customer at the self-checkout, or it goes to an associate monitoring the scan and go/self-checkout lanes. In another example, the notification is transmitted to a user device associated with a user performing a receipt check at an exit door.

In still other examples, if an unscanned item is detected, the notification is transmitted to a SCO or other checkout device. The notification instructs the customer to wait for an associate to assist the customer at the SCO. The associate optionally also receives a notification instructing the associated to assist the customer with scanning the missed items. For example, the SCO may display a notification that says, “wait for associate to assist you” or “scanning error.” This notification prevents the SCO transaction from completing until the associate enters a code or otherwise assists the user with scanning the missed items or removing the removing undesired items which were unscanned.

### Example User Interface Displays

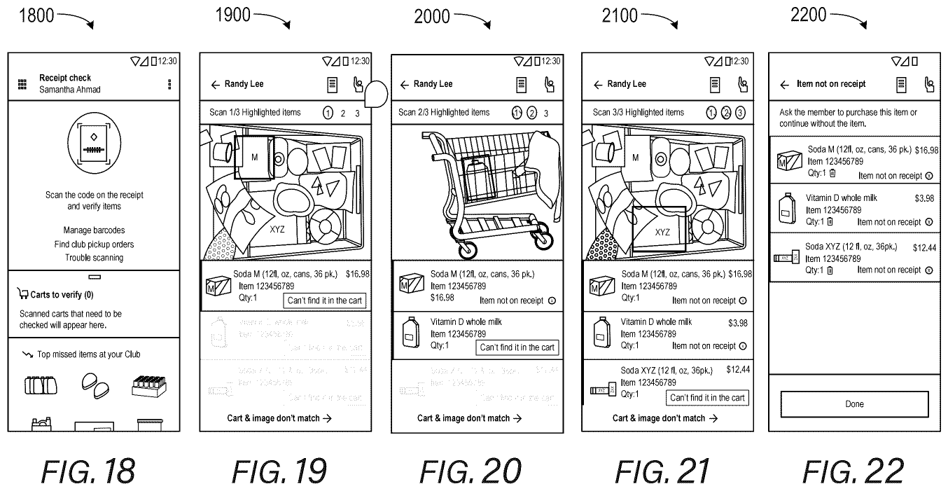

FIGS. 18-22 include example set screenshots of a set of notifications displayed via a UI associated with a checkout device, such as a staffed or unstaffed checkout. The notifications in this example display a list of the unscanned items, an image of the selected cart having the unscanned items highlighted by bounding boxes and/or an anchor image of each item is presented with the name, brand, variety, and other descriptive information associated with each unpaid item.

FIG. 18 is an example screenshot 1800 showing a receipt check screen displayed via a UI device. The receipt check screen is displayed to a user performing a receipt check at exit. During receipt check, an authorized user determines whether the items in a shopping cart matches the list of items in the receipt that is matched to the cart by the basket matching process.

FIG. 19 is an example screenshot 1900 of a scan items notification including a cart image with instructions to scan a sample of the items in the cart associated with the image. The notification includes instructions to scan highlighted items in the annotated cart image. The notification is presented to a user performing the receipt check via a user device, such as a tablet.

FIG. 20 is an example screenshot 2000 of a scan items notification including a cart image with a side view of a cart. The notification is presented to a user performing the receipt check via a user device, such as a tablet.

FIG. 21 is an example screenshot 2100 of a scan items notification including a cart image with highlighted items for scanning by a user prior to customer exit. The notification is presented to a user performing the receipt check via a user device, such as a tablet. In this example, the user is instructed to scan items in the cart to ensure the items in the cart are included on the receipt matched to the cart.

FIG. 22 is an example screenshot 2200 of an unscanned items notification displayed via a UI device. The notification is presented to a user performing the receipt check via a user device, such as a tablet. In this example, one or more items in the cart fails to appear on the receipt matched to the cart. These unscanned items should be scanned and paid for or removed from the cart prior to the customer exiting the store or other retail facility with the cart.

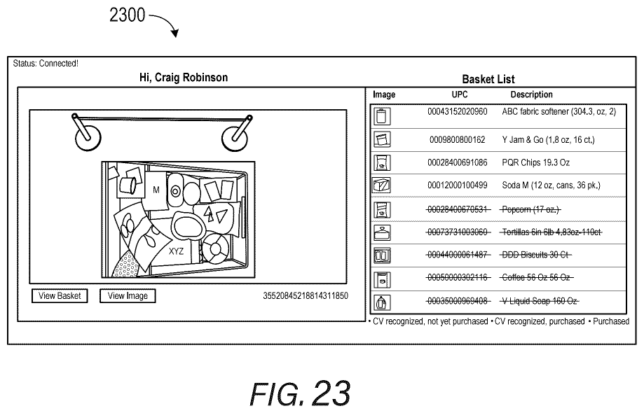

FIG. 23 is an example illustration of a gallery monitoring page 2300 displaying a set of paid items and a set of unpaid items. A user-friendly display on the Gallery monitor page, presenting a clear distinction between a list of paid items shown in “strikethrough” and a list of unpaid items shown without “strikethrough.” This information is accessible to club associates for convenient review. In some examples, the image(s) generated by the camera(s) include images of customers or other humans. The system, in some examples, crops the images to remove the images of the customers or other humans as the system is only concerned with the cart and cart contents.

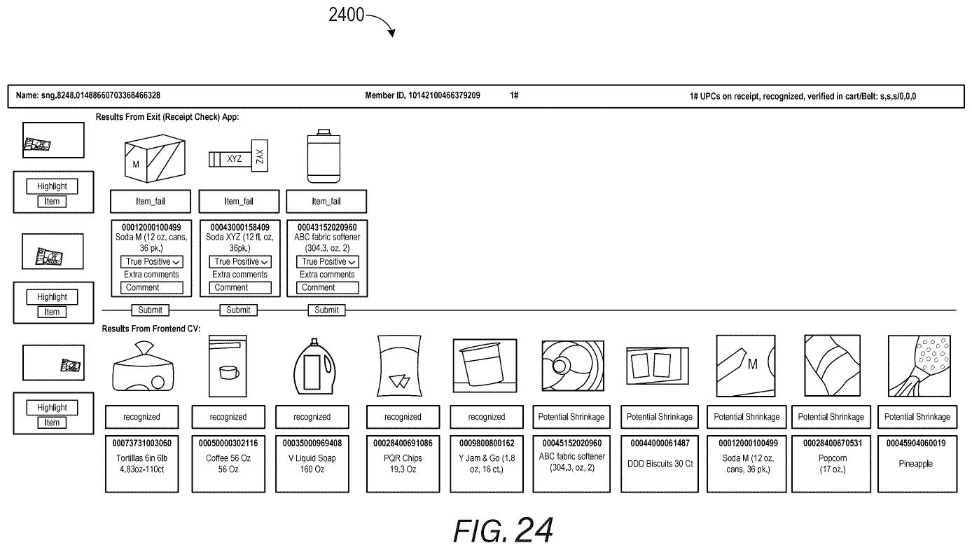

FIG. 24 is an example illustration of a gallery review page 2400 including a list of paid items and a list of unpaid items. The gallery review page 2400 exhibits a list of paid items and unpaid items. In some examples, the paid and unpaid items may be displayed in a contrasting manner so that they are readily distinguishable. For example, the paid and unpaid items may be displayed in different colors. In examples, the paid and unpaid items may be displayed in any color, including black. This page is made available to the labeling team, aiding the human labelers in identifying true positive (TP) and false positive (FP) items during transaction marking. These marked items contribute to the final evaluation metrics, enhancing the accuracy of the system.

### Example Archway Truss Devices

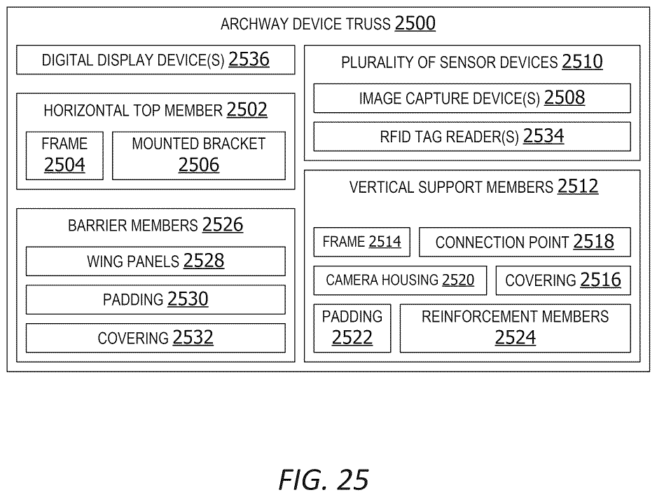

Referring now to FIG. 25, an example block diagram illustrating a system for an interactive exit lane via an archway truss device 2500 is shown. The archway truss device 2500 includes a horizontal top member 2502. The horizontal top member 2502 has a frame 2504. The frame 2504, in some examples, is a metal frame. However, the examples are not limited to a metal frame. In other examples, the frame 2504 is composed of any other appropriate material.

The horizontal top member 2502, in some examples, includes a mounting bracket 2506 or other attachment device for removably attaching an image capture device, such as, but not limited to, the one or more image capture device(s) 2508 in the plurality of sensor device(s) 2510 removably attached to the archway truss device 2500.

The archway truss device 2500 includes a plurality of vertical support members 2512. In some examples, the plurality of vertical support members 2512 includes two vertical support members defining a single lane of travel through the archway truss device 2500. In these examples, two vertical support members are spaced a predetermined distance apart which is sufficient to enable at least one user pushing a shopping cart or driving a motorized cart to pass between the two vertical support members of the archway truss device 2500 as the user proceeds toward the exit via the lane of travel between the two vertical support members.

In other examples, the plurality of vertical support members 2512 includes three vertical support members defining two distinct lanes of travel through the archway truss device 2500. In still other examples, the archway truss device 2500 includes four vertical support members defining three lanes of travel through the archway truss device 2500. In still other examples, the archway truss device 2500 includes five or more vertical support members defining four or more lanes of travel through the archway truss device.

Each vertical support member in the plurality of vertical support members 2512 includes a frame 2514 and a covering 2516 over the frame. Each vertical support member connects to the horizontal top member 2502 at a connection point 2518. The connection point 2518 is located at a top portion of each vertical support member.

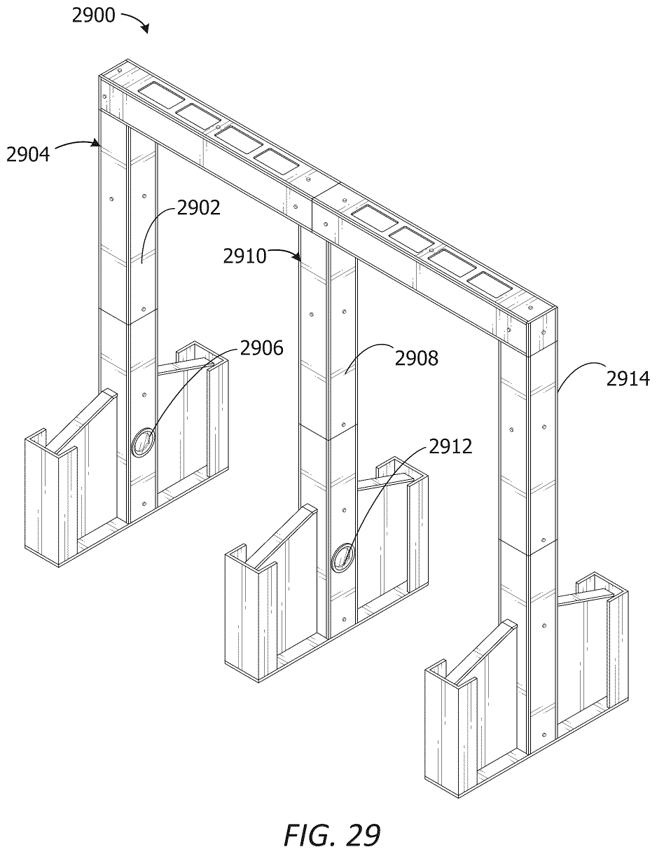

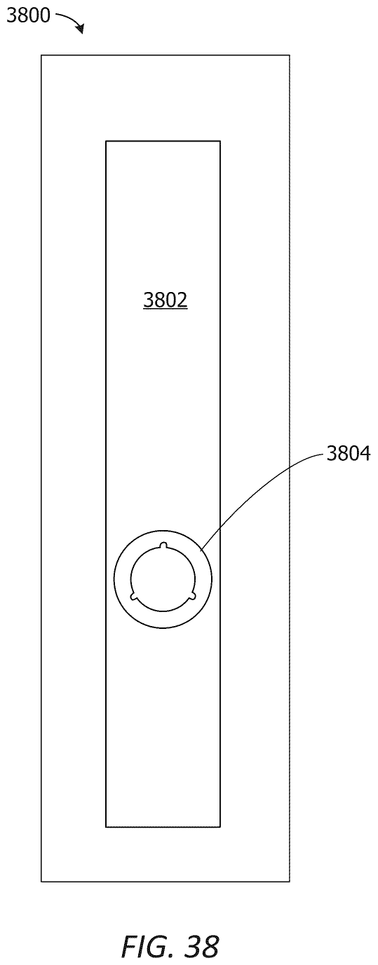

A camera housing 2520 is recessed within each vertical support member. The camera housing 2520 is sized to encompass an image capture device, such as a camera, as shown in FIGS. 29 and 38 below.

Each vertical support member in the plurality of vertical support members 2512 optionally includes one or more pieces of padding, such as, but not limited to, the padding 2522. The padding 2522 is any type of padding for cushioning the frame 2514 in case a user comes into contact with the vertical support member. The padding 2522 can include fabric padding, foam padding, cardboard padding, an air-filled padding, or any other type of padding.

The plurality of vertical support members 2512, in other examples, includes one or more reinforcement members 2524. A reinforcement member is a reinforcing material or substance designed to protect the archway truss device 2500 from impacts with motorized shopping carts or other heavy objects. The reinforcement members 2524 enable the archway truss device 2500 to remain intact and stable if a cart strikes a vertical support member in the plurality of vertical support members 2512.

The archway truss device 2500 includes a plurality of barrier members 2526 positioned perpendicular to the front facing and the back facing of the archway truss device 2500. Each barrier member includes a pair of wing panels, such as the wing panels 2528. One wing panel in the pair of wing panels is attached to a front face of a vertical support member. The second wing panel in the pair of wing panels is attached to a back face of the same vertical support member. A barrier member optionally includes padding 2530 around at least a portion of an exterior of the barrier member to provide protection to users from accidental contact with the barrier member. The padding 2530 can be implemented as cardboard, fabric, foam, or any other material to cushion hard surfaces, corners, and/or edges of the barrier.

The archway truss device 2500 provides support for a plurality of sensor devices 2510. The plurality of sensor devices 2510 includes one or more image capture device(s) 2508 and/or one or more radio frequency identification (RFID) tag reader(s) 2534. The image capture device(s) 2508 includes any type of device for generating images of objects, such as, but not limited to, a digital camera and/or an infrared (IR) camera. The RFID tag reader(s) 2534 include any type of device for detecting RFID signals from one or more RFID tags. The plurality of sensor devices 2510 are removably mounted to the archway truss device 2500.

In still other examples, the archway truss device 2500 includes one or more digital display device(s) 2536. A digital display device in the digital display device(s) 2536 is a device having a display screen for displaying content to a user, such as, but not limited to, still images and/or video content. The content can include text as well as images. In other examples, the digital display device(s) 2536 include speakers for outputting audio content to users. In still other examples, the digital display device(s) 2536 include one or more touch screens enabling users to provide input to a computing system, such as to make selections from one or more options provided via the digital display screen.

In some examples, the digital display device(s) 2536 includes one or more display screens mounted to at least a portion of a front facing of the archway truss device 2500 such that users approaching the archway truss device 2500 as they move away from a checkout area and towards an exit area can view content displayed on the digital display device(s) 2536.

In other examples, the digital display device(s) 2536 includes one or more display screens mounted to at least a portion of a back facing of the archway truss device 2500 such that users exiting the archway truss device 2500 and approaching the exit area can view content displayed on the digital display device(s) 2536 if they turn their heads or look behind them. Other uses entering through a main entrance adjacent to the exit can also view content displayed on the one or more digital display device(s) 2536 mounted to the back facing of the archway truss device 2500.

In still other examples, the archway truss device 2500 includes digital display devices mounted to both the front facing and the back facing of the archway truss device. In still other examples, one or more digital display devices in the digital display device(s) 2536 are mounted to portions of the front facing of the archway truss device, portions of one or more side facings of the archway truss device, and/or portions of the back facing of the archway truss device 2500.

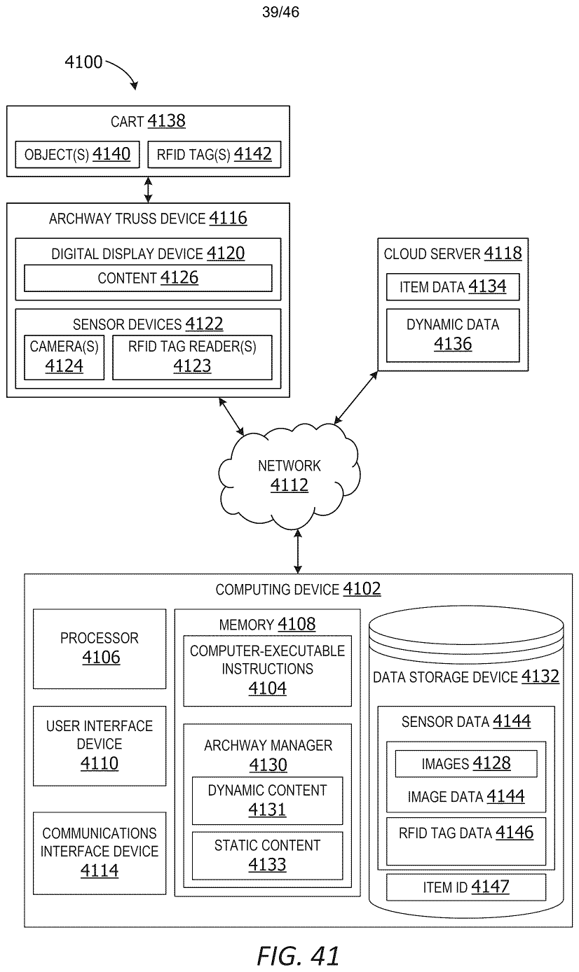

The digital display device(s) 2536 in some examples includes a processor, a memory, and/or a communications interface device enabling the digital display device(s) 2536 to receive content from a computing device and/or a cloud server, as shown in FIG. 41 below. The digital display device(s) 2536 optionally also receive input from users via one or more touch screens associated with the digital display device(s) 2536. In some examples, the digital display device(s) 2536 optionally transmits user inputs to the computing device and/or cloud server.

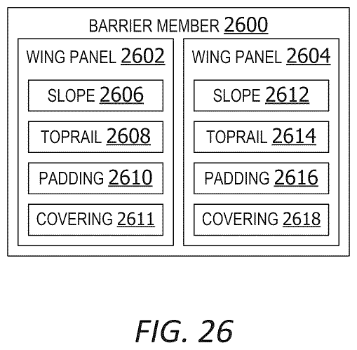

FIG. 26 is an example block diagram illustrating a barrier member 2600 for blocking a field of view (FOV) of a set of cameras from objects outside an exit lane of the archway truss. The barrier member 2600 is a barrier attached to a vertical support member of an archway truss, such as, but not limited to, a barrier in the plurality of barrier members 2526 in FIG. 25.

The barrier member 2600 includes a pair of wing panels, such as, but not limited to, the wing panel 2602 and wing panel 2604. The wing panel 2602 has a slope 2606 such that the top rail 2608 of the wing panel slopes downward and away from the vertical support member. The wing panel 2602 optionally includes padding 2610 and/or a covering 2611 over an internal frame of the wing panel.

The wing panel 2604 also includes a slope 2612 such that a top rail 2614 slopes downward away from the vertical support member. The wing panel 2604 optionally includes padding 2616 and/or a covering 2618 over an internal frame of the wing panel 2604.

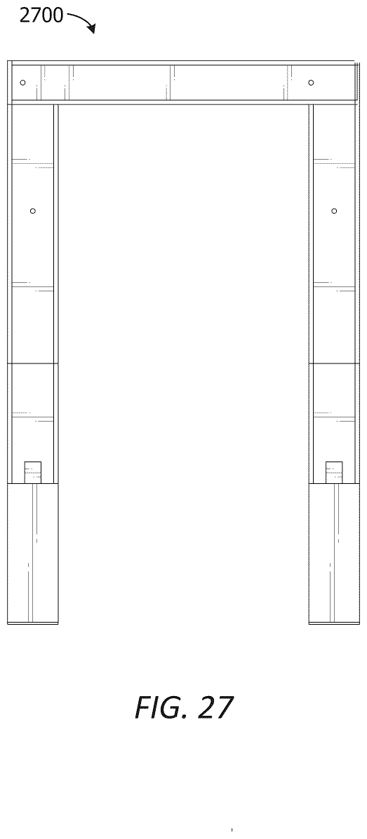

Referring now to FIG. 27, an example diagram illustrating a single lane archway truss 2700 having a pair of barriers is shown. The archway truss 2700 is a device for supporting a plurality of sensor devices, such as, but not limited to, the archway truss device 2500 in FIG. 25. In this example, a first vertical support member is attached to a horizontal top member at a first connection point. A second vertical support member is attached to the horizontal top member at a second connection point.

The first vertical support member includes a barrier member. In this non-limiting example, one wing panel of the barrier member is visible. The second vertical support member includes a barrier member. In this example, one wing panel of the barrier member attached to the second vertical support member is visible. The first vertical support member and the second vertical support member define a lane of travel beneath the arch. The first vertical support member and the second vertical support member are spaced apart a pre-defined distance sufficient to enable a single user pushing a cart, carrying a basket, or riding in a motorized cart to pass through the archway between the vertical support members of the archway truss 2700.

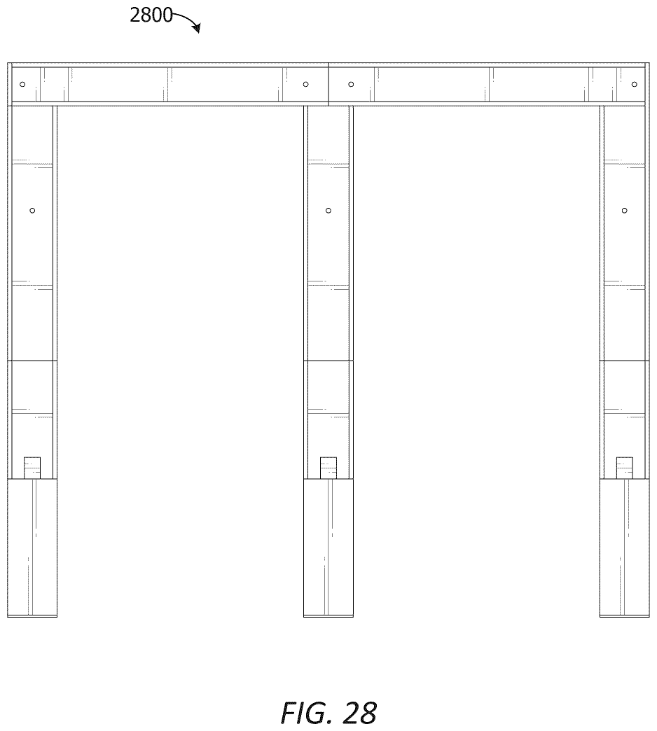

In this example, only two vertical support members are provided to create a single lane of travel through the archway truss. However, the examples are not limited to only two vertical support members. In other examples, the archway truss 2700 includes three or more vertical support members, as shown in FIGS. 28-32 below.

FIG. 28 is an example diagram illustrating a front view of a multi-lane archway truss 2800 having a plurality of barrier members. The archway truss 2800 is a device for supporting a plurality of sensor devices, such as, but not limited to, the archway truss device 2500 in FIG. 25.

The multi-lane archway truss 2800 includes three vertical support members, a left side vertical support member, a central support member, and a right side vertical support member. The central support member is a vertical support member positioned between two other vertical support members. The central support member optionally includes additional reinforcement to protect the central support member against collisions from carts.

The left side vertical support member, a portion of the horizontal top member and the central support member form a first lane of travel through the archway. The central support member, a second portion of the horizontal top member and the right side vertical support member form a second lane of travel through the archway.

Each vertical support member in this example includes a barrier member. A wing panel of each barrier member is visible. For example, the wing panel of the right side vertical support member is visible in FIG. 28. The wing panel includes a sloping top rail, such as, but not limited to, the sloping top rail 2608 and/or the sloping top rail 2614 in FIG. 26.

FIG. 29 is an example diagram illustrating a perspective view of a multi-lane archway truss 2900 having a plurality of barrier members. In this example, the multi-lane archway truss 2900 includes three vertical support members with a horizontal top member forming two lanes or passageways through the archway. In this example, each lane is associated with a checkout device, such as a point-of-sale (POS) device, a self-checkout (SCO) device or other checkout terminal. For example, one lane is associated with a first checkout terminal while the second lane is associated with a second checkout such that a user completing checkout at the first terminal exits via the first lane and a different user checking out at the second terminal exits via the second lane.

In some examples, the multi-lane archway truss 2900 includes one or more recessed camera housings within one or more vertical support members. In this example, an interior side 2902 of a first vertical support member 2904 includes a recessed camera housing 2906. A camera is placed inside the recessed camera housing 2906. The camera captures images of a side and/or bottom of a cart, such as a shopping cart, motorized cart or basket carried by a user moving through a first lane defined by the first vertical support member 2904 and the central support member 2910.

Likewise, an interior side 2908 of the central support member 2910 also includes another recessed camera housing 2912 for a camera. The camera inside the recessed camera housing 2912 captures images of a side and/or bottom of a cart moving through the second lane defined by the central support member 2904 and a second vertical support member 2914.

In other examples, the central support member 2910 includes two recessed camera housings. The recessed camera housing 2912 is located on a first side of the central support member 2910 facing toward the second vertical support member 2914, such that the camera in the recessed camera housing can capture images of objects in the second lane. A second recessed camera housing (not shown) is located on an opposite side of the central support member facing toward the first vertical support member 2904 sch that a camera in the second recessed camera housing can capture images of objects moving through the first lane.

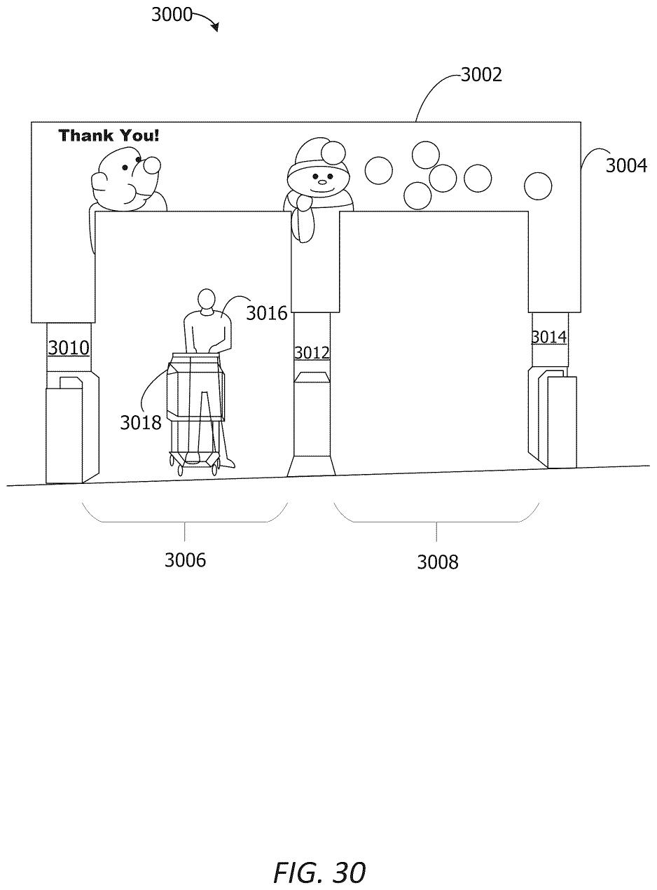

FIG. 30 is an example diagram illustrating a multi-lane archway truss 3000 having a digital display device 3002. The multi-lane archway truss 3000 is an archway truss device, such as, but not limited to, the archway truss device 2500 in FIG. 25. In this example, the multi-lane archway truss 3000 defines a first lane 3006 and a second lane 3008. The digital display device 3002 is a device for displaying video content, such as, but not limited to, the digital display device(s) 2536 in FIG. 25. The digital content includes still images, digital video, and/or audio content.

The first lane is defined by the first vertical support member 3010, a portion of the horizontal top member, and the central support member 3012. The second lane 3008 is defined by the central support member 3012, a portion of the horizontal top member, and the second vertical support member 3014. In this non-limiting example, a user 3016 pushes a cart 3018 from a checkout terminal through the first lane 3006 as the user 3016 moves towards an exit.

In this example, the digital display device 3002 is located on a top portion of the multi-lane archway truss 3000. The digital display device 3002 covers all of the horizontal top member as well as a top portion of each vertical support member. However, the examples are not limited to a single digital display device. In other examples, the digital display device 3002 includes two or more digital display devices attached to one or more locations on the multi-lane archway truss. Likewise, the digital display device is not limited to covering all of the horizontal top members and/or only a portion of the vertical support members. In other examples, a screen of the digital display device covers only a portion of the horizontal top member. In still other examples, the digital display device covers all of one or more of the vertical support members.

In this example, the digital display device 3002 is located on a back facing side 3004 of the multi-lane archway truss. However, in other examples, the digital display device is attached to the opposite (front facing) side of the multi-lane archway truss 3000.

The multi-lane archway truss 3000 includes a plurality of sensor devices, such as cameras, which capture data associated with objects in the cart 3018 as the user 3016 moves through the first lane 3006 of the multi-lane archway truss 3000. For example, a camera within a recessed camera housing of the first vertical support member, a camera mounted to a portion of the horizontal top member above the first lane 3006 and a camera mounted within another recessed camera housing of the central support member 3012 captures multiple images of the objects in the cart from multiple different angles as the user 3016 moves through the archway without requiring the user to pause or stop as they exit the retail facility. Other sensor devices, such as RFID tag readers, barcode readers, or other sensor devices capture additional item identification data as the user 3016 moves through the archway.

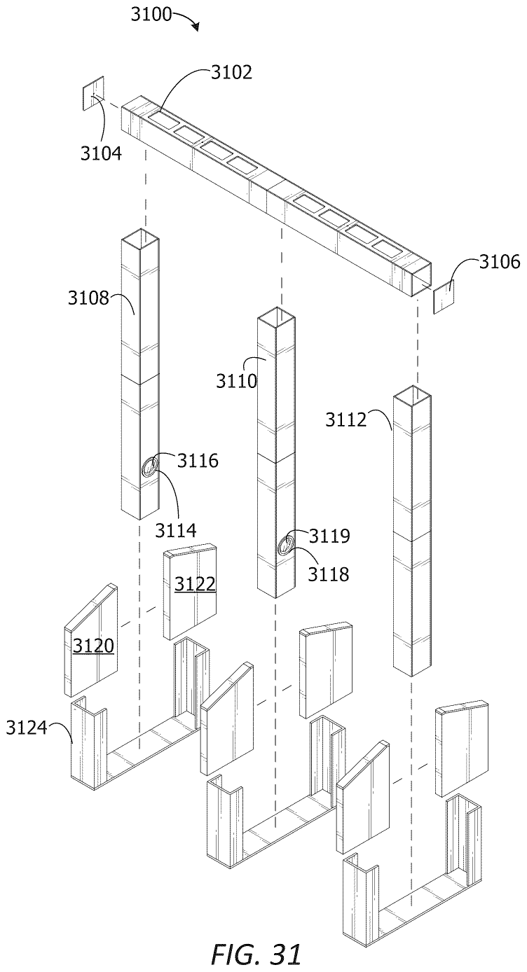

FIG. 31 is an example diagram illustrating an exploded view of a multi-lane archway truss 3100 having a plurality of barrier members. The multi-lane archway truss 3100 in some examples includes a horizontal top member frame 3102 and a cover, such as the end cap covering 3104 and end cap covering 3106.

In other examples, the multi-lane archway truss 3100 includes a plurality of vertical support members, such as, but not limited to, the plurality of vertical support members 2512 in FIG. 25. In this example, the plurality of vertical support members includes a first vertical support member 3108, a second vertical support member 3110, and a third vertical support member 3112. The second vertical support member 3110 can also be referred to as a central support member.

Each vertical support member includes at least one camera housing. In this example, the first vertical support member 3108 includes a recessed camera housing 3114 partially recessed within a frame of the first vertical support member 3108. The recessed camera housing 3114 at least partially encloses a camera 3116 associated with an interior side of the first vertical support member 3108. The second vertical support member 3110, in this example, includes a recessed camera housing 3118 associated with an interior (inward facing) side of the second vertical support member 3110. The recessed camera housing 3118 partially encloses a camera 3119.

Each vertical support member includes a barrier member. In this example, a first barrier member associated with the first vertical support member 3108 includes a first wing panel 3120 and a second wing panel 3122. The pair of wing panels sit within a base member 3124. The pair of wing panels, including the first wing panel 3120 and the second wing panel 3122, with the base member forms a first barrier member of the first vertical support member.

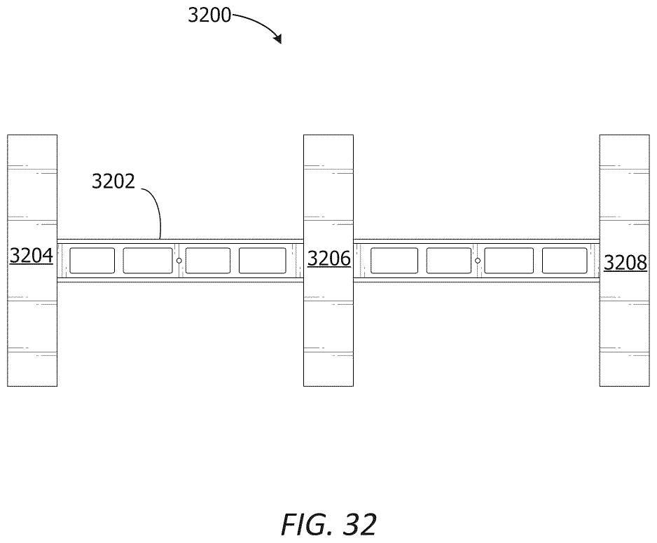

FIG. 32 is an example diagram illustrating a top view of the multi-lane archway truss 3200 having a plurality of barrier members. In this example, a horizontal top member 3202. A plurality of barrier members associated with the multi-lane archway truss 3200 includes a first barrier member 3204, a second barrier member 3206, and a third barrier member 3208.

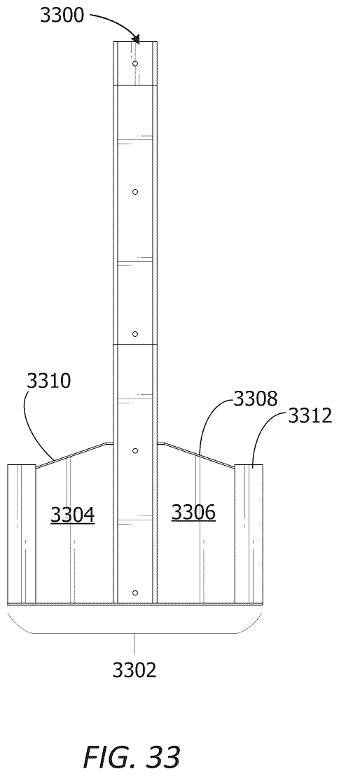

FIG. 33 is an example diagram illustrating an exterior side of a vertical support member 3300 having a barrier member 3302. The barrier member 3302 includes a first wing panel 3304 and a second wing panel 3306 forming a pair of wing panels. Each wing panel includes a sloping top rail, such as, but not limited to, the sloping top rail 3308 of the second wing panel 3306 and the sloping top rail 3310 associated with the first wing panel 3304. The pair of wing panels both sit within a base member 3312.

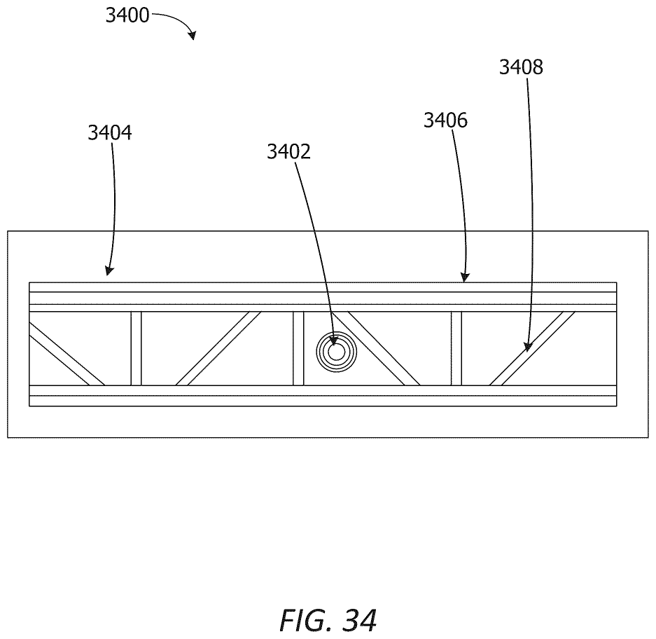

Turning now to FIG. 34, an example diagram illustrating a camera 3402 mounted to a horizontal top member 3404 is shown. The camera 3402 is mounted to a frame 3408 of the horizontal top member 3404 via a mounting bracket, in this example. The frame 3408 is at least partially covered with a covering 3406.

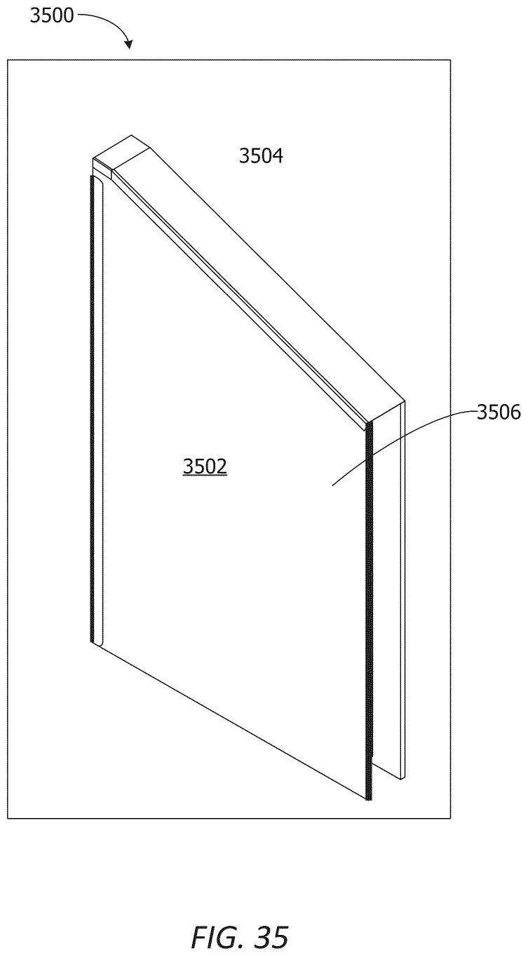

FIG. 35 is an example diagram illustrating a wing panel 3502 having a sloping top edge 3504. The wing panel optionally includes padding or other material within an interior of the wing panel and/or on an exterior surface of the wing panel to provide protection to users coming into contact with the wing panel. In this example, the interior frame of the wing panel is not visible due to a covering 3506 over the frame.

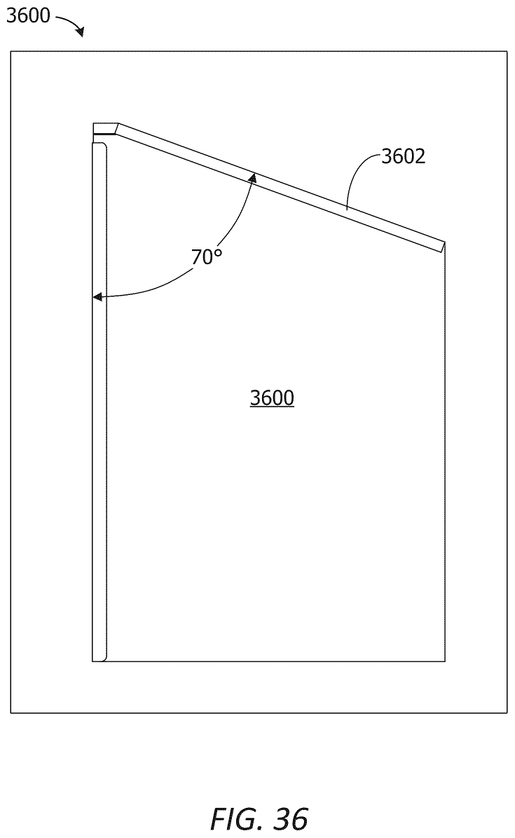

FIG. 36 is an example diagram illustrating a side view of a wing panel 3600 having a sloping top rail 3602. In this example, there is a seventy degree angle associated with the top rail forming the downward slope of the wing panel. However, the examples are not limited to a wing panel having a seventy degree angle at the top corner to form a slope. In other examples, the angle may be greater than shown in FIG. 36 or less than the angle shown in FIG. 36.

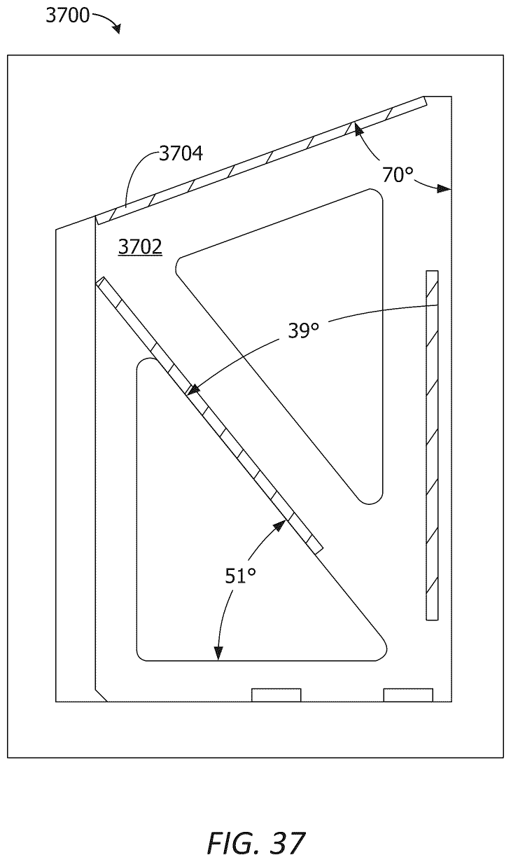

FIG. 37 is an example diagram illustrating a side view of a wing panel 3700 frame 3702 without an exterior covering. The top rail 3704 of the wing panel 3700 has a downward slope, in this non-limiting example. However, in other examples, the top rail of the wing panel is substantially level and does not have a slope. In still other examples, the top rail has an upward slope instead of a downward slope.

FIG. 38 is an example diagram illustrating an interior side 3802 of a vertical support member 3800 having a recessed camera housing 3804. In this example, the camera housing is recessed within the vertical support member. However, in other examples, the camera housing is not completely recessed within the vertical support member. Instead, the camera housing at least partially protrudes outside the vertical support member.

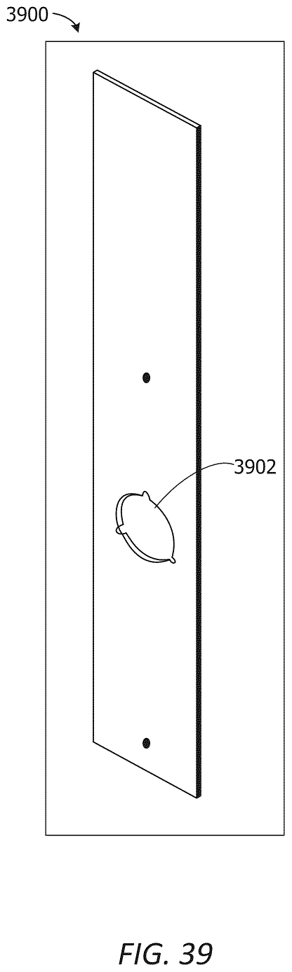

FIG. 39 is an example diagram illustrating an exterior covering 3900 for a vertical support member including an aperture 3902 for a camera housing. The aperture is a substantially round opening to accommodate the FOV of a camera within a recessed camera housing of the vertical support member. However, the examples are not limited to a round aperture. In other examples, the recessed camera housing has a square aperture, a rectangular aperture, an oval shaped aperture, or any other shape.

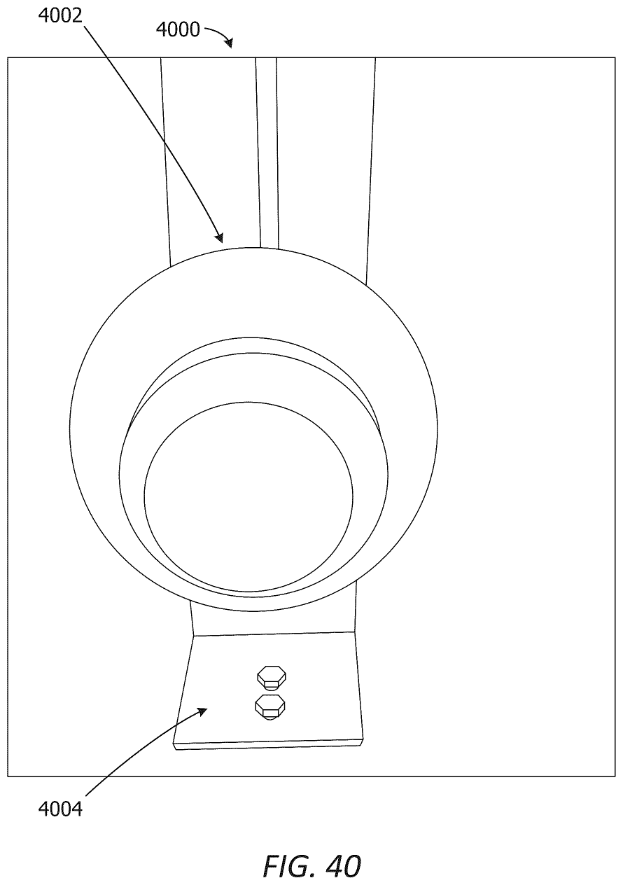

FIG. 40 is an example diagram illustrating a camera 4002 mounted to a horizontal top member via a mounting bracket 4004. However, the examples are not limited to mounting a camera to a portion of a horizontal top member via a bracket. In other examples, the camera is removably attached to a portion of the horizontal top member via a camera housing, a camera socket, or any other device for removably attaching a camera to a frame of a horizontal top member.

FIG. 41 is an example block diagram illustrating a system 4100 for an interactive multi-lane archway truss displaying customizable content to users while generating sensor data associated with objects moving towards an exit. In the example of FIG. 41, the computing device 4102 represents any device executing computer-executable instructions 4104 (e.g., as application programs, operating system functionality, or both) to implement the operations and functionality associated with the computing device 4102.

The computing device 4102, in some examples includes a mobile computing device or any other portable device. A mobile computing device includes, for example but without limitation, a mobile telephone, laptop, tablet, computing pad, netbook, gaming device, and/or portable media player. The computing device 4102 can also include less-portable devices such as servers, desktop personal computers, kiosks, or tabletop devices. Additionally, the computing device 4102 can represent a group of processing units or other computing devices.

In some examples, the computing device 4102 has at least one processor 4106 and a memory 4108. The computing device 4102, in other examples includes a user interface device 4110.

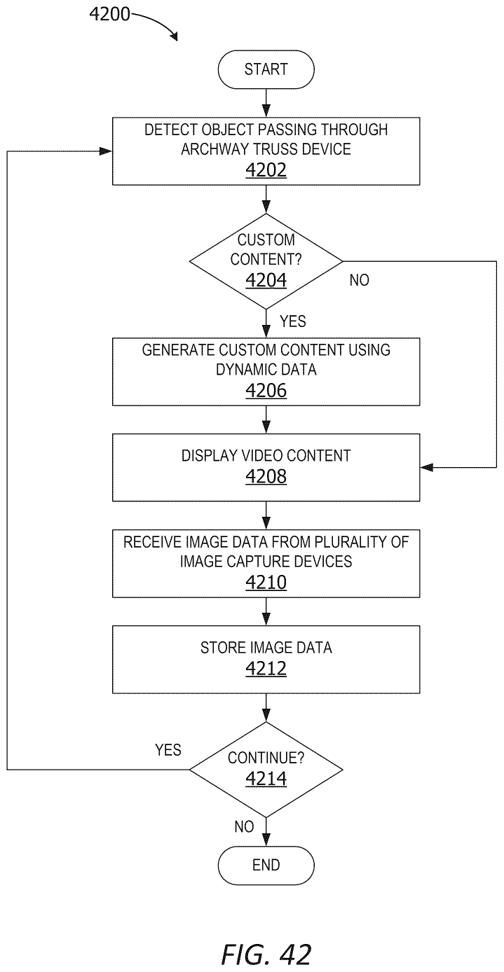

The processor 4106 includes any quantity of processing units and is programmed to execute the computer-executable instructions 4104. The computer-executable instructions 4104 are performed by the processor 4106, performed by multiple processors within the computing device 4102 or performed by a processor external to the computing device 4102. In some examples, the processor 4106 is programmed to execute instructions such as those illustrated in the figures (e.g., FIG. 42).

The computing device 4102 further has one or more computer-readable media such as the memory 4108. The memory 4108 includes any quantity of media associated with or accessible by the computing device 4102. The memory 4108 in these examples is internal to the computing device 4102 (as shown in FIG. 41). In other examples, the memory 4108 is external to the computing device (not shown) or both internal and external (not shown). The memory 4108 can include read-only memory and/or memory wired into an analog computing device.

The memory 4108 stores data, such as one or more applications. The applications, when executed by the processor 4106, operate to perform functionality on the computing device 4102. The applications can communicate with counterpart applications or services such as web services accessible via a network 4112. In an example, the applications represent downloaded client-side applications that correspond to server-side services executing in a cloud.

In other examples, the user interface device 4110 includes a graphics card for displaying data to the user and receiving data from the user. The user interface device 4110 can also include computer-executable instructions (e.g., a driver) for operating the graphics card. Further, the user interface device 4110 can include a display (e.g., a touch screen display or natural user interface) and/or computer-executable instructions (e.g., a driver) for operating the display. The user interface device 4110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 4102 in one or more ways.

The network 4112 is implemented by one or more physical network components, such as, but without limitation, routers, switches, network interface cards (NICs), and other network devices. The network 4112 is any type of network for enabling communications with remote computing devices, such as, but not limited to, a local area network (LAN), a subnet, a wide area network (WAN), a wireless (Wi-Fi) network, or any other type of network. In this example, the network 4112 is a WAN, such as the Internet. However, in other examples, the network 4112 is a local or private LAN.

In some examples, the system 4100 optionally includes a communications interface device 4114. The communications interface device 4114 includes a network interface card and/or computer-executable instructions (e.g., a driver) for operating the network interface card. Communication between the computing device 4102 and other devices, such as but not limited to an archway truss device 4116 and/or a cloud server 4118, can occur using any protocol or mechanism over any wired or wireless connection. In some examples, the communications interface device 4114 is operable with short range communication technologies such as by using near-field communication (NFC) tags.

The archway truss device 4116, the digital display device 4120, and/or the sensor devices 4122 of the archway truss device 4116 includes one or more communications interface devices which enables the archway truss device, the digital display device 4120 and/or a plurality of sensor devices 4122 on the archway truss device 4116 to communicate with the computing device 4102 and/or the cloud server 4118 via the network 4112. In some examples, the archway truss device 4116, the digital display device 4120, and/or the sensor devices 4122 includes at least one processor and a memory. The archway truss device 4116 optionally also includes a user interface device, such as a touchscreen or other input/output device associated with the digital display device 4120 or other component of the archway truss device.

The digital display device 4120 is a device for displaying content 4126 via a screen, such as a digital display screen or a touch screen. The digital display device 4120 is optionally implemented as a light emitting diode (LED), liquid crystal display (LCD), cathode ray tube (CRT), or any other type of display screen.

The plurality of sensor devices 4122 is a plurality of devices for gathering data associated with one or more objects passing through the archway truss device 4116. The plurality of sensor devices 4122 includes sensor devices, such as, but not limited to, one or more RFID tag reader(s) 4123 and/or one or more camera(s) 4124 for capturing images 4128 of objects in a cart, such as a shopping cart, a motorized cart, a hand-held basket, or any other type of cart. The RFID tag reader(s) 4123, in some examples, generate sensor data 4144, including RFID tag data 4146 obtained from one or more RFID tag(s) 4142 on the one or more object(s) 4140 detected in a cart 4138.

The cloud server 4118 is a logical server providing services to the computing device 4102 or other clients, such as, but not limited to, the digital display device 4120. The cloud server 4118 is hosted and/or delivered via the network 4112. In some non-limiting examples, the cloud server 4118 is associated with one or more physical servers in one or more data centers. In other examples, the cloud server 4118 is associated with a distributed network of servers.

In some examples, the cloud server 4118 stores item data 4134 and/or dynamic data 4136. Item data 4134 is data associated with object(s) 4140 detected in a user cart 4138. The item data 4134 includes an item ID 4147 for each detected object captured in the images 4128 and/or identified using the RFID tag data 4146.

The system 4100 can optionally include a data storage device 132 for storing data, such as, but not limited to sensor data 4144 generated by the plurality of sensor devices 4122 and/or item ID 4147 for the object(s) 4140. The sensor data 4144 includes image data 4144 associated with the images 4128 and/or the RFID tag data 4146. The data storage device 4132 can include one or more different types of data storage devices, such as, for example, one or more rotating disks drives, one or more solid state drives (SSDs), and/or any other type of data storage device. The data storage device 4132 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 4132 includes a database.

The data storage device 4132 in this example is included within the computing device 4102, attached to the computing device, plugged into the computing device, or otherwise associated with the computing device 4102. In other examples, the data storage device 4132 includes a remote data storage accessed by the computing device via the network 4112, such as a remote data storage device, a data storage in a remote data center, or a cloud storage.

The memory 4108 in some examples stores one or more computer-executable components, such as, but not limited to, archway manager 4130. The archway manager component, when executed by the processor 4106 of the computing device 4102, receives the images 4128 from the camera(s) 4124 and stores them as image data 4144 in the data storage device 4132 for use in CV object detection and recognition. The archway manager 4130 generates dynamic content 4131 using dynamic data 4136. The dynamic data 4136 includes seasonal data associated with a season of the year, holidays, weather forecast, current weather conditions, local events, local trends, promotions, themes, instructional information or directions for users, information dissemination, etc. Dynamic data can also include user input, such as user selections of themes or content selected via an application on a user device, selections made via a touch screen, and/or selections made via the computing device 4102.

The system can alternatively select static content 4133. Static content 4133 is any pre-planned or pre-generated content which is presented via the digital display device without regard to dynamic data 4136. The dynamic content 4131 and the static content 4133 includes still images, moving video images and/or audio content.

FIG. 42 is an example flow chart illustrating operation of a computing device to generate content for display to a user and receive image data from a plurality of camera devices associated with the archway truss. The process 4200 shown in FIG. 42 is performed by an archway manager, executing on a computing device, such as the computing device 4102 in FIG. 41.

The process begins by detecting one or more objects passing through the archway truss device at 4202. The objects are detected by a plurality of sensor devices, such as, but not limited to, the plurality of sensor devices 2510 in FIG. 25. A determination is made whether the generate custom content for presentation to the user via a digital display device at 4204. If yes, customized content is generated using dynamic data at 4206. The content includes video content, such as still images or moving video images. The video content optionally includes audio content. The video content is displayed at 4208. The content is displayed via a digital display device, such as, but not limited to, the digital display device(s) 2536 in FIG. 25. Image data is received from a plurality of image capture devices at 4210. The image capture devices are devices for capturing images of objects passing through the archway truss, such as, but not limited to, the plurality of image capture device(s) 2508 in FIG. 25. The image data is stored at 4212. The image data is stored in a data storage device, such as, but not limited to, the data storage device 4132 in FIG. 41. A determination is made whether to continue at 4214. If yes, the process iteratively executes operations 4202 through 4212 until a determination is made not to continue at 4214. The process terminates thereafter.

While the operations illustrated in FIG. 42 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 42.

### Example Store Fixtures with Personalized Advertisements

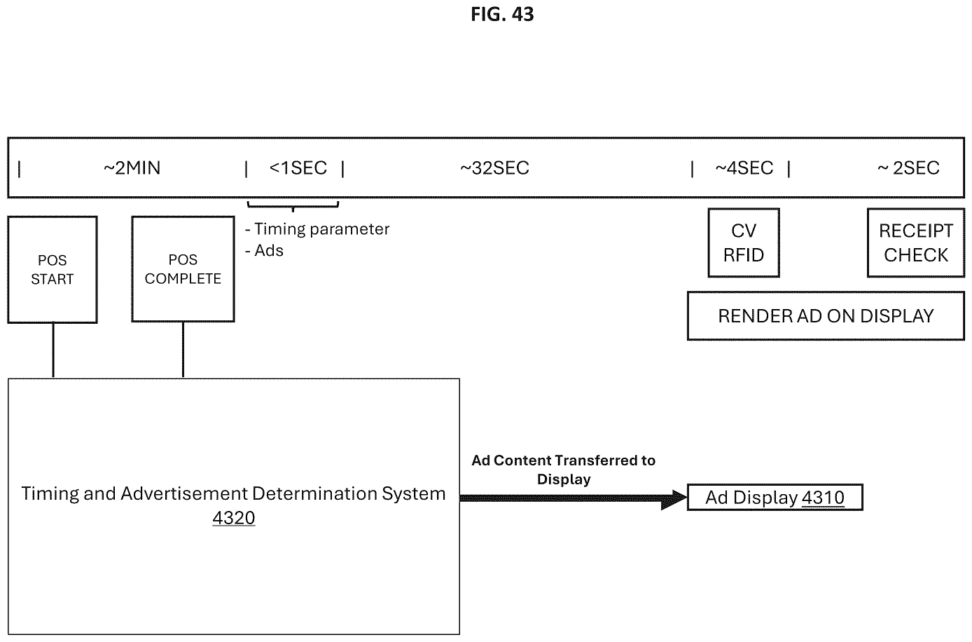

FIG. 43 illustrates aspects of a store environment and process flow for determining and displaying personalized ads to a customer or user initiating a POS transaction and thereafter exiting the store. It should be noted that times displayed and discussed with reference to FIG. 43 and elsewhere are merely exemplary. As seen in FIG. 43, it may take a certain amount of time, e.g., up to approximately 2 minutes on average, for a customer to initiate and complete a POS transaction. During this timeframe, or shortly after this timeframe, user-profile information of the customer is retrieved or accessed by the timing and advertisement determination system 4320 and one or more personalized advertisements are determined by timing and advertisement determination system 4320 based on the user profile information and/or information about the POS transaction (e.g., product(s) purchased). Additionally, a timing parameter is determined by timing and advertisement determination system 4320 using the user-profile information, the timing parameter being indicative of an estimated time (e.g., the average time) it takes the customer to exit the store based on the transaction type, e.g., staffed checkout, self-checkout, SNG, and/or transaction location. The timing parameter(s) may be store-specific and/or POS register-specific. In some implementations, the process for determining the timing parameter and determining ads may take a fraction of a second, but in other implementations may take longer. Once the transaction has completed, a timestamp may be associated with the end of the transaction. In the example shown in FIG. 43, based on the example store configuration shown, it is determined that it takes approximately 32 seconds for the customer to approach the advertisement (ad) display system or device 4310 (“ad display 4310”). As the customer nears the ad display 4310, the personalized ad(s) determined by timing and advertisement determination system 4320 are rendered on the screen(s) of the ad display 4310 at a time based on the determined timing parameter, which in this case indicates that it takes the customer on average 32 seconds to approach the ad display 4310 after the transaction event end time. The timing parameter may be adjusted to display the ad(s) earlier or later based on customers' range of view of the ad display 4310 depending on the store configuration. The timing parameter may be updated for the customer based on an exit time as may be determined upon the customer exiting the store, e.g., by way of an exit audit timestamp during a receipt check at the exit or based on a CV/RFID check process at the exit as discussed herein. Additionally, the personalized ad content may be displayed for a preset period of time or may end based on a receipt check at the exit or based on a CV/RFID check process at the exit. For example, the ad may be displayed for a predetermined or variable amount of time after a receipt check or CV RFID check has completed.

In some examples, the ad display 4310 in the retail facility may be fixed in location and may be located proximate to an exit of the store and be configured to display digital advertising content. For example, in some implementations, the fixed digital display device may be integrated on an exit truss structure located proximate to the exit, such as exit truss device 2500, which may include CV/RFID scanning technologies capabilities as discussed herein. The fixed digital display device may include one or multiple display screens and is configured to display advertising on one or more of the one or multiple display screens.

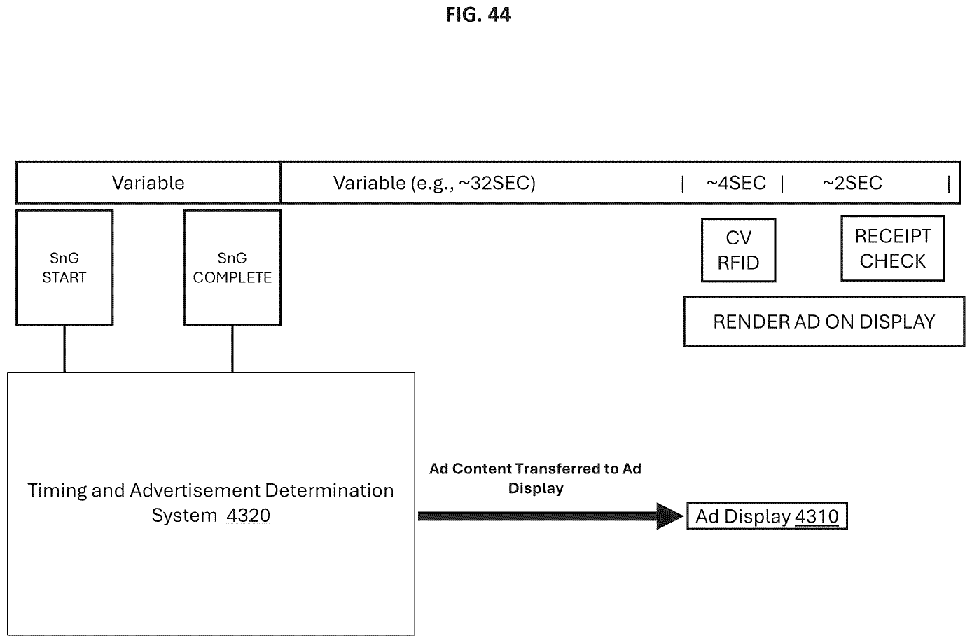

FIG. 44 illustrates aspects of a store environment and process flow for determining and displaying personalized ads to a customer or user initiating a mobile self-checkout transaction, also referred to as a scan and go SNG transaction, and thereafter exiting the store. Here, the process and process flow is similar to the POS transaction scenario shown in FIG. 43, but the timing parameter may be different as the SNG transaction event can take place at other locations within the store besides the staffed registers and the self-checkout registers. In an example, for a SNG transaction the timing parameter may be determined based on information about the user's location within the store, such as from the user's device in coordination with the SNG transaction (e.g., location data from GPS, beacon technology, etc.), and based on calculated or pre-defined travel times to the exit.

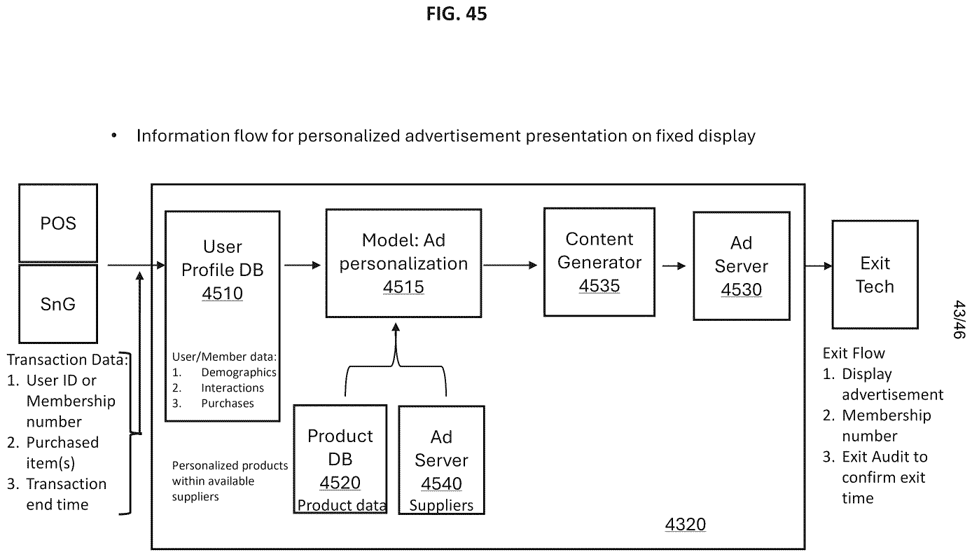

FIG. 45 illustrates an example flow of information between various systems for personalized advertisement presentation. In an implementation, a retail store environment or retail facility may include one or more staffed transaction registers at which users may purchase items and/or conduct other transactions with the help of a staff associate of the retail store. Additionally or alternatively, the retail facility may include one or more self-checkout transaction registers at which users may purchase items and/or conduct other transactions without requiring the help of a staff associate of the retail store. Collectively, the staffed registers and self-checkout registers are referred to as POS in FIG. 45. The staffed and self-checkout registers are communicably coupled with timing and advertisement determination system 4320 via a network link. Alternatively or additionally, the retail facility may also be configured to implement mobile self-checkout/scan and go (SNG) transactions, such as transactions wherein a user scans a product and completes a purchase transaction of the product using an application on a mobile device (e.g., smartphone or other user device, which may be similar in many respects to user device 116) configured to connect with the store transaction network. Relevant transaction information from such SNG transactions may also be provided to timing and advertisement determination system 4320 via a network link, such as network 112 or 4112.

In examples, timing and advertisement determination system 4320 determines advertising content for display on ad display 4310, or other display system within the store or outside of the store. Timing and advertisement determination system 4320 includes a processing resource, e.g., one or more processors, and one or more memories storing instructions to control operation of the various processors to implement various processes and/or models as described herein. It should be understood that timing and advertisement determination system 4320 may include one or more separate computer systems each implementing various processes or functions or it may include a single computer system implementing the various functions or processes. It should be understood that the terms “process”, “function”, “model” and “module” may be used interchangeably herein when discussing components and abilities of timing and advertisement determination system 4320.

As shown in FIG. 45, timing and advertisement determination system 4320 may include one or more database systems (DBs) such as user profile DB 4510 and product DB 4520 and may include processing components to implement various processes and functions or models to process data provided by or retrieved from the various DBs as well as data provided by or received from POS and/or SNG terminals or devices (e.g., transaction data such as user ID or membership number of the user, list of purchased items, transaction end time, etc.) to implement the ad presentation methods described herein. Timing and advertisement determination system 4320 is also communicably coupled with an exit tech system which includes one or more digital display devices, e.g., ad display 4310, on which to display the personalized advertising content.

For example, in some implementations, timing and advertisement determination system 4320 implements a timing prediction function or process and an advertising content determination function or process to determine advertising content to be presented at the exit tech systems and a time at which to present the advertising content based on information provided by and/or retrieved from user profile DB 4510, a product DB 4520, and an ad server 4540. The product DB 4520 may store information relevant to various products and/or advertisers. For example, stored product information may include one or more of a name, a price, a product category, a brand, a description, ratings information, or review information as well as information relevant to advertisements and advertisement campaigns of various advertisers. Any process or function may be embodied as a separate functional module running as code on the one or more processors associated with timing and advertisement determination system 4320.

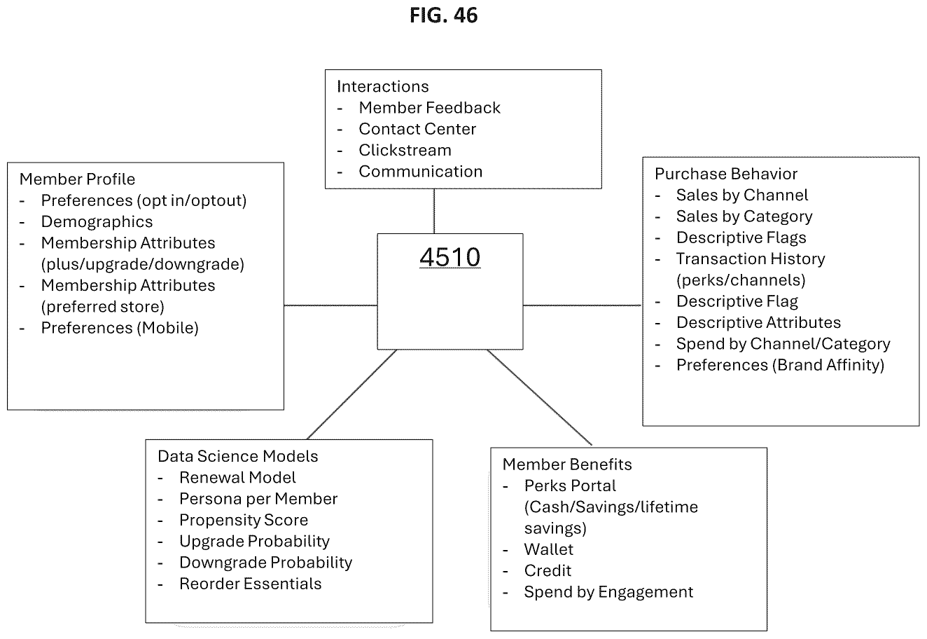

FIG. 46 illustrates an example of a user profile DB 4510. User profile DB 4510 may include a single database or multiple databases storing various types of information. The types of information may vary. Each type of information may be stored in a separate logical or physical database or some or all types may be stored in the same physical or logical database. In example implementations, the types of information may be characterized in five different categories as follows:
(1) User/Member Profile information: Includes demographic information, personally identifiable information (e.g., as provided by the user), user preferences regarding email and SMS sign-ups, membership attributes, etc.
(2) Interaction information: Includes interactions a user has had with the retailer, including clickstream on a website and applications, feedback, customer service contact, and in-store communications, etc.
(3) Purchase Behavior information: Includes products purchased, spend by channel and by category, brand affinities, and flags to denote descriptive attributes, etc.
(4) User/Member Benefits information: Includes usage of the membership perks such as loyalty reward programs, usage of related services such as travel/pharmacy/installations/café, and credit card and payment information, etc.
(5) Data Science/Inferential Model Data: Includes data models generated about the member, including user renewal probability scores, user upgrade or downgrade probability scores, user-product propensity scores, user persona categorization, etc.

It should be understood that users may be members of a store or chain of stores or members of an award's program associated with a store or chain of stores, and as such may have provided user profile information as part of a process to acquire membership or sign up for the awards program. These customers may have a unique member number or user ID assigned to their account as part of the membership. In some cases, the customers may be regular customers of a retail store without membership services or an award's program, or the user may have opted not to acquire membership or sign up for awards, and user profile information for the user may be acquired over time based on credit card usage, online purchases, etc. The user ID is used to track and store in the user profile DB user profile information associated with the user that is acquired upon membership sign up or renewal, award's program signup or renewal, or over time based on various channels, such as in-store purchases or transactions, online purchases and/or viewing activity, credit card usage, etc.

Returning to FIGS. 43-45, as an example of data flow, in an initial step, transaction event associated with a user is detected. The transaction event may be a POS transaction event at one of a staffed checkout event at a staffed register or a user self-checkout event at a self-checkout register (as depicted in FIG. 43), or may be a user mobile self-checkout/scan and go event (as depicted in FIG. 44) at a mobile device of the user within the retail facility. The transaction event generates transaction data associated with the event. For example, the transaction data will typically include a user identifier associated with the user and a transaction end time and product information. The transaction event may include a purchase transaction, a return transaction, an exchange transaction or other interaction where a user identifier is used. The transaction data may include a list of purchased items. The transaction data may include or be associated with an e-receipt. The transaction data is sent to or retrieved by timing and advertisement determination system 4320.

A timing parameter indicative of an estimated time for the user to approach the fixed digital display device, e.g., ad display 4310, after the transaction event is determined by timing and advertisement determination system 4320 based on the transaction data associated with the transaction event and user profile information of the user stored in the User Profile DB 4510. For example, in some examples, a timing parameter representing an average time to exit is stored in the user profile database for the user in relation to the store in which the transaction occurs and/or the type of transaction that has occurred (e.g., staffed checkout, self-checkout, scan and go checkout). Initially the timing parameter may be a preset time based on the physical store configuration and the location of the POS register at which the transaction occurred, e.g., the timing parameter may be a function of a distance or route distance between the specific register at which the transaction occurred and the fixed display device, e.g., ad display 4310, and an average walking speed of a user. For example, the timing parameter may be based on the average walking speed multiplied by the distance. Different physical stores may have different configurations and the initial timing parameters for different stores or different register locations relative to display screens may be different for the user.

The timing parameter may also be updated in some examples. Updating may be based on a timestamp indicating that the user has exited the store or passed by a specific feature in the store, such as an arch truss device 2500 associated with ad display 4310. For example, after the user passes the exit arch truss, the user may be greeted by a store representative and an exit audit (e.g., as identified as Receipt Check in FIGS. 43 and 44) may be completed using a network connected device (which may be part of the exit tech systems) that scans merchandise and/or a transaction receipt associated with the user ID and, whereupon the exit audit has a timestamp associated therewith that is provided to the timing and advertisement determination system 4320 and/or the user profile DB 4510. The average exit time for that user for that store for that type of transaction (e.g., staffed register checkout or self-checkout or scan and go checkout) may be updated based on the exit audit timestamp, e.g., a function of the time at exit on the timestamp minus the transaction end time may be used to update the stored timing parameter, or may be added to information in the user profile database from which the timing parameter is derived or calculated.

The timing and advertisement determination system 4320 may determine personalized advertising content for the user based on the user profile information of the user stored in the user profile DB 4510. The personalized advertising content may also be determined based on advertising content information stored in the product DB 4520 and/or ad server 4540, which may store supplier information such as information provided by product suppliers and advertisers. Such information may include premade advertisements and/or images, videos or other content associated with products which may be usable to produce advertising content.

The timing and advertisement determination system 4320 may cause display of the determined advertising content on the ad display 4310 via ad server 4530. For example, the timing and advertisement determination system 4320 may send or transmit information of the determined advertising content to the ad display 4310 over a communication link from ad server 4530. The information of the determined advertising content may include the actual advertising content for display (e.g., image(s), video(s), QR code(s), etc.) or it may include an identifier or other information from which ad display 4310 can retrieve stored advertising content. The information provided to the ad display 4310 may also include the timing parameter.

The personalized advertising content for the user is displayed on the digital display within the store at a time based on the timing parameter. For example, the personalized advertising content is rendered on the ad display 4310. For example, the timing and advertisement determination system 4320 may provide the advertising content to ad display 4310 with an instruction to display the received content at a certain time, or it may provide an ID to the ad display 4310 to retrieve the stored content based on one or more ad ID(s).

To determine personalized ads to be made available on the ad display 4310, timing and advertisement determination system 4320, in an implementation, determines the most relevant product(s) to be displayed to the user at the moment in time the user approaches the ad display 4310. The ad server may store information relating to advertising campaigns currently running for advertisers at the retail store and may be accessed to optimize results for advertisers.

For example, in some implementations, to determine personalized ads to be made available on the ad display 4310, timing and advertisement determination system 4320 implements or includes an ad personalization model 4515 that includes a propensity model, and in some implementations a real-time ranker, layered on an ad server to determine and display the most relevant product(s) to the user at the moment in time the user approaches or is expected to approach the ad display 4310. The ad personalization model uses data from the user profile DB 4510 and the product DB 4520 and/or ad server 4540.

In some implementations, three models may be utilized to determine advertising content:
(1) A propensity model—a machine learning model trained to determine the personalized product(s) to be showcased to the member.
   a. The propensity model interfaces with the user profile DB to access user profile information such as member demographics, interaction patterns, and purchase history in order to ingest, for example:
      i. user-level features (e.g., demographics, recency of last transaction, frequency of transactions, and spend amounts);
      ii. product-level features (e.g., product category, brand, price, etc.); and
      iii. interaction-level features (e.g., clickstream data, purchase data, etc.).
   b. The propensity model generates a user-product propensity score to represent the likelihood of engagement between the customer and a product or category of products.
   c. The score represents a user-product pair, to drive customer conversion, i.e., purchase of the product by the customer.
(2) Real-time ranker—a machine learning model that optimizes response times from the propensity model to rank the product recommendations, e.g., enabling selection of a highest-ranking user-product score by ad personalization model 4515 for advertisement determination.
   a. The propensity model may generate scores at a set frequency (e.g., daily or weekly). The real-time ranker is applied on top of the propensity model to optimize for the results' response time.
   b. Real-time ranker model integrates one or more of multi-objective optimization, session-level signals, and contextual relevance:
      i. Multi-objective optimization: optimize for multiple objectives (e.g., business goals) simultaneously, for example—discovery, engagement, and conversion.
      ii. Session-level signals: include real-time user behavior, for example—the current items the user purchased, items browsed via scan-and-go, and items with a high propensity but that were out of stock in the store.
      iii. Contextual signals—understand external signals based on channel of advertisement rendering, for example—geographic location (of store), time of day, seasonality (e.g., spring, summer, fall, winter, holidays, etc.).
(3) Ad server—Advertisement management system that optimizes supplier advertisement spend and/or advertiser budget across the retail platform by measuring reach (e.g., views, impressions, and clicks) and developing corresponding campaigns. The ad server system tracks an advertiser's on-going campaigns across various channels and uses reporting to determine ad spend and ROAS (return on ad spend).

In some examples, timing and advertisement determination system 4320 implements or includes a content generator 4535 used to generate the advertising content to be displayed. For example, the content generator 4535 may automatically generate highly personalized creative content in real-time, automatically, i.e., without manual inputs. Traditionally, creative assets on a website are created by a human designer, designing a template for e.g., an ad banner on the homepage of a retail website. For example, the human designer may be instructed with the brand and product to be advertised, the various placements of the ad (e.g., multiple versions of the ad e.g., for desktop website, for a mobile screen, for a horizontal layout, etc.), and other information, and then the designer may determine layouts, background colors, whether to show lifestyle imagery or product images, what text to include, formatting and more.

The content generator 4535 automates the generation of ad content. The content generator 4535 in certain aspects, is provided with a set of pre-defined (pre-stored) templates, input variables, and desired output formats, such as:
(1) Input variables—include user/member information (demographics, interactions, affinities, transactions), product information (name, price, category, brand, description, ratings, reviews), and contextual information (location, seasonality).
(2) Output format—what is expected to be produced; e.g., an advertisement for specific dimensions of an archway truss, emails or social media posts, or banners on a website, etc.
(3) There may be one or more pre-defined templates for each output format.

The content generator 4535 may include model(s) that specialize in natural language generation (NLG) and/or utilizes AI large language models (LLMs), and is trained on existing advertising content including product descriptions, user-generated content, and brand/marketing material for the model to learn brand context, voice, and tone.

The content generator 4535 starts by selecting a template. The content generator 4535 then populates the template with the personalized product recommendations for the ad (e.g., based on output of the propensity model, real-time ranker, and ad server as described herein). Content generator 4535 uses the input variables to generate copy (i.e., text) using its model(s) (e.g. NLG and/or LLM). The output can be rendered on the ad display as-is (when done in real-time) or may be run through manual quality control (e.g., when done for planned campaigns in advance).

For example, in some implementations, generating digital advertisement content based on the product information may include automatically selecting a display template from a set of one or more predefined display templates, each having a different output display format, populating the selected display template with information about the product based on one or more input variables to produce an advertisement in an output display format capable of being displayed on the fixed digital display device, e.g., ad display 4310, wherein the one or more input variables includes the product information, user information and contextual information.

Two non-limiting examples are provided below to show how the content generator 4535 may show the same product on the same channel in different ways based on differing input variables:
In a first example, a user is approaching the exit archway truss and has just bought a pair of running shoes in the store. The store might be running an ad campaign with sporting goods brand “G” for their running watch. The timing and advertisement determination system 4320 and/or content generator 4535 uses the user's propensity score and real-time ranking to determine that brand “G”'s running watch is the next best product to show the member (e.g., based on input variable: member demographics and transaction history). For example, the content generator 4535 may take the user's information and the brand “G”'s watch specifications, to generate an ad for the member that focuses on aspects such as the reliability of the tracking metrics and long-battery life, since the use-case of running has been established.

In a second example, the user just purchased their groceries in the month of June and in the past, has bought items from a Father's Day category page, but has not made any qualifying big purchase in the current year. The propensity model might determine showing this member a brand “G” watch could serve their Father's Day gift needs this year (input variable: seasonality). In this case, the content generator 4535 generates an ad for the member that focuses on member reviews indicating how dads have loved the brand “G” watch as their present and may even include a social media post about it on the screen.

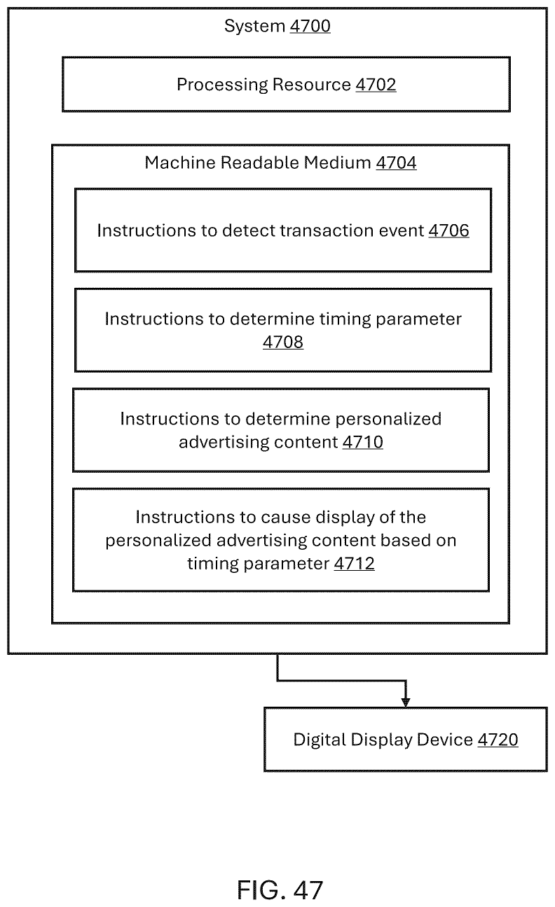

FIG. 47 is an example block diagram illustrating a system 4700 for providing advertising content. In some implementations, the system 4700 may serve as or be included in an implementation of the timing and advertisement determination system 4320. The system 4700 includes a non-transitory machine readable medium 4704 encoded with instructions executable by a processing resource 4702. The processing resource 4702 may include a microcontroller, a microprocessor, central processing unit core(s), an application-specific integrated circuit (ASIC), a field programmable gate array (FPGA), and/or other hardware device suitable for retrieval and/or execution of instructions from the machine readable medium 4704 to perform functions described herein. Additionally or alternatively, the processing resource 4702 may include or be coupled to electronic circuitry or dedicated logic for performing some or all of the functionality of the instructions described herein. The machine readable medium 4704 may be any medium suitable for storing executable instructions, such as RAM, ROM, EEPROM, flash memory, a hard disk drive, an optical disc, or the like. In some example implementations, the machine readable medium 4704 may be a tangible, non-transitory medium.

As described further herein below, the machine readable medium 4704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 47.

With reference to FIG. 47, the machine readable medium 4704 includes instructions 4706, 4708, 4710, 4712. Instructions 4706, when executed, cause the processing resource 4702 detect a transaction event associated with a user. For example, the transaction event may be a staffed checkout event, a user self-checkout event, or a user mobile self-checkout (i.e. scan and go) event.

Instructions 4708, when executed, cause the processing resource 4702 to determine a timing parameter based on transaction data associated with the transaction event and user profile information of the user. The timing parameter may be indicative of an estimated time for the user to reach or approach a digital display device 4720 after the transaction event. In some implementations, the digital display device 4720 may be similar in many respects to ad display 4310 or digital display device 4120. In some implementations, the transaction data may include a user identifier associated with the user and a transaction end time. The user identifier may be useful for looking up user profile information stored in a user profile database, such as the user profile database 4510 described with reference to FIG. 46.

Instructions 4710, when executed, cause the processing resource 4702 to determine personalized advertising content for the user for display on the fixed digital display device based on the user profile information of the user. In example implementations, the instructions 4710 may include instructions to determine a user-product propensity score, to determine a cohort-product score, to generate digital advertisement content (e.g., as described above with respect to content generator 4535 or other instructions encoding functionality of the timing and advertisement determination system 4320 described above.

Instructions 4712, when executed, cause the processing resource 4702 to cause display of the personalized advertising content for the user on the digital display device 4720 at a time based on the timing parameter.

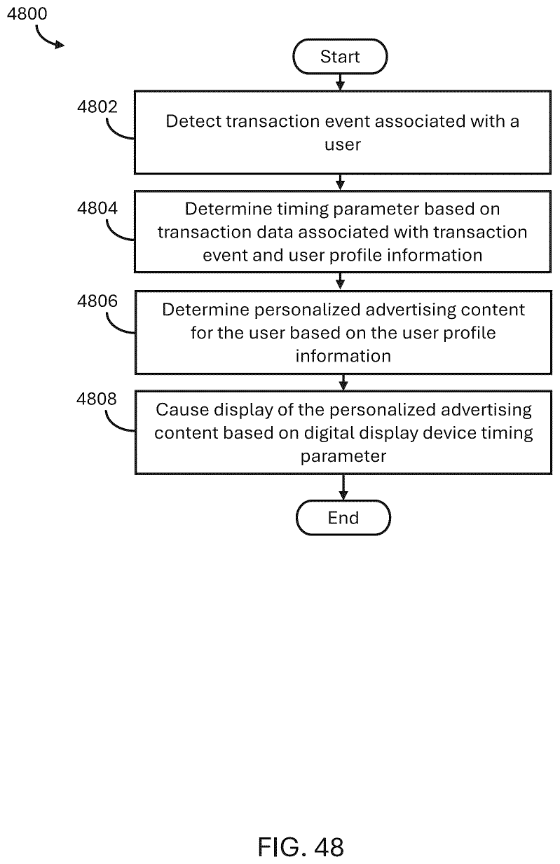

FIG. 48 is a flow diagram depicting an example method for providing advertising content. In some implementations, one or more blocks of the methods may be executed substantially concurrently or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIG. 48 may be implemented in the form of executable instructions stored on a machine readable medium and executed by a processing resource and/or in the form of electronic circuitry. For example, the methods described may be performed by the system 4700 or the timing and advertisement determination system 4320.

FIG. 48 depicts an example method 4800. Method 4800 starts and continues to block 4802, where a transaction event associated with a user is detected. At block 4804, a timing parameter based on transaction data associated with the transaction event and user profile information of the user is determined. The timing parameter is indicative of an estimated time for the user to reach or approach a digital display device after the transaction event.

At block 4806, personalized advertising content is determined for the user for display on the digital display device based on the user profile information of the user. In some implementations, the personalized advertising content is based on a user-product propensity score (e.g., a highest-ranking user-product propensity score), which may be derived as discussed above. In some implementations, block 4806 may include generating digital advertisement content, which may include selecting a display template and populating the selected display template with information about the product to be advertised based at least on input variables (e.g., using an LLM to automatically generate copy text), in a manner similar to that described above with respect to the content generator 4535.

At block 4808, the personalized advertising content for the user is caused to be displayed on the digital display device (e.g., 4120, 4310, or 4720) at a time based on the timing parameter. The digital display device may be fixed on an exit archway truss proximate to the exit of a retail facility.

In some examples, display of advertising on ad display (e.g., 4120, 4310, or 4720) may be delayed and/or extended, e.g., due to a customer congestion event detected proximate to the ad display. Delaying displaying the personalized advertising content for the user may be based on a second transaction event detected (e.g., customer stops for a drink at an in-store food court on way out), or a number of other users may be ahead of user at the exit (congestion/slow exit/bottleneck at store exit). Based on a delay being detected, display timing of personalized advertising content may be adjusted, e.g., based on user profile information of a group of congregating users, including the user, expected to exit together. Time-to-exit may not be static and constant across in-store visits, e.g., even for the same member in the same group of stores. In this case, a predictive model may be used to determine time-to-exit based on the store layout or configuration and number and type of events possible between the end of transaction and the approach to the exit. Similarly, depending on the contextual cues (seasonality, day of week, time of day), traffic density may be estimated at each retail store to predict congestion possibilities between the point of sale and the exit.

To determine the “group of users”, a cohort of customers may be identified, and commonalities between users may be found based on derivative information. This enables developing a propensity score for a cohort-product pair, enabling personalized recommendations that optimize for the cohorts needs holistically. By doing this, a “personalized ad” relevant to the group of customers approaching the exit together may be rendered.

For example, user profile information, interaction data, and purchase history data may be used to derive a membership renewal score for each customer or member. In an example, a group of customers exiting together may have 80% of the customers with a renewal score indicative of a low likelihood of renewal. In this case, this may be identified to be an “at-risk” audience. Thus, the model may optimize for categories of products that have high correlation with renewal rates (e.g., consumables category, i.e., users who rely on the retail store for everyday items like toilet paper are more likely to renew their membership than users who shop less frequently for one-off purchases only).

In some implementations, determining personalized advertising content may include determining, for the user and for one or more other users for which a transaction event was detected within a threshold timeframe of the transaction event associated with the user, cohort-product scores for each of the multiple products in the product database based on commonalities in information associated with the user and the one or more other users, wherein the commonalities in information include commonalities in demographics information, transaction information, interaction information and purchase behavior information of the user and the one or more other users (e.g., as determined from the User Profile DB), and determining advertising content based on a product associated with a highest-ranking cohort-product propensity score for the user and the one or more other users.

After block 4808, the method 4800 ends.

### Example Customer (Member) Experience and Information Flow

### Step 1

A user uses their membership card to begin checkout, which could be at POS (with associate or self-checkout) or on Scan and Go.

The following data is captured:

Membership number to connect with member data (user profile information).

Member demographics, behavioral, and purchase data: allows to personalize the ad based on intent and actual purchase.

Average time it takes member to exit: allows to determine when to show the ad.

### Step 2

Member completes checkout and begins to exit.

On the back-end, ad personalization model has created a personalized ad for the member using their member data.

This will be the most relevant advertisement to display for the shopper/member.

### Step 3

Member is approaching exit archways, and their average checkout time is triggered in the system.

A personalized ad is showcased for the member on the display(s) of the exit archways.

Steps repeat, to showcase different personalized ads for each member that may be passing through the exit archways.

### Step 4

An exit greeter after the arch audits the transaction providing confirmation of when the member left the club, e.g., an exit timestamp which may be used to update the timing parameter information for the member.

### Additional Examples

In some examples, the frontend CV pipeline includes five computer vision models, including a cart detection model, item detection model, two item recognition model, and/or a depth detection model. The cart detection model uses 5-20 images captured by the camera at the staffed checkout lane. A cart detection algorithm is employed to isolate and extract the cart and belt area within the staffed checkout zone. Additionally, a depth model estimates the depth value of each cart in the view, enabling the system to accurately identify the cart corresponding to the ongoing transaction. An item detection model crops images of items present in the cart or on the belt. This process enables precise localization of items within the captured images. Two item recognition algorithms are utilized to infer the UPC from the cropped item images. These algorithms facilitate accurate identification and recognition of items in the transaction. By leveraging the aforementioned computer vision models, the frontend CV system generates an item list by inferring from the 5-20 transaction images. This item list is then compared with the e-receipt item list, resulting in the prediction of two lists: the paid item list (checked items that have been paid for) and the unpaid item list (potential shrinkage items). In the event that the frontend CV system detects unpaid items during a transaction, upon receiving the ‘ready to pay’ signal, it sends notifications to the tablet mounted next to the checkout monitor. These notifications display red bounding boxes, one at a time, on the checkout image, effectively highlighting the unpaid items for further attention and resolution.

In some examples, the frontend CV system effectively verifies the presence of unpaid items during an ongoing transaction, eliminating the need for an additional random check by the exit greeter at the exit door. This streamlined process significantly reduces friction for members, ensuring a seamless and frictionless exit experience, especially for ‘green to go’ transactions. Paying for unpaid items upstream at the POS is considerably more convenient than doing so at the exit door. With the frontend CV system, any unpaid item can be easily repaid at the POS, whereas attempting to make repayment at the exit door poses challenges and potential embarrassment to the members.

Other examples provide a system to recognize and identify items that are likely to have been missed during a checkout process at a POS. The system includes multiple computer vision image capture models for identifying the cart associated with the current transaction. The system identifies items in the cart and on the conveyor belt or other region associated with the current transaction by applying an item detection algorithm to crop images of items. The system recognizes the identified items and infers item codes (UPCs). The system compares the identified items with a receipt of the transaction. The system sends notifications to the POS/cashier including information about possible missed items right before the transaction is completed. The system completes payment or repayment of the identified missed items before the transaction is completed. The system reduces the occurrence of item shrink and the need for manual receipt checking at the exit of the store.

In other examples, the system performs item scan verification based on the information of the images and item scan information. The system verifies the items that have already been scanned via item recognition and verification. At the end, when the user clicks the finish (ready to pay) button, the system provides a recommendation for unpaid/unscanned items which are recognized in the image data but not identified in the scan data and/or on the receipt. The system gives the customer an opportunity to scan the missed items before completing the transaction and/or leaving the checkout lane.

In some examples, two cameras are installed at two different locations, such as at the ceiling and at the bottom of the counter near expected cart locations. The cameras capture different angles of transaction cart and conveyor at transaction time used to correlate transaction scanned items with recognized items in cart and/or on the conveyor.

In other examples, the items are scanned and mapping recognized items to the scanned items occurs in parallel for reduced latency and improved processing efficiency. This further enables faster result generation with reduced error rate as scanned items are verified against image data object detection results. In this manner, the system provides zero-friction exit experience for staffed lane members via frontend computer vision.

The system applies grouping logic in some examples in which an item fails to be accurately identified by the item recognition algorithm. In such cases, if an exact match for an item is not found, the system may infer a group of item IDs for similar items. For example, grouping logic can be applied to map an item identified as a twenty-four pack soft drink of brand A to a scanned item for a thirty-six pack soft drink of the same brand A. In this case, although the system failed to exactly identify the item, the system is able to map the identified item to any item in a group of items having the same brand and/or category of items.

Alternatively, or in addition to the other examples described herein, examples include any combination of the following:
isolate the selected cart and a conveyor belt in an image;
extract a cropped image of the selected cart and the conveyor belt area within a staffed checkout area;
obtain a plurality of images comprising a plurality of carts; track the selected cart through the plurality of images; and place a bounding box around the selected cart in each image in the plurality of images;
estimates a depth value of each cart in a plurality of carts within the image; and identify the cart selected corresponding to the current transaction;
add a set of indicators to the set of unscanned item images, wherein the set of indicators comprises a bounding box associated with each unscanned item in at least one image;
display an image of each unscanned item in the set of unscanned items on the UI device one at a time, wherein the user is instructed to scan each item as it is displayed on the UI, wherein an image of a first unscanned item is displayed with a first instruction to scan the first unscanned item;
upon receiving scan data for a first unscanned item, display an image of a second unscanned item with a second instruction to scan the second unscanned item;
a set of cameras, the set of cameras comprising a ceiling mounted camera capturing a set of images associated with a top view of the selected cart and a camera mounted to a portion of the POS device capturing a set of images associated with a side view of the selected cart, wherein the set of cameras transmits a plurality of images of the selected cart to a computing device via a network;
obtaining an image of a selected cart and a plurality of items associated with the selected cart;
identifying the plurality of items associated with the selected cart;
predicting an item identifier (ID) associated with each item in the plurality of items, wherein a set of identified items comprising a plurality of item IDs associated with the plurality of items is generated;
obtaining item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device;
mapping each scanned item ID to an identified item ID in the set of identified items;
upon receiving a scan complete signal from the POS device indicating a user is ready to pay for the set of scanned items, identifying a set of unscanned item based on mapping of the set of identified items to the set of scanned items, wherein an unscanned item is an item having an item ID in the set of identified items that fails to map to a corresponding item ID in the set of scanned items;
sending a notification to a user interface device associated with the POS device prior to completion of the current transaction, the notification comprising the set of unscanned items and a set of unscanned item images, wherein a user is instructed to scan each item in the set of unscanned items;
receiving first scan data associated with a first scanned item from the POS device, the first scan data comprising a first scanned item ID;
adding the first scanned item ID to the set of scanned items;
receiving second scan data associated with a second scanned item from the POS device, the second scan data comprising a second scanned item ID;
adding the second scanned item ID to the set of scanned items in real-time prior to receiving a payment associated with completion of the current transaction;
obtaining a plurality of images comprising a plurality of carts;
tracking the selected cart through the plurality of images;
placing a bounding box around the selected cart in each image in the plurality of images;
cropping each image to isolate the selected cart from other objects based on the bounding box around the selected cart in each image;
estimating, by a depth model, a depth value of each cart in a plurality of carts within the image; and identifying the cart selected corresponding to the current transaction based on the depth value, wherein the depth value indicates a proximity of the selected cart to the POS device;
displaying an image of each unscanned item in the set of unscanned items on the UI device one at a time, wherein the user is instructed to scan each item as it is displayed on the UI, wherein an image of a first unscanned item is displayed with a first instruction to scan the first unscanned item,
upon receiving scan data for a first unscanned item, displaying an image of a second unscanned item with a second instruction to scan the second unscanned item;
identifying each item on a conveyor belt associated with the POS device based on a top view image of the conveyor belt;
predicting an item ID associated with each item on the conveyor belt;
adding the item ID associated with each item on the conveyor belt to the set of identified items;
generating a plurality of images of the selected cart by a set of cameras, the set of cameras comprising a ceiling mounted camera capturing a set of images associated with a top view of the selected cart, the set of cameras further comprising a camera mounted to a portion of the POS device capturing a set of images associated with a side view of the selected cart, wherein the set of cameras transmits a plurality of images of the selected cart to a computing device via a network;
obtain an image of a selected cart and a conveyor belt associated with a POS device, the image comprising a plurality of items associated with the selected cart and the conveyor belt;
identify the plurality of items associated with the selected cart and the conveyor belt;
predict an item identifier (ID) associated with each item in the plurality of items, wherein a set of identified items comprising a plurality of item IDs associated with the plurality of items is generated;
obtain item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device;
map each scanned item ID to an identified item ID in the set of identified items;
upon receiving a scan complete signal from the POS device indicating a user is ready to pay for the set of scanned items, identify a set of unscanned item based on mapping of the set of identified items to the set of scanned items, wherein an unscanned item is an item having an item ID in the set of identified items that fails to map to a corresponding item ID in the set of scanned items;
send a notification to a user interface device associated with the POS device prior to completion of the current transaction, the notification comprising the set of unscanned items and a set of unscanned item images, wherein a user is instructed to scan each item in the set of unscanned items;
display an image of the selected cart including a set of indicators associated with the set of unscanned items;
display an image of each unscanned item in the set of unscanned items on the UI device one at a time, wherein the user is instructed to scan each item as it is displayed on the UI, wherein an image of a first unscanned item is displayed with a first instruction to scan the first unscanned item;
estimate, by a depth model, a plurality of depth values associated with a plurality of carts within an image;
select a cart closest to the POS device based on the plurality of depth values, wherein the depth value indicates a proximity of the selected cart to the POS device;
wherein the item ID is a universal product code (UPC);
wherein the POS device is associated with a staffed checkout lane; and
wherein the POS device is associated with an unstaffed self-checkout (SCO) lane.

In other examples, a computer readable medium having instructions recorded thereon which when executed by a computer device cause the computer device to cooperate in performing a method of frontend unscanned item identification, the method comprising obtaining an image of a selected cart and a plurality of items associated with the selected cart; identifying the plurality of items associated with the selected cart; predicting an item identifier (ID) associated with each item in the plurality of items, wherein a set of identified items comprising a plurality of item IDs associated with the plurality of items is generated; obtaining item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device; mapping each scanned item ID to an identified item ID in the set of identified items; upon receiving a scan complete signal from the POS device indicating a user is ready to pay for the set of scanned items, identifying a set of unscanned item based on mapping of the set of identified items to the set of scanned items, wherein an unscanned item is an item having an item ID in the set of identified items that fails to map to a corresponding item ID in the set of scanned items; and sending a notification to a user interface device associated with the POS device prior to completion of the current transaction, the notification comprising the set of unscanned items and a set of unscanned item images, wherein a user is instructed to scan each item in the set of unscanned items.

In some examples, the system provides an innovative exit computer vision (CV) solution designed to address the challenges faced by self-checkout (SCO) customers during the checkout process. To streamline and enhance the exit experience, the system includes an archway between the checkout terminal and the exit door of the store. The archway is a structure including one or more cameras for capturing images of the cart from multiple different angles as the cart passes through the archway. In some examples, the archway includes a top camera which captured a bird's eye view (top view) of the cart, as well as a camera on the right side of the arch and a camera on the left side of the arch to capture images of both sides of the cart.

The system includes a valid cart verification in which a customer walks their cart towards the exit and the system performs a quick check to ensure that it falls within the SCO camera view. The SCO may also be referred to as a scan and go (SNG). The system determines if the cart is a valid cart eligible for the exit CV process. Item recognition with CV algorithms is employed, including advanced CV algorithms, to recognize and generate a comprehensive list of items present in the cart. Fuzzy matching is used with active SCO e-receipts and the CV generated list of items. The fuzzy matching links the cart images to the corresponding SCO e-receipts ensuring accurate verification. The system then compares the results and conveniently displays a list of paid items associated with a selected e-receipt and a list of unpaid items from the CV generated list of items which fail to match to an item on the selected receipt on a gallery page. Simultaneously, this information is transmitted to the receipt check team for further verification. When the exit greeter scans the receipt barcode provided by the customer exiting the store, the receipt check system fetches and presents the results, including the list of paid and the list of unpaid items. The results are displayed to the exit greeter via a user interface associated with a user device. If all the items in the CV generated list of items have been paid for, there is no need for random scanning of one or more items in the customer's cart. If any items are included in the list of unpaid items, the exit greeter scans those identified items to verify whether those items were paid for or not rather than scanning random items. This focused approach is more accurate and time-efficient for both the associates and the customers. Moreover, this significantly reduces friction for customers and streamlines the exit process of customers for a more customer-friendly experience.

In other examples, the system provides an exit CV solution that streamlines the cart verification process as customers approach an exit door in a retail facility, such as a brick-and-mortar retail store. The system employs a cart detection model and object tracking algorithm to analyze images generated by one or more exit cameras to determine if a customer cart is passing through an exit camera view. It verifies the cart's trajectory (direction of travel) using a series of images of the cart in sequence, ensuring it enters from the left side of the view and exits on the right side. Representative cart image selection uses a similarity measure between the bounding box and three anchor points. The system selects representative cart images along the cart trajectory. The chosen bounding box is fully visible in the image. The computer vision item list generation leverages computer vision models, such as cart detection, item detection, depth model, classification models and verification models. The system processes the selected cart images to generate a comprehensive computer vision item list. Basket fuzzy matching utilizes the CV generated item list and precisely associates the cart image with the corresponding SCO receipt from the active SCO receipt list. Finally, the system compares the detected items, displaying a comprehensive list of paid items and unpaid items. The results are forwarded to the receipt check team for verification.

In other examples, the system provides an efficient exit experience for customers and store associates as well. Upon scanning the receipt barcode, the exit greeter receives the system's results. If the cart is determined to be “green to go,” this indicates all items have been paid for and there is no need for random scanning of three items in the cart, significantly reducing friction for customers. Through this optimized exit CV process, a seamless and hassle-free exit experience is provided for customers, enhancing customer satisfaction, and increasing loyalty to the retail store.

Still other examples provide a system to recognize and identify items that are likely to have been missed during a checkout process at an exit of a store. The system includes multiple computer vision image capture models for identifying and/or validating the cart contents with a receipt. The system validates carts to ensure they fall within the field of view of one or more cameras. The system identifies items in the cart and performs fuzzy matching between the identified items and a set of possible electronic receipts (e-receipts) associated with recent transactions. The system presents information associated with paid items and possible unpaid items in the cart based on the comparison. The system sends notifications to an exit greeter to confirm the accuracy of thee-receipt more efficiently with respect to items in the cart. The notification to the exit greeter is sent with visual cues (indicators) by outlining the potentially unpaid items with bounding boxes. The system reduces the occurrence of shrink associated with the unpaid items and improves the efficiency of the exit greeters that validate the contents of a cart as it exits the store where the exit greeters need not randomly scan items in the cart or take other such steps to prevent or control potential shrink.

In some examples, the exit CV system enables a cart verification process and enhances the overall customer experience. For example, the system provides frictionless exit verification. Unlike traditional methods that involve stopping customers and conducting random checks, the exit CV system efficiently verifies the presence of unpaid items as customers walk their carts to the exit door without any interruption. This eliminates the need for additional random checks by the exit greeter, reducing friction and ensuring a smooth and effortless exit experience, particularly for ‘green to go’ transactions.

In some examples, the system enables intelligent unpaid item notification. When the system detects unpaid items in a cart, it notifies the exit greeter with visual cues, outlining the potentially unpaid items with bounding boxes. This intelligent notification mechanism is superior to the traditional receipt check, which relies on random selection. The system employs smart sampling to accurately identify potentially unpaid items, fostering greater trust and confidence in customers.

In other examples, the system enables comprehensive item verification. The exit CV system's advanced capabilities allow it to detect and recognize every visible item in the shopping cart. As a result, our solution can verify more paid items and effectively catch a higher number of unpaid items. This comprehensive approach to item verification ensures that losses due to shrink are minimized, leading to substantial savings and reduction in shrink. The exit CV system provides the ability to seamlessly verify carts for unpaid items without disrupting the exit process, its intelligent notification system, and its capacity to accurately verify a comprehensive range of items. These pioneering features combine to create a frictionless, trustworthy, and efficient exit experience for customers.

In one example, the system performs cart detection, item detection, item classification and verification using computer vision image analysis. The system captures images of carts as the carts are exiting the retail facility. The images are received from one or more camera devices. The system uses computer vision to detect and track the customer carts. Sample images of the carts are selected, compressed, and sent to the unpaid item manager for analysis.

In another example, the system listens for cart detected trigger indicating a cart is exiting. The system performs item detection to get cropped images of the cart. The system calls classification and verification for cropped images. Basket matching is performed to match the cart to a receipt or an e-receipt. The system saves the basket matching results and images of the cart to a cloud storage or other data storage device. The system sends the results to an ML application. This is used to recommend the number of item scans to be performed by a user at receipt check.

In still another example, the system fetches real-time shrink results from the cloud storage. The tablets or other UI devices display real-time CV results to a user for review.

Alternatively, or in addition to the other examples described herein, examples include any combination of the following:
select a first image of the selected cart in which the selected cart is located in proximity to a first anchor point within the field of view of the image capture device;
select a second image of the selected cart in which the selected cart is located in proximity to a second anchor point within the field of view of the image capture device, wherein a trained object detection model analyzes the first image and the second image to detect a plurality of items within the selected cart;
obtain a plurality of images comprising a plurality of carts;
track the selected cart through the plurality of images using object tracking;
place a bounding box around the selected cart in each image in the plurality of images;
generate a set of indicators within the selected image of the selected cart associated with the set of unpaid items, wherein each unpaid item is associated with an indicator in the set of indicators;
wherein the set of indicators comprises a bounding box associated with each unpaid item in the set of unpaid items;
display a set of images of the set of unpaid items, wherein an image of each unpaid item is included in the set of images displayed on the UI device;
a set of cameras, the set of cameras comprising a ceiling mounted camera capturing a set of images associated with a top view of the selected cart, wherein the set of cameras transmits a plurality of images of the selected cart to a computing device via a network;
selecting an image of a selected cart from a plurality of images of the selected cart using a set of anchor points associated with a field of view of an image capture device;
identifying a plurality of items associated with the selected cart using the selected image;
predicting an item identifier (ID) associated with each item in the plurality of items associated with the selected cart, a set of identified items comprising a plurality of item IDs associated with the plurality of items;
selecting a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned at a POS device during a transaction associated with the selected e-receipt;
mapping each receipt item ID in the set of paid items to a predicted item ID in the set of identified items, wherein an unmapped item in the set of identified items is a predicted unpaid item;
upon receiving a verification request signal associated with the selected receipt from a scan device indicating a user is ready to exit, generating a notification including a verification result, wherein the verification result includes a set of unpaid items, wherein each predicted unpaid item in the set of unpaid items is associated with a predicted item ID in the set of identified items that fails to map to a corresponding receipt item ID in the set of paid items;
sending the notification to a user interface device associated with the scan device, the notification comprising the set of paid items and the set of unpaid items;
receiving first scan data associated with a first receipt from the scan device, the first scan data comprising a first receipt ID associated with the first receipt;
retrieving a first result including a first set of unpaid items and a first set of paid items associated with a first basket of items;
generating a first notification including the first result, wherein the first notification is transmitted to the user interface for presentation to the user in real-time;
receiving second scan data associated with a second receipt from the scan device, the second scan data comprising a second receipt ID;
retrieving a second result including a second set of unpaid items and a second set of paid items associated with a second basket of items;
generating a second notification including the second result, wherein the second notification is transmitted to the user interface for presentation to the user in real-time;
obtaining a plurality of images comprising a plurality of carts;
tracking the selected cart through the plurality of images;
placing a bounding box around the selected cart in each image in the plurality of images;
cropping each image to isolate the selected cart from other objects based on the bounding box around the selected cart in each image;
generate a list of predicted universal product code (UPC) values associated with each identified item in the set of identified items, wherein each predicted UPC in the list of predicted UPCs is mapped to a UPC associated with an item in the set of paid items obtained from the selected receipt;
displaying an image of each unpaid item in the set of unpaid items on the UI device one at a time, wherein the user is instructed to scan each item as it is displayed on the UI, wherein an image of a first unpaid item is displayed with a first instruction to scan the first unpaid item;
upon receiving scan data for a first unpaid item, displaying an image of a second unpaid item with a second instruction to scan the second unpaid item;
mapping a receipt item ID to a group of potential item IDs associated with a sub-set of items in the set of identified items;
generating a plurality of images of the selected cart by a set of cameras, the set of cameras comprising a ceiling mounted camera capturing a set of images associated with a top view of the selected cart, wherein the set of cameras transmits the plurality of images of the selected cart to a computing device via a network;
select an image of a selected cart from a plurality of images of the selected cart using a set of anchor points associated with a field of view of an image capture device;
identify a plurality of items associated with the selected cart using the selected image;
predict an item identifier (ID) associated with each item in the plurality of items associated with the selected cart, a set of identified items comprising a plurality of item IDs associated with the plurality of items;
select a receipt associated with the selected cart from a plurality of active receipts using a fuzzy matching of a set of paid items included in the selected receipt and the set of identified items generated using the selected image in real time, the set of paid items comprising a receipt item ID associated with each item scanned at a POS device during a transaction associated with the selected receipt;
map each receipt item ID in the set of paid items to an identified item ID in the set of identified items, wherein an unmapped item in the set of identified items is a predicted unpaid item;
upon receiving a verification request signal associated with the selected receipt from a scan device indicating a user is ready to exit, generate a notification including a verification result, wherein the verification result includes a set of unpaid items, wherein each predicted unpaid item in the set of unpaid items is associated with an item ID in the set of identified items that fails to map to a corresponding receipt item ID in the set of paid items;
send the notification to a user interface device associated with the scan device, the notification comprises a list of items in the set of paid items and a list of items in the set of unpaid items;
display an image of the selected cart including a set of indicators associated with the set of unpaid items;
display an image of each unpaid item in the set of unscanned items on the UI device one at a time;
estimate, by a depth model, a plurality of depth values associated with a plurality of carts within an image;
select a cart closest to an anchor point based on the plurality of depth values, wherein the depth value indicates a proximity of the selected cart to the anchor point;
the receipt item ID is a universal product code (UPC);
wherein the selected e-receipt is associated with a transaction completed at a self-checkout (SCO) device in an unstaffed checkout lane;
select a first image of the selected cart in which the selected cart is located in proximity to a first anchor point within the field of view of the image capture device;
select a second image of the selected cart in which the selected cart is located in proximity to a second anchor point within the field of view of the image capture device; and
select a third image of the selected cart in which the selected cart is located in proximity to a third anchor point within the field of view of the image capture device, wherein the first image, a trained object detection model analyzes the second image and the third image to detect a plurality of items within the selected cart.

At least a portion of the functionality of the various elements in FIGS. 1-3 can be performed by other elements in FIGS. 1-3 or an entity (e.g., processor 106, web service, server, application program, computing device, etc.) not shown in FIGS. 4-9. In some examples, the operations illustrated in FIGS. 4-9 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of identifying unpaid items via an exit CV, the method comprising selecting an image of a selected cart from a plurality of images of the selected cart using a set of anchor points associated with a field of view of an image capture device; identifying a plurality of items associated with the selected cart using the selected image; predicting an item identifier (ID) associated with each item in the plurality of items associated with the selected cart, a set of identified items comprising a plurality of item IDs associated with the plurality of items; selecting a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned at a POS device during a transaction associated with the selected e-receipt; mapping each receipt item ID in the set of paid items to a predicted item ID in the set of identified items, wherein an unmapped item in the set of identified items is a predicted unpaid item; upon receiving a verification request signal associated with the selected receipt from a scan device indicating a user is ready to exit, generating a notification including a verification result, wherein the verification result includes a set of unpaid items, wherein each predicted unpaid item in the set of unpaid items is associated with a predicted item ID in the set of identified items that fails to map to a corresponding receipt item ID in the set of paid items; and sending the notification to a user interface device associated with the scan device, the notification comprising the set of paid items and the set of unpaid items.

In some examples, as customers exit a retail facility after having paid for their products, the archway truss is installed as at least two exit lanes. Sensor devices, such as cameras, are installed on the archway such that the cameras are able to capture all different angle of the customer's products whilst maintaining the ability to detect and recognize products passing through the arch in a shopping cart. Furthermore, the archway truss is installed and positioned between checkout terminals and the exits so as to control traffic, provide a structure for hanging cameras and RFID tag readers, and be able to withstand the force of physical collisions from carts and flatbeds passing through the arch. The barrier also reduces false positives by preventing erroneous attribution of objects in the background to the contents of a cart passing through the archway.

The cameras, in some examples, are positioned and calibrated to capture images of carts and objects in carts from multiple angles. This enables the system to generate high quality images of items. High quality images enables more accurate CV results using the images.

The archway truss, in other examples, includes recessed camera housing. The housings are recessed partially within the vertical support members to protect the cameras from impacts, tampering, damage or contacts which could move the cameras out of their ideal placement and result in the need to re-position and/or recalibrate the cameras.

In some examples, the distance from the archway truss to the store exit is sufficient to enable the requisite processing time to analyze the sensor data associated with the passing customer's cart contents, and provide a recommendation regarding the cart to the exit greeter. The recommendation includes a recommendation that all items in the cart were correctly scanned and/or appear on the receipt. Another recommendation includes a recommendation to scan one or more items in the cart to verify the cart contents. In some examples, the archway truss provides at least two lanes where each lane includes at least three cameras. The three cameras include a top camera mounted to the horizontal top member, and two bottom cameras mounted to each vertical support member in a pair of vertical support members.

In some examples, the top camera is positioned so that the camera is a couple of inches off of the center of the horizontal top rail in the truss. The guard on the camera is pointed away from the exit.

In other examples, to effectively block the neighboring lane, the central support member barrier should measure either 3×5 or 4×5 feet on each side, with a total length of 3×10 or 4×10 feet. The central barrier blocks objects in the adjacent lane more effectively than other methods such as background removal. To mitigate the impact of objects on the two sides, a combination of the side barrier and background removal algorithm can be employed. When two carts are detected in an image, the system employs a depth model to differentiate the two carts in the image.

Some examples provide a two-way passage architecture archway-metal truss having a top (horizontal) member, a right side (vertical) member, a left side (vertical member), and a middle (vertical) central barrier forming two lanes through which shopping carts can pass. The truss has at least six cameras mounted on the truss. There are three cameras mounted such that they capture images from multiple angles of a first cart passing through the first lane. There are at least three cameras mounted to the archway such that the cameras capture images of a second cart passing through the second lane from multiple angles. A camera mounted to the top of the truss, a camera mounted at the bottom/right side and a camera mounted at the bottom left side of the truss to capture images from multiple directions/angles of the shopping cart and cart contents (products in the cart) as the cart passes through. The archway truss is positioned between the checkout and the exit.

Other sensor devices are optionally mounted to the truss, such as, but not limited to, RFID sensors, barcode readers, Bluetooth, NFC, or other sensor devices to read tags, barcodes, and other identifiers on the products within the cart. A plurality of image capture devices mounted to an archway truss exit lane are able to capture images of a shopping cart and products in the cart from multiple angles as the customer exits. A top member of the archway truss having a top camera mounted to it and pointing downward captures a “bird's eye view” top view image of the shopping cart. A right side member of the archway truss having a bottom mounted camera directed toward a first side of the first shopping cart in the first lane captures side view images of the cart and cart contents. A central barrier member of the archway truss having a bottom mounted camera directed towards a second side of the first shopping cart in the first lane captures opposite side view images of the cart and cart contents. A second top member camera mounted to the top member of the archway truss that is pointing downward captures top view images of a second shopping cart in a second exit lane. A left side member of the truss having a camera mounted to a bottom portion of the side member and positioned captures images of the side of the second shopping cart in the second lane.

Having a balanced number of cameras mounted to the archway truss enables the system to capture images of shopping carts and cart contents adjusted to maximize efficiency. Two way passage architecture with a central barrier blocks the view of cameras in the first lane from capturing images in the second lane. The central barrier also blocks the view of cameras in the second lane from capturing images of carts in the first lane.

Alternatively, or in addition to the other examples described herein, examples include any combination of the following:
a set of image capture devices removably attached to the archway truss, the set of image capture devices;
a first image capture device removably attached to the first vertical support member, wherein the first image capture device is located within a first recessed camera housing of the first vertical support member;
a second image capture device removably attached to the second vertical support member, wherein the second image capture device is located within a second recessed camera housing of the second vertical support member;
a third image capture device removably attached to the horizontal top member and positioned between the first vertical support member and the second vertical support member, wherein the first image capture device, the second image capture device and the third image capture device are positioned to capture a first set of images of a first set of objects moving through the first lane;
a fourth image capture device removably attached to the horizontal top member between the second vertical support member and the third vertical support member;
a fifth image capture device removably attached to the second vertical support member, wherein the fifth image capture device is located within a third recessed camera housing of the second vertical support member;
a sixth image capture device removably attached to the third vertical support member, wherein the sixth image capture device is located within a fourth recessed camera housing of the third vertical support member, and wherein the fourth image capture device, the fifth image capture device and the sixth image capture device are positioned to capture a second set of images of a second set of objects moving through the second lane;
a barrier member associated with a vertical support member, the barrier member comprising a pair of the wing panels, each wing panel extending perpendicular to the vertical support member;
a set of radio frequency identification (RFID) reader devices removably attached to the archway truss;
a set of reinforced panels covering an exterior surface of the second vertical support member, wherein the second vertical support member is reinforced to withstand collisions of one or more carts with the second vertical support member;
digital display device associated with a front facing side of the archway truss device, wherein the digital display device displays content viewable by users passing through the first lane;
digital display device associated with a back facing side of the archway truss device, wherein the digital display device displays dynamic content;
a first wing panel of a barrier attached to a front side of a vertical support member, the first wing panel sloping downward away from the vertical support member;
a second wing panel of the barrier attached to a back side of the vertical support member, the second wing panel sloping downward away from the vertical support member;
a multi-lane archway truss forming two lanes of travel through the archway;
a multi-lane archway truss forming three lanes of travel through the archway;
a reinforced central support member disposed between a first vertical support member and a second vertical support member;
a set of image capture devices removably attached to the archway truss generating images of the objects passing through the first lane and the second lane;
the set of RFID tag readers generating sensor data associated with the objects passing through the first lane and the second lane of the archway truss;
a first image capture device removably attached to the first vertical support member, wherein the first image capture device is at least partially recessed within the first vertical support member;
a second image capture device removably attached to the central support member, wherein the second image capture device is at least partially recessed within the central support member; and
a third image capture device removably attached to the horizontal top member and positioned between the first vertical support member and the central support member, wherein the first image capture device, the second image capture device and the third image capture device are positioned to capture a first set of images of a fist set of objects moving through the first lane;
a first downward sloping top rail of the first side panel; and
a second downward sloping top rail of the second side panel, wherein the first side panel and the second side panel are positioned to block any objects outside the first lane from a field of view of at least one image capture device within the set of image capture devices;
a first metal frame within the first vertical support member covered by a first padded exterior covering;
a second metal frame within the second vertical support member covered by a second padded exterior covering;
a third metal frame within the central support member covered by a third padded exterior covering;
a digital display device at least partially covering at least one side of the archway truss device, wherein the digital display device displays content viewable by users passing through the first lane and the second lane;
a third vertical support member attached to the horizontal top member, wherein a third lane of travel is formed between the third vertical support member and the second vertical support member;
a third set of image capture devices positioned to capture images of objects passing through the third lane of travel;
a first vertical support member connected to a first connection point of a horizontal top member;
a second vertical support member connected to a second connection point of the horizontal top member, the first vertical support member, a first portion of the horizontal top member, and the second vertical support member forming a first lane for passage of carts through the archway truss device;
a second barrier attached to the second vertical support member, wherein the first barrier and the second barrier provide a screen preventing the first set of cameras from capturing images of objects outside the first lane;
a third vertical support member connected to a third connection point of the horizontal top member, the second vertical support member, a second portion of the horizontal top member, and the third vertical support member forming a second lane for a second set of carts to pass through the archway truss device;
a second set of cameras removably attached to the archway truss, the second set of cameras comprising a third bottom camera associated with the second vertical support member, a fourth bottom camera associated with the third vertical support member, and a second top camera associated with the horizontal top member, the second set of cameras positioned to capture images of a second set of objects passing through the second lane;
a third barrier attached to the third vertical support member, wherein the second barrier and the third barrier provide a screen preventing the second set of cameras from capturing images of objects outside the second lane;
a digital display device removably attached to the archway truss device, the digital display device covering at least a portion of a front facing side of the archway truss device, wherein the digital display device displays customizable content viewable by users passing through the first lane and the second lane;
the first barrier comprising a first wing panel attached to a bottom portion of the front facing side of the first vertical support member and a second wing panel attached to a bottom portion of a back facing side of the first vertical support member;
the second barrier comprising third wing panel attached to a bottom portion of the front facing side of the second vertical support member and a fourth wing panel attached to a bottom portion of a back facing side of the second vertical support member; and
the third barrier comprising a fifth wing panel attached to a bottom portion of the front facing side of the third vertical support member and a sixth wing panel attached to a bottom portion of a back facing side of the third vertical support member.

At least a portion of the functionality of the various elements in FIGS. 25-41 can be performed by other elements in FIGS. 25-41, or an entity (e.g., processor 4106, web service, server, application program, computing device, etc.) not shown in FIGS. 25-41. In some examples, the operations illustrated in FIG. 42 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of managing an archway truss device, the method comprising detecting objects in a cart; generating dynamic content for display via a digital display device, and store sensor data generated by sensor devices on the archway truss device.

### Example Operating Environments

Example computer-readable media (also referred to as computer-readable storage media or machine readable media) include volatile and nonvolatile, removable, and non-removable media implemented in any method or technology for storage of information such as computer-readable instructions, data structures, program modules and the like. Computer-readable media may be tangible, non-transitory media. Computer readable media may be implemented in hardware and exclude carrier waves and propagated signals. Computer readable media for purposes of this disclosure are not signals per se. Example computer readable media include digital versatile discs (DVDs), compact discs (CDs), floppy disks, tape cassettes, hard disks, flash drives, other solid-state memory, RAM, ROM, or the like.

Instructions encoded on the computer-readable media may be executed by a processing resource (also referred to herein as a processor). A processing resource may include a microcontroller, a microprocessor, central processing unit core(s), an ASIC, an FPGA, and/or other hardware device suitable for retrieval and/or execution of instructions from the machine readable medium to perform functions related to various examples described herein. Additionally or alternatively, the processing resource may include or be coupled to electronic circuitry or dedicated logic for performing some or all of the functionality of the instructions described herein.

Although described in connection with an example computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute example means for frontend identification of unscanned items. For example, the elements illustrated in FIGS. 1-3, such as when encoded to perform the operations illustrated in FIGS. 4-9, constitute example means for obtaining an image of a selected cart and a plurality of items associated with the selected cart; example means for identifying the plurality of items associated with the selected cart; example means for predict an item identifier (ID) associated with each item in the plurality of items; example means for obtaining item scan data in real time from a point-of-sale (POS) device; example means for mapping each scanned item ID to an identified item ID in the set of identified items; example means for identifying a set of unscanned item based on mapping of the set of identified items to the set of scanned items, wherein an unscanned item is an item having an item ID in the set of identified items that fails to map to a corresponding item ID in the set of scanned items; and example means for sending a notification to a user interface device associated with the POS device prior to completion of the current transaction, the notification comprising the set of unscanned items and a set of unscanned item images, wherein a user is instructed to scan each item in the set of unscanned items.

Other non-limiting examples provide one or more computer storage devices having a first computer-executable instructions stored thereon for providing frontend identification of unscanned items. When executed by a computer, the computer performs operations including obtaining an image of a selected cart and a plurality of items associated with the selected cart; identifying the plurality of items associated with the selected cart; predicting an item identifier (ID) associated with each item in the plurality of items, wherein a set of identified items comprising a plurality of item IDs associated with the plurality of items is generated; obtaining item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device; mapping each scanned item ID to an identified item ID in the set of identified items; upon receiving a scan complete signal from the POS device indicating a user is ready to pay for the set of scanned items, identifying a set of unscanned item based on mapping of the set of identified items to the set of scanned items, wherein an unscanned item is an item having an item ID in the set of identified items that fails to map to a corresponding item ID in the set of scanned items; and sending a notification to a user interface device associated with the POS device prior to completion of the current transaction, the notification comprising the set of unscanned items and a set of unscanned item images, wherein a user is instructed to scan each item in the set of unscanned items.

Other non-limiting examples provide one or more computer storage devices having a first computer-executable instructions stored thereon for providing identification of unpaid items. When executed by a computer, the computer performs operations including selecting an image of a selected cart from a plurality of images of the selected cart using a set of anchor points associated with a field of view of an image capture device; identifying a plurality of items associated with the selected cart using the selected image; predicting an item identifier (ID) associated with each item in the plurality of items associated with the selected cart, a set of identified items comprising a plurality of item IDs associated with the plurality of items; selecting a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned at a POS device during a transaction associated with the selected e-receipt; mapping each receipt item ID in the set of paid items to a predicted item ID in the set of identified items, wherein an unmapped item in the set of identified items is a predicted unpaid item; generating a notification including a verification result, wherein the verification result includes a set of unpaid items, wherein each predicted unpaid item in the set of unpaid items is associated with a predicted item ID in the set of identified items that fails to map to a corresponding receipt item ID in the set of paid items; and sending the notification to a user interface device associated with the scan device, the notification comprising the set of paid items and the set of unpaid items.

The examples illustrated and described herein as well as examples not specifically described herein but within the scope of aspects of the disclosure constitute example means for managing an interactive multi-lane archway truss device. For example, the elements illustrated in FIG. 41, such as when encoded to perform the operations illustrated in FIG. 42, constitute example means for detecting objects in a cart, example means for generating video content for display on a digital display device, and example means for generating and storing sensor data associated with objects passing through the interactive multi-lane archway truss device.

All references cited herein are hereby incorporated by reference to the same extent as if each reference were individually and specifically indicated to be incorporated by reference and were set forth in its entirety herein.

The use of the terms “a” and “an” and “the” and “at least one” and similar referents are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate aspects of the disclosure and does not pose a limitation on the scope of the aspects of the disclosure unless otherwise claimed. No language in the specification should be construed as indicating any non-claimed element as essential.

Variations of aspects of the disclosure may become apparent to those of ordinary skill in the art upon reading the foregoing description. Accordingly, the disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of providing personalized advertising content for one or more users in a retail facility, the method comprising:
detecting a transaction event associated with a user;
determining a timing parameter based on transaction data associated with the transaction event and user profile information of the user, wherein the timing parameter is indicative of an estimated time for the user to approach a digital display device after the transaction event;
determining personalized advertising content for the user for display on the digital display device based on the user profile information of the user; and
causing display of the personalized advertising content for the user on the digital display device at a time based on the timing parameter.

2. The method of claim 1, wherein the determining personalized advertising content for the user is based at least in part on one or more items identified in the transaction data.

3. The method of claim 1, wherein the determining personalized advertising content for the user is based on a user-product propensity score representing a likelihood of engagement between the user and a product.

4. The method of claim 1, wherein the digital display device is integrated on a fixed exit truss structure located proximate to the exit.

5. The method of claim 4, wherein the digital display device includes one or multiple display screens, and wherein the displaying the personalized advertising content includes displaying the personalized advertising content on one or more of the one or multiple display screens.

6. The method of claim 1, wherein the determining the personalized advertising content includes:
determining user-product propensity scores for multiple products in a product database, wherein a user-product propensity score represents a likelihood of engagement between the user and a product; and
determining advertising content to serve as the personalized advertising content based on a product associated with a highest-ranking user-product propensity score.

7. The method of claim 6, further comprising adjusting the user-product propensity scores for the multiple products in the product database based on real-time information, the real-time information including an objective, detected user behavior information, or a contextual signal.

8. The method of claim 6, wherein the determining advertising content based on the product associated with the highest-ranking user-product propensity score includes:
providing product information related to the product to a content generator, and
generating digital advertisement content based on the product information.

9. The method of claim 8, wherein the digital advertisement content includes a static image, a video, or a QR code.

10. The method of claim 8, wherein the generating digital advertisement content based on the product information includes:
selecting a display template from a set of one or more predefined display templates, each predefined display template having a different output display format;
populating the selected display template with information about the product based on one or more input variables to produce an advertisement in an output display format capable of being displayed on the digital display device, wherein the one or more input variables include the product information, user information and contextual information.

11. The method of claim 10, wherein the product information includes one or more of a name, a price, a product category, a brand, a description, ratings information, or review information;
wherein the user information includes one or more of demographics information, user-interaction information, user affinity information, or user transaction information; and
wherein the contextual information includes one or more of seasonality information and location information.

12. The method of claim 10, wherein the populating includes:
automatically generating copy based on the one or more input variables using a trained language learning model, and
incorporating the copy in the advertisement.

13. The method of claim 1, wherein the determining the personalized advertising content includes:
determining, for the user and for one or more other users for which a transaction event was detected within a threshold timeframe of the transaction event associated with the user, cohort-product scores for one or more of the multiple products in a product database based on commonalities in information associated with the user and the one or more other users, wherein the commonalities in information include commonalities in demographics information, transaction information, interaction information and/or purchase behavior information of the user and the one or more other users; and
determining advertising content to serve as the personalized advertising content based on a product associated with a highest-ranking cohort-product propensity score for the user and the one or more other users.

14. The method of claim 1, further comprising adjusting the timing parameter based on detection of a second transaction event, based on a detected density of users in the retail facility, or based on timing context information that indicates one or more of a season, a day of the week, or a time of the day.

15. The method of claim 1, further comprising updating an average estimated time for the user to approach the display device in the retail facility based on a timestamp associated with an exit audit event that occurs after the transaction event, wherein the average estimated time is included in the user profile information.

16. A system for providing personalized advertising content in a retail facility, the system comprising:
a digital display device in the retail facility;
a processing resource; and
a non-transitory machine readable medium storing instructions that when executed cause the processing resource to:
detect a transaction event associated with a user;
determine a timing parameter based on transaction data associated with the transaction event and user profile information of the user stored in a user profile database, wherein the transaction data includes a transaction end time and the timing parameter is indicative of an estimated time for the user to approach the digital display device after the transaction event;
determine personalized advertising content for the user for display on the digital display device based on the user profile information of the user; and
cause display the personalized advertising content for the user on the digital display device at a time based on the timing parameter.

17. The system of claim 16, wherein the digital display device is integrated on an exit truss structure located proximate to the exit.

18. The system of claim 16, wherein the digital display device includes one or multiple display screens, and wherein the displaying the personalized advertising content includes displaying the personalized advertising content on one or more of the one or multiple display screens.

19. The system of claim 16, wherein the determining personalized advertising content for the user is based on a user-product propensity score representing a likelihood of engagement between the user and a product.

20. The system of claim 16, wherein the determining personalized advertising content for the user is based at least in part on one or more items identified in the transaction data.

21. The system of claim 16, wherein the user profile information includes user-product propensity scores for the user for each of multiple products in a product database,
wherein a user-product propensity score represents a likelihood of engagement between the user and a product, and
wherein the instructions that cause the processing resource to determine the personalized advertising content further includes instructions that cause the processing resource to determine advertising content as the personalized advertising content based on a product associated with a highest-ranking user-product propensity score.

22. The system of claim 21, wherein the machine readable medium further stores instructions that, when executed, cause the processing resource to adjust the user-product propensity scores for each of the multiple products in the product database based on real-time information that includes an objective, detected user behavior information, or a contextual signal.

23. The system of claim 21, wherein the instructions to determine advertising content based on the product associated with the highest-ranking user-product propensity score further includes:
instructions to provide product information related to the product to content generator, and
instructions to generate, by the content generator, digital advertisement content based on the product information.

24. The system of claim 23, wherein the digital advertisement content includes a static image, a video, or a QR code.

25. The system of claim 23, wherein the instructions to generate digital advertisement content based on the product information includes:
instructions to select a display template from a set of one or more predefined display templates, each predefined display template having a different output display format; and
instructions to populate the selected display template with information about the product based on one or more input variables to produce an advertisement in an output display format capable of being displayed on the digital display device, wherein the one or more input variables include the product information, user information and contextual information.

26. The system of claim 25, wherein the product information includes one or more of a name, a price, a product category, a brand, a description, ratings information, or review information;
wherein the user information includes one or more of demographics information, user-interaction information, user affinity information, or user transaction information; and
wherein the contextual information includes one or more of seasonality information and location information.

27. The system of claim 25, wherein the instructions to populate includes instructions to automatically generate copy based on the one or more input variables using a trained language learning model and incorporate the copy in the advertisement.

28. The system of claim 16, wherein the machine readable medium further stores instructions that, when executed, cause the processing resource to adjust the timing parameter based on detection of a second transaction event and/or based on a detected density of users in the retail facility and/or based on timing context information that indicates one or more of a season, a day of the week or a time of the day.

29. The system of claim 21, wherein the user profile information of the user stored in the user profile database includes an average estimated time for the user to approach the display device in the retail facility, and wherein the steps further include updating the average estimated time based on a timestamp associated with an exit audit event that occurs after the transaction event.

30. The system of claim 16, wherein the instructions that cause the processing resource to determine personalized advertising content further includes:
instructions to determine, for the user and for one or more other users for which a transaction event was detected within a threshold timeframe of the transaction event associated with the user, cohort-product scores for each of the multiple products in the product database based on commonalities in information associated with the user and the one or more other users, wherein the commonalities in information include commonalities in demographics information, transaction information, interaction information, or purchase behavior information of the user and the one or more other users; and
instructions to determine advertising content to serve as the personalized advertising content based on a product associated with a highest-ranking cohort-product propensity score for the user and the one or more other users.
